(19) United States
(12) Patent Application Publication
(10) Pub. No.: US 2021/0064234 A1
(43) Pub. Date: Mar. 4, 2021

(54) SYSTEMS, DEVICES, AND METHODS FOR IMPLEMENTING IN-MEMORY COMPUTING

(71) Applicant: FORMULUS BLACK CORPORATION, Jersey City, NJ (US)

(72) Inventors: Yin Zhang, Iselin, NJ (US); Nafees Ahmed Abdul, Harrison, NJ (US); Pradeep Balakrishnan, Sunnyvale, CA (US); Boyu Ni, Weehawken, NJ (US); Prasanth Krishnamoorthy, Harrison, NJ (US)

(21) Appl. No.: 16/849,205

(22) Filed: Apr. 15, 2020

Related U.S. Application Data
(60) Provisional application No. 62/834,640, filed on Apr. 16, 2019.
(60) Provisional application No. 62/834,784, filed on Apr. 16, 2019.

(51) Int. Cl. G06F 3/06

(52) U.S. Cl. CPC G06F 3/061; G06F 3/0679; G06F 3/0676; G06F 3/0629

(57) ABSTRACT

In some embodiments, systems, methods, and devices disclosed herein are directed to implementing in-memory computer systems that offer improved performance over conventional computer systems. In some embodiments, the implementations of in-memory computer systems, devices, and methods described herein can function without reliance on conventional storage devices and thus are not subject to the bottleneck in processing speed associated with conventional storage devices. Rather, in some embodiments, the implementations of in-memory computer systems described herein include and/or utilize a processor and memory, wherein the memory is used for mass data storage, without reliance on a conventional hard drive, solid state drive, or any other peripheral storage device. Some embodiments herein relate to non-uniform real-time memory access (NURA) computing, for example on an in-memory computing system. Other embodiments relate to hybrid input/output (I/O) processing to provide general and flexible I/O functionalities, for example on hyper-converged in-memory systems.

### CROSS-REFERENCE TO RELATED APPLICATIONS

This application claims the benefit of U.S. Provisional Application No. 62/834,784, filed Apr. 16, 2019, and titled SYSTEMS, DEVICES AND METHODS FOR IMPLEMENTING NON-UNIFORM REAL-TIME MEMORY ACCESS COMPUTING, and claims the benefit of U.S. Provisional Application No. 62/834,640, filed Apr. 16, 2019, and titled SYSTEMS, DEVICES, AND METHODS FOR HYBRID I/O PROCESSING. Each of the foregoing applications is hereby incorporated by reference in their entirety.

Any and all applications for which a foreign or domestic priority claim is identified in the Application Data Sheet as filed with the present application are hereby incorporated by reference under 37 CFR 1.57.

### BACKGROUND

### Field

This application relates to computer systems, devices, and methods, and in particular, to systems, devices, and methods for implementing in-memory computing, which may primarily rely on memory for data storage, allowing a processor of the computer systems to store and access data in a highly efficient manner.

### Description

In recent years, most computer systems have been based on the Von Neumann architecture and have included a processor connected to a main (or primary) memory and a peripheral bus allowing connection to additional components, such as mass storage devices. Generally, the main memory stores data that is directly accessed by the processor over a high-speed memory bus, and the peripheral bus, which is generally much slower than the memory bus, allows access to data on the mass or peripheral storage devices. The main memory can include RAM, which is generally volatile, while the mass or peripheral storage devices accessed over the peripheral bus can include conventional storage devices, such as hard disk drives (HDDs), solid state drives (SSDs), and the like. In general, the main memory can store active data being used by the processor, and the mass or peripheral storage devices can store passive data for long term data storage. The main memory is generally smaller and faster than the mass storage devices which are generally larger and slower.

Peripheral buses can allow almost infinite expansion but with slower access based on the amount of mass storage devices connected thereto. Main memory is typically smaller because it is much more expensive than peripheral storage. Since the advent of dynamic random access memory (DRAM), peripheral storage has been intimately involved in the running of applications for random IO. Previously, peripheral storage was only used for streaming in raw data and streaming out derived information from the application. This is because DRAM is volatile and loses its contents upon power loss.

Recent advances have enabled in-memory computing, which may provide relatively faster performance, scalability to massive quantities of data, and access to an increasing numbers of data sources. By storing data in memory and processing it in parallel, in-memory computing supplies real-time insights that enable users to deliver immediate actions and responses. Adoption of In-memory computing, also known as IMC, is on the rise. This can be attributed to the growing demand for faster processing and analytics on big data and the need for simplifying architecture as the number of various data sources increases. However, implementation of in-memory computing remains a challenge given the generally volatile nature of memory and the lack of software for properly implementing and optimizing existing hardware for in-memory processing. Thus, new systems, devices, and methods for implementing in-memory computing are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Various embodiments herein relate to computer systems, devices, and methods, and in particular, to systems, devices, and methods for implementing in-memory computing, which may primarily rely on memory for data storage, allowing a processor of the computer systems to store and access data in a highly efficient manner. Some embodiments relate to non-uniform real-time memory access (NURA) computing, for example on an in-memory computing system. Other embodiments relate to hybrid input/output (I/O) processing to provide general and flexible I/O functionalities, for example on hyper-converged in-memory systems.

Some embodiments herein are directed to a computer-implemented method of implementing hybrid input/output (I/O) functionality for an in-memory computer system, wherein the hybrid I/O comprises synchronous I/O and asynchronous I/O, the computer implemented method comprising: allocating, by the in-memory computer system, a portion of a memory to a base operating system; configuring, by the in-memory computer system, a remaining portion of the memory into a real-time memory (RTM), such that the memory is exposed to an operating system of the in-memory computer system as a device; utilizing, by the in-memory computer system, one or more Storage Performance Development Kits (SDPK) and/or one or more processes that mimic SDPK to bypass the kernel and/or any kernel synchronization mechanisms and communicate directly with the memory, wherein the configuring the remaining portion of the memory into a RTM enables the utilization of the one or more Storage Performance Development Kits (SDPK) and/or one or more processes that mimic SDPK; utilizing one or more drivers to facilitate communication between the base operating system and the RTM; and dividing system calls to be performed by either a synchronous I/O processing or an asynchronous I/O processing, wherein the in-memory computer system comprises the processor and the memory. In some embodiments, the one or more processes that mimic SDPK communicate directly to memory. In some embodiments, the allocating the portion of the memory comprises loading, by the in-memory computer system, a secondary operating system. In some embodiments, the secondary operating system is configured to allocate the portion of the memory to the base operating system and to configure the remaining portion of the memory into a RTM. In some embodiments, the configuring of the remaining portion of the memory comprises reconfiguring, by the secondary operating system performs a reconfiguration of the memory to appear as media and/or memory-backed storage to the base operating system In some embodiments, the remaining portion of the memory comprises 50% or more of the memory. In some embodiments, the remaining portion of the memory comprises 75% or more of the memory. In some embodiments, the remaining portion of the memory comprises 90% or more of the memory. In some embodiments, the remaining portion of the memory comprises 99% or more of the memory. In some embodiments, the one or more drivers comprise a layer within the base operating system that communicates with the memory or the RTM.

Some embodiments herein are directed to in-memory computer system comprising: a non-uniform non-aligned real time memory access (NURA) architecture for two or more computer processors, the NURA architecture comprising: a plurality of first computer readable memory devices configured to store a first plurality of computer executable instructions; a plurality of second computer readable memory devices configured to store a second plurality of computer executable instructions; a first hardware computer processor node in communication with the plurality of first computer memory devices; and a second hardware computer processor node in communication with the plurality of second computer memory devices, wherein memory of a first subset of the a plurality of first computer readable memory devices is reserved or utilized as a first system memory in a non-uniform memory access node, such that the first system memory is accessible to the first hardware computer processor node and is not accessible to the second computer processor node via memory channels, wherein memory of a first subset of the a plurality of second computer readable memory devices is reserved or utilized as a second system memory in a non-uniform memory access node, such that the second system memory is accessible to the second hardware computer processor node and is not accessible to the first computer processor node via memory channels, wherein memory of a second subset of the plurality of first computer readable memory devices is reserved or utilized as a first real-time memory (RTM) in a non-uniform non-aligned real time memory access node, wherein the first RTM is accessible to the first hardware computer processor node and is not accessible to the second computer processor node via memory channels, wherein memory of a second subset of the plurality of second computer readable memory devices is reserved or utilized as a second RTM in a non-uniform non-aligned real time memory access node, wherein the second RTM is accessible to the second hardware computer processor node and is not accessible to the first computer processor node via memory channels, wherein the first RTM and the second RTM comprise allocated memory that appears as mass or peripheral storage media to an operating system within the first plurality of computer executable instructions and the second plurality of computer executable instructions, and wherein the first RTM and the second RTM comprise identical pools of data elements, bit markers, and/or raw data.

In some embodiments, the memory of the plurality of first computer readable memory devices and the plurality of second computer readable memory devices is reserved or utilized by using a kernel command line parameter “memmap=”. In some embodiments, the first subset of the plurality of first computer readable memory devices and the first subset of the plurality of second computer readable memory devices are placed on memory channel 0. In some embodiments, the memory of the second subset of the plurality of first computer readable memory devices and the memory of the second subset of the plurality of second computer readable memory devices is not physically contiguous. In some embodiments, the first RTM and the second RTM comprise a super block, data segment, or meta segment. In some embodiments, the first computer processor node and the second computer processor node are configured to perform processing using the first RTM and the second RTM in parallel. In some embodiments, the first computer processor node and the second computer processor node are configured share information through QuickPath Interconnect (QPI). In some embodiments, the system further comprises one or more additional pluralities of readable memory devices and computer processor nodes, wherein each additional computer processor node is configured with a first subset of a plurality of computer readable memory devices reserved or utilized as an additional system memory and with a second subset of a plurality of computer readable memory devices reserved or utilized as an additional RTM. In some embodiments, each additional computer processor node is configured to perform processing in parallel to each other additional computer processor node. In some embodiments, each of the first computer processor node and the second computer processor node is configured with a logical extended memory (LEM). In some embodiments, the LEM comprises a part of the non-uniform memory access node.

### BRIEF DESCRIPTION OF THE DRAWINGS

The features of the present disclosure will become more fully apparent from the following description, taken in conjunction with the accompanying drawings. Understanding that these drawings depict only some embodiments in accordance with the disclosure and are, therefore, not to be considered limiting of its scope, the disclosure will be described with additional specificity and detail through use of the accompanying drawings.

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 is a block diagram illustrating an example embodiment of a in-memory computer system;

FIG. 2 is a block diagram illustrating an example embodiment a dual-node in-memory computer system;

FIG. 3 is a block diagram illustrating an example embodiment of a four node in-memory computer system;

FIG. 4 is a schematic representation of an example embodiment of data reduction engine processing raw data received from a host for storage in memory.

FIG. 5 is a block diagram illustrating a schematic representation of an example embodiments of data stored within memory;

FIG. 6 is a flowchart illustrating an example method for transferring virtual machines between in-memory computer systems according to one embodiment;

FIG. 7A is a flowchart illustrating an example method(s) for writing data utilizing in-memory computer systems, devices, and methods;

FIG. 7B is a flowchart illustrating another example method(s) for writing data utilizing in-memory computer systems, devices, and methods;

FIG. 8 is a flowchart illustrating an example method(s) for reading data utilizing in-memory computer systems, devices, and methods;

FIG. 9 illustrates an example of a system comprising a duel socket server comprising a physical memory address space formatted as a single dimension linear address space, across multiple memory channels as a uniform RTM access (URA) architecture;

FIG. 10 illustrates an example of a system comprising a dual socket server comprising NURA RTMs according to some embodiments herein;

FIG. 11 illustrates an example of a symmetric ccNUMA architecture according to some embodiments herein;

FIG. 12 illustrates an example NUMA memory configuration according to some embodiments herein;

FIG. 13 illustrates an example NUMA memory configuration according to some embodiments herein;

FIG. 14 illustrates a multi-node NURA memory configuration according to some embodiments herein;

FIG. 15 illustrates an example gene pool structure comprising an RTMIO structure, recycle bin structure and lookup table structure according to some embodiments herein;

FIG. 16 illustrates another example gene pool structure according to some embodiments herein;

FIG. 17 illustrates an example NURA memory reservation control flow according to some embodiments herein;

FIG. 18 illustrates an example NURA recycle phase flow according to some embodiments herein;

FIG. 19 illustrates an example NURA reuse control flow according to some embodiments herein;

FIG. 20 illustrates an example node structure and function for accessing each CPU core's “call gate” variable according to some embodiments herein;

FIG. 21 illustrates an example user space and kernel space and a synchronous I/O process flow according to some embodiments herein;

FIG. 22 illustrates an example user space and kernel space and an asynchronous I/O process flow according to some embodiments herein;

FIG. 23 illustrates an example integration of a core algorithm engine into Linux kernel as an independent IP kernel module according to some embodiments herein;

FIG. 24 illustrates an example virtualization Mode, wherein the core algorithm engine can collaborate with the SPDK or SPDK-like framework according to some embodiments herein; and

FIG. 25 is schematic diagram depicting an embodiment(s) of a computer hardware system configured to run software for implementing one or more embodiments of in-memory computer systems, devices, and methods.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

This detailed description discusses features for implementing in-memory computer systems, devices, and methods in relation to certain described embodiments, some of which are illustrated in the figures. Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

### Introduction

In recent decades, computer systems, e.g., personal computers (such as desktops and laptops), servers, mobile devices (such as tablets and mobile phones), and the like, have generally included a processor connected to a main (or primary) memory (often RAM), and a peripheral bus connected to peripheral or mass storage devices. Generally, the main memory is used to store data that can be quickly accessed by the processor over a high-speed memory bus, and the peripheral data bus allows access to data stored on the peripheral or mass storage devices. The peripheral data bus, however, is much slower than the memory bus.

As used herein, memory refers to any physical device capable of storing information temporarily, like random access memory (RAM) or permanently, like read-only memory (ROM). As used herein, RAM may be considered a generic term and generally refer to other high speed memory. In some instances, RAM may refer to any memory device that can be accessed randomly, such that a byte of memory can be accessed without touching the preceding bytes. RAM can be a component of any hardware device, including, for example, servers, personal computers (PCs), tablets, smartphones, and printers, among others. Typically, RAM allows data items to be read or written in almost the same amount of time irrespective of the physical location of data inside the memory. Generally, RAM takes the form of integrated circuit (IC) chips with MOS (metal-oxide-semiconductor) memory cells. RAM may refer generally to volatile types of memory, such as any type of dynamic RAM (DRAM) modules, high-bandwidth-memory (HBM), video RAM (VRAM) or static RAM (SRAM). In some embodiments, RAM may refer generally to non-volatile RAM, including, for example, read-only memory (ROM) or NOR-flash memory. Thus, as used herein, RAM is a generic term to generally refer to high-speed memory, including but not limited to SRAM, DRAM, MRAM and/or the like. This includes any commercially available RAM, such as those manufactured by Intel, Samsung, Micron and others.

As used herein, operating system (OS) refers to software that manages the computer's memory and processes, as well as all of its software and hardware. Most modern OSs employ a method of extending RAM capacity, known as virtual memory. A portion of the computer's hard drive is set aside for a paging file or a scratch partition, and the combination of physical RAM and the paging file form the system's total memory. When the system runs low on physical memory, it can “swap” portions of RAM to the paging file to make room for new data, as well as to read previously swapped information back into RAM. Excessive use of this mechanism results in thrashing and generally hampers overall system performance, mainly because hard drives are far slower than RAM.

In some embodiments herein, computers may be configured to operate without a traditional hard drive, such that paging information is stored in memory. For example, an OS herein may comprise Forsa OS, developed and marketed by Formulus Black Corporation. Forsa OS enables any workload to run in-memory, without modification. Furthermore, Forsa OS enables memory to be provisioned and managed as a high performance, low latency storage media. Thus, in some embodiments, substantially all computer data may be stored on RAM, using, for example, forms of data amplification or compression. In some embodiments, an OS, middleware, or software can “partition” a portion of a computer's RAM, allowing it to act as a much faster hard drive. Generally, RAM loses stored data when the computer is shut down or power is lost. However, in some embodiments, RAM is arranged to have a standby battery source or other mechanisms for persisting storage are implemented to protect data stored in RAM. For example, methods and systems herein may be combined with data retention mechanisms, such as those described in U.S. Pat. No. 9,304,703 entitled METHOD AND APPARATUS FOR DENSE HYPER IO DIGITAL RETENTION, U.S. Pat. No. 9,628,108 entitled METHOD AND APPARATUS FOR DENSE HYPER IO DIGITAL RETENTION, and U.S. Pat. No. 9,817,728 entitled FAST SYSTEM STATE CLONING, each of which is hereby incorporated herein by reference in its entirety.

The in-memory computing implementation systems, devices and methods described herein may therefore be utilized in in-memory or in-memory computer systems, such as those described in U.S. patent application Ser. No. 16/222,543, entitled RANDOM ACCESS MEMORY (RAM)-BASED COMPUTER SYSTEMS, DEVICES, AND METHODS, which is incorporated herein by reference in its entirety. Furthermore, the embodiments described herein may be used in combination with data amplification systems and methods such as those described in U.S. Pat. No. 10,133,636 entitled DATA STORAGE AND RETRIEVAL MEDIATION SYSTEM AND METHODS FOR USING SAME, U.S. Pat. No. 9,467,294, entitled METHODS AND SYSTEMS FOR STORING AND RETRIEVING DATA, and U.S. patent application Ser. No. 13/756,921, each of which is hereby incorporated herein by reference in its entirety.

Conventionally, computer systems have utilized RAM, commonly in the form of DRAM, as the main memory. RAM can be directly connected to the processor by a high speed memory bus, such that read and write operations to and from the RAM can occur very quickly. For example, in some computer systems the I/O speed for reading and writing data to and from RAM can be as high as 56.7 GB/s, but in others slower or much higher depending on the number of central processing units (CPUs) and complexity of the computer being designed. The high I/O speed associated with RAM can make it ideal for main memory, which must be readily available and quickly accessible by the processor. However, in conventional computer systems, there are some disadvantages associated with the use of RAM. For example, RAM capacity (size, density, etc.) is limited (e.g., relatively smaller) when compared with capacities of other storage devices, such as HDDs and SSDs. RAM capacity has been limited by several key factors, first being cost, then including processor design, nanometer density limitations of silicon, and power dissipation. Today, the largest RAM module commonly available is only 128 GB in capacity, although 256 GB RAM modules will likely be available soon. Another disadvantage associated with the use of RAM in conventional computer systems is that RAM is generally volatile, meaning that data is only stored while power is supplied to the RAM. When the computer system or the RAM lose power, the contents of the RAM are lost. Additionally, RAM, especially larger RAM modules, is quite expensive when compared with other types of storage (e.g., on a dollars per gigabyte scale).

It is generally because of the limited capacity, volatility, and high cost associated with RAM that conventional computer systems have also included a peripheral bus for accessing peripheral devices such as peripheral or mass storage devices. In conventional computer systems, peripheral or mass storage devices (also referred to herein as conventional storage devices) can be any of a number of conventional persistent storage devices, such as hard disk drives (HDDs), solid state drives (SSDs), flash storage devices, and the like. These conventional storage devices, are generally available with capacities that are much larger than RAM modules. For example, HDDs are commonly available with capacities of 6 TB or even larger. Further, these conventional storage devices are generally persistent, meaning that data is retained even when the devices are not supplied with power. Additionally, these conventional storage devices are generally much cheaper than RAM. However, there are also disadvantages associated with the use of these conventional storage devices in conventional computer systems. For example, I/O transfer speeds over the peripheral bus (e.g., to and from conventional storage devices) are generally much slower than the I/O speeds to and from main memory (e.g., RAM). This is because, for example, conventional storage devices are connected to the processor over the slower peripheral bus. In many computers, the peripheral bus is a PCI bus. Then there is typically an adapter to the actual bus that the peripheral storage device is attached to. For storage devices, such as HDDs and SSDs, the connector is often SAS, SATA, Fiber Channel, and most recently Ethernet. There are also some storage devices that can attach to PCI directly such as NVMe Drives. However, in all cases speeds for accessing devices over the peripheral bus are about 1000 times slower than speeds for accessing RAM (e.g. DRAM).

Thus, in conventional computer systems, devices, and methods a limited amount of memory in the form of RAM has generally been provided that can be accessed at high transfer speeds, and a larger amount of peripherally attached conventional storage is provided for long term and mass data storage. However, in these conventional systems, the difference in the I/O transfer speeds associated with the RAM and the conventional storage devices creates a bottleneck that can affect the overall performance of the systems. Under heavy computing loads, for example, this bottleneck will eventually slow the entire computing system to the speed of the conventional storage device.

This application describes new and improved computer systems, devices, methods, and implementations thereof that can overcome or alleviate the above-noted and other issues associated with conventional computer systems, devices, and methods that are reliant on both memory and conventional storage devices. In particular, this application describes implementations for in-memory computer systems, devices, and methods that offer improved performance over conventional computer systems, devices, and methods.

As will be described in greater detail below, in some embodiments, the in-memory computer systems, devices, and methods described herein can function without reliance on conventional storage devices (and thus are not subject to the bottleneck described above) and/or provide solutions to one or more of the conventionally-viewed drawbacks associated with memory (e.g., volatility and limited capacity). Stated another away, in some embodiments, the implementations of in-memory computer systems, devices, and methods described herein include and/or utilize a processor and memory, wherein the memory may be used for mass data storage, without reliance on a conventional hard drive, solid state drive, or any other peripheral storage device.

In some embodiments, the in-memory computer systems, devices, and methods can be configured to provide and/or utilize storage capacities in memory generally only associated with conventional storage devices (e.g., HDDs and SSDs), and that can be accessed at the high I/O transfer speeds associated with memory. Further, certain systems, devices, and methods can be configured such that the data is generally non-volatile, such that data will not be lost if the systems lose power. In some embodiments, the in-memory computer systems, devices, and methods utilize specialized computer architectures. In some embodiments, the in-memory computer systems, devices, and methods utilize specialized software operating on a system with traditional computer architecture. These and other features and advantages of the in-memory computer systems, devices, and methods described herein will become more fully apparent from the following description.

Overview—in-Memory Computer Systems, Devices, and Methods

As used herein, the term “memory-based computer system,” “memory-based computer device,” “memory-based computer method,” “in-memory computer system,” “in-memory computer device,” and “in-memory computer method” refers to a computer system, device, and method that is configured to process and store data wholly or substantially using only a processor and memory, regardless of whether the system includes a conventional storage device (such as an HDD or SSD). In-memory computer systems, devices, and methods can be configured such that the memory is used to perform the functions traditionally associated with both main memory (e.g., quick access to currently or frequently used data) and conventional storage devices accessible over a peripheral bus (e.g., long term storage of mass amounts of data). In some embodiments, in-memory computer systems, devices, and methods may include and/or utilize a data reduction engine or module that can employ bit marker or other technologies as discussed herein that allow the system to process and store data wholly or substantially using only a processor and memory.

In some embodiments, an in-memory computer system and one or more features thereof as described herein can be implemented on a computer system having specialized computer system architecture as described in more detail below. In some embodiments, an in-memory computer system and one or more features thereof as described herein can be implemented on a computer system having conventional computer system architecture by utilizing one or more computer-implemented methods via computer software for achieving the same. For example, in some embodiments, a system having conventional computer system architecture can be reconfigured through software such that the system generally operates using only memory and a computer processor. In some embodiments, a conventional architecture computer system can be reconfigured through software such that the memory is used to perform the functions traditionally associated with both main memory and conventional storage devices accessible over a peripheral bus. In some embodiments, a conventional storage device of the system can be used rather for back-up purposes only as will be described in more detail below.

Without the use of data reduction algorithms such as bit marker technology, typical computing systems would require peripheral devices such as hard, or solid-state disk drives for permanent memory storage; however, the use of peripheral devices generally require sending of data over bus channels, which adds latency and slows down the processing power of the computing system. The most latency added is that of small transfers to/from these hard or solid state disk drives, called ‘random-I/O,’ which RAM is designed to complete. Other usage during typical computing is to do sequential (large or small contiguous transfers to/from external drives, which still adds latency, but less than random I/O.

As described herein, in some embodiments, the implementations of in-memory computer systems, devices, and methods, by utilizing only a processor and memory, without the need for peripheral storage as part of the running of the application, can have dramatically increased processing power relative to conventional system. For example, in some embodiments, external storage can be used for ingress of large amounts raw data for an application to operate upon, and egress of data to write computed information from the raw data back to external persistent storage.

In some embodiments, in-memory computer systems, devices, and methods can be configured to utilize bit marker technology in conjunction with only a processor and memory in order to achieve 20 times amplification of memory in terms of storage capacity, and 20 times improvement over conventional servers in terms of processing speed and capacity. In some embodiments, the foregoing technical improvements, can be achieved through the system using only a processor and memory because the system utilizes bit marker technology to amplify the memory storage capacity and the system is configured with backup power supply in order to make the memory storage non-volatile, thereby allowing the system complete workloads using the processor and the faster memory, instead of wasting time in accessing peripheral devices in order to read and write data using random I/O, sequential I/O, and in general any access to peripheral devices while the application is running on raw data.

In some embodiments, the systems, devices, and methods disclosed herein are configured to guarantee no loss or substantially no loss of data in using a computing system primarily storing all data in memory. In some embodiments, the systems, devices, and methods disclosed herein can be configured to not have 100% availability and/or have less than 100% no data loss. For example, such systems could be potentially useful in situations where the applications operating on the system can recreate data and/or tolerate having data that is not updated in real-time or data that is updated behind schedule, such as in media processing contexts.

In some embodiments, the computing systems, devices, and methods described herein are configured to operate with only a processor and memory without the need for use of a conventional storage device. In some embodiments, a conventional storage device is a hard disk drive (HDD) or hard disk or a fixed disk that uses magnetic storage to store and retrieve digital information using one or more rigid rapidly rotating disks (platters) coated with magnetic material. In some embodiments, a conventional storage device is a solid-state drive (SSD) or solid-state disk that uses integrated circuit assemblies as memory to store data persistently, and typically uses flash memory, which is a type of non-volatile memory that retains data when power is lost. In contrast to flash memory, RAM or DRAM (dynamic random access memory) can refer to a volatile memory that does not store memory permanently without a constant power source. However, generally speaking, writing and reading data to and from RAM can be much faster than writing and reading data to and from flash memory. In some embodiments, flash memory is 100 times slower than RAM.

In some environments, systems, devices, and methods described herein operate by using a processor and memory only, without the need for a persistent conventional storage drive, which can allow the system to process data at about 20 times the speed of conventional computer systems, thereby allowing a single system to do the work of about 20 conventional computer systems. By utilizing the technology disclosed herein, users of such computer systems, devices, and methods can utilize fewer computer systems to do the same amount of work, thereby avoiding server sprawl. By avoiding server sprawl, managers of server farms can reduce complexity and expense in managing such computer systems. Furthermore, conventional computer systems utilizing conventional storage devices, such as HDD and or SSD, can be prone to failure at some point in time because the conventional storage devices fail or break with usage or over-usage in the case of server farms. However, with the use of some systems, devices, and methods disclosed herein, managers of server farms may not need to replace the systems, because such systems would be less prone to breakage given that there is no or less reliance on conventional storage devices, such as SSDs or HDDs. Accordingly, managers of server farms can reduce time and expense and complexity by avoiding the need to constantly replace servers that are broken or nonfunctional due to hardware failures, not to mention reduce the amount of network infrastructure, power, space, and personnel required to maintain a data center. In some embodiments, systems, devices, and methods herein can still comprise and/or utilize external storage as a piece for ingress of raw data for an application as well as egress of computed information by the application to external storage.

In some embodiments, the systems, devices, and methods disclosed herein comprise and/or utilize a specialized computer architecture that enables the computer system to operate and process data using only a processor and RAM, while only using the same or substantially the same amount of memory in conventional computing systems, for example, 16 gigabytes, 32 gigabytes, 64 gigabytes, 78 gigabytes, 128 gigabytes, 256 gigabytes, 512 gigabytes, 1024 gigabytes, 2 terabytes, or more. In some embodiments, the computing architecture of the systems disclosed herein enable the system to store an amount of raw data that is many times that of the physically memory size of the memory, for example, 2×, 3×, 4×, 5×, 6×, 7×, 8×, 9×, 10×, 11×, 12×, 13×, 14×, 15×, 16×, 17×, 18×, 19×, 20×, 21×, 22×, 23×, 24×, 25×, 26×, 27×, 28×, 29×, 30×, 31×, 32×, 33×, 34×, 35×, 36×, 37×, 38×, 39×, 40×, or more, resulting in the ability to store an equivalent of, for example, 320 gigabytes, 640 gigabytes, 1 terabyte, 2 terabytes, 3 terabytes, 4 terabytes, 5 terabytes, 6 terabytes, 7 terabytes, 8 terabytes, 9 terabytes, 10 terabytes, 11 terabytes, 12 terabytes, 13 terabytes, 14 terabytes, 15 terabytes, 16 terabytes, 17 terabytes, 18 terabytes, 19 terabytes, 20 terabytes, 30 terabytes, 40 terabytes, or more of raw data. In some embodiments, the systems, devices, and methods disclosed herein comprise and/or utilize a computer architecture that enables the computer system to operate and process data using only a processor and memory to permanently store data while not requiring the use of a conventional storage device, unlike conventional computer systems which rely on conventional storage devices to operate, because the RAM provides an equivalent storage capacity that is similar to that of a conventional storage device in a conventional computing system.

In some embodiments, systems, devices, and methods described herein can be configured to perform computer processing of data by using only a processor and memory without the need for a conventional peripheral storage device. In some embodiments, the use of bit marker technology can dramatically increase the amount of data that can be stored in memory. Accordingly, in some embodiments, systems, devices, and methods described herein can comprise and/or utilize an amount of memory that is typically provided in most computers today; however, the amount of data that can be stored in the memory is, in some embodiments, 2×, 3×, 4×, 5×, 6×, 7×, 8×, 9×, 10×, 11×, 12×, 13×, 14×, 15×, 16×, 17×, 18×, 19×, 20×, 21×, 22×, 23×, 24×, 25×, 26×, 27×, 28×, 29×, 30×, 31×, 32×, 33×, 34×, 35×, 36×, 37×, 38×, 39×, 40×, more than what can be stored in the memory without using bit marker technology. This hardware system and/or software configuration can be advantageous because it can change the cost model for memory in computing systems, in particular, the need to conventional storage drives, such as HDD or SSD. In conventional systems, the main cost driver can be the cost of memory, and therefore a conventional storage device can be required to store memory because it is too costly to configure a computer with enough memory to equal the amount of data storage that can be made available through less costly convention storage devices. For example, 128 gigabyte of DRAM can cost as much as $16,000. However, with the use of bit marker technology, in some embodiments described herein, it can be possible to configure a computing system with a conventional amount of memory that can store a substantially equivalent amount of data as conventional storage devices, and at a virtual lower cost per GB for what is known to the industry as the most expensive type of storage.

Embodiments with Specialized Computer Architecture for in-Memory Computer Systems

In some embodiments, in-memory computer systems, devices, and methods may include and/or utilize specialized computer architectures. Specialized computer architectures may enable or facilitate one or more of the advantages associated with in-memory computer systems, devices, and methods. For example, in some embodiments, specialized computer architectures can virtually increase the storage capacity of the memory such that the in-memory computer system, device, or method can store in memory an equivalent amount of raw data that is greater than, and in many cases, substantially greater than the actual capacity of the memory. In some embodiments, this can allow the memory to be used as the primary storage for the entire system and allow all of the data to be accessed at high speeds over the memory bus. As another example, in some embodiments, specialized computer architectures can allow the data to be stored in a non-volatile manner such that if the system loses power, the data will be preserved. Additionally, in some embodiments, specialized computer architectures can allow the in-memory computer system systems to be fault tolerant and highly available.

In some embodiments, a specialized architecture for in-memory computer system can comprise a single node system. In some embodiments, a specialized architecture for in-memory computer system can comprise a multi-node system.

### Example Embodiments of a Single Node System

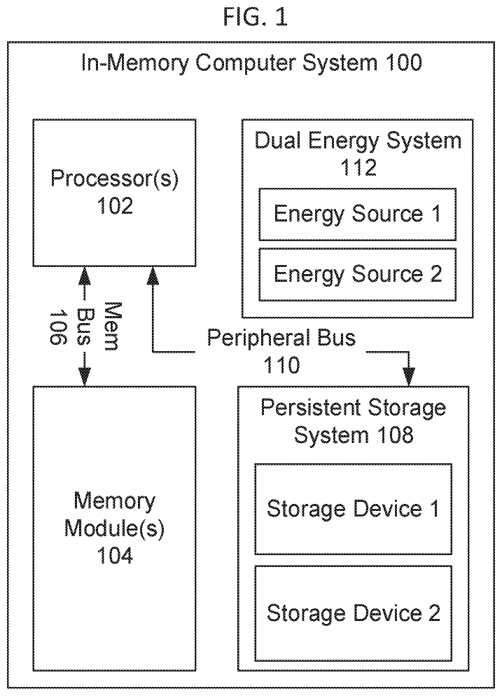

In some embodiments, a computer architecture of a single node in-memory computer system can comprise a fault tolerant, in-memory computer architecture. FIG. 1 is a block diagram representing one embodiment of an in-memory computer system 100. In the illustrated embodiment, the system 100 includes one or more processors 102 and one or more memory modules 104. In some embodiments, the processors 102 are connected to the memory modules by a memory bus 106. In some embodiments, the system 100 also includes a persistent storage system 108. In some embodiments, the persistent storage system 108 can include one or more persistent storage devices. In the illustrated embodiment, the persistent storage system 108 includes two storage devices: storage device 1 and storage device 2. In some embodiments, the persistent storage system 108 is connected to the processors 102 by a peripheral bus 110. In some embodiments, the peripheral bus is a Peripheral Component Interconnect Express (PCIe) bus, although other types of peripheral buses may also be used. In some embodiments, the system 100 also includes a dual energy system 112. The dual energy system 112 can include at least two energy sources, for example, as illustrated energy source 1 and energy source 2. In some embodiments, the energy sources can each be a battery, a super capacitor, or another energy source. In some embodiments, the system may exclude an energy system and/or a persistent storage system.

In some embodiments, the system 100 can be configured to store substantially all of the data of the system 100 in the RAM modules 104. By way of comparison, conventional computer systems generally store a limited amount of data in memory and rely on conventional storage devices for mass data storage. The system 100 can be configured to use the memory modules 104 for even the mass data storage. In some embodiments, this advantageously allows all of the data to be quickly accessible to the processor over the high-speed memory bus 106 and dramatically increases the operating speed of the system 100.

Some types of memory modules (e.g., DRAM) are generally volatile. Accordingly, to prevent data loss and make data storage non-volatile, in some embodiments, the system 100 includes the persistent storage system 108 and the dual energy system 112. In some embodiments, these components work together to make the system 100 essentially non-volatile. For example, the dual energy system 112 can be configured to provide backup power to the system 100 in case of power loss. The backup power provided by the dual energy system 112 can hold up the system for sufficient time to copy the contents of the memory modules 104 to the persistent storage system 108. The persistent storage system 108 can include non-volatile, persistent storage devices (e.g., SSDs or HDDs) that safely store the data even with no power.

In some embodiments, the system 100 constantly mirrors the contents of the memory modules 104 into the persistent storage system 108. In some embodiments, such mirroring is asynchronous. For example, the contents of the persistent storage system 108 can lag slightly behind the contents of the memory modules 104. In some embodiments, in the event of power failure, the dual energy system 112 can hold up the system 100 for long enough to allow the remaining contents of the memory modules 104 to be mirrored to the persistent storage system 108. In some embodiments, the system 100 only transfers the contents of the memory modules to the persistent storage system 108 in the event of a power failure.

Although the illustrated embodiment of the system 100 includes both memory modules 104 and a persistent storage system 108 that includes persistent storage devices, such as HDDs and SSDs, in some embodiments, the system 100 uses these components in a substantially different way than conventional computer systems. For example, as noted previously, conventional computer systems rely on memory to quickly access a small portion of the data of the system and rely on conventional storage devices for long term and persistent data storage. Thus, in general, the entire amount of data used by conventional systems is only stored in the conventional storage devices. In contrast, in some embodiments of the system 100, substantially all of the data of the system 100 is stored in the memory. This can allow all of the data to be quickly accessible by the processors 102 over the high speed memory bus 106. In some embodiments, a second copy of the data (or an asynchronous copy of the data) can be provided in the persistent storage system 108 with the purpose of preserving the data in case of power loss to the system 100. Thus, through use of the persistent storage system 108 and the dual energy system 112 the system 100 can provide a solution to one of the disadvantages generally associated with memory: its data volatility.

In some embodiments, the system 100 can provide a solution to another of the disadvantages generally associated with memory: its limited capacity. In some embodiments, the system 100 can include a data reduction engine that can greatly reduce the data actually stored on the system 100. In some embodiments, the data reduction engine can use various techniques and methods for reducing the amount of data stored, including utilizing bit marker technology. The data reduction engine and data reduction methods will be described in greater detail below. In the system 100, in some embodiments, the data reduction engine can be executed on the one or more processors 102. In some embodiments, the data reduction engine is executed on an additional circuit of the system 100, such as an FPGA, ASIC, or other type of circuit. In some embodiments, the data reduction engine can use bit marker technology.

In some embodiments, the data reduction engine intercepts write requests comprising raw data to be written to a storage medium. In some embodiments, the data reduction engine can compress, de-duplicate, and/or encode the raw data such that it can be represented by a smaller amount of reduced or encoded data. In some embodiments, the smaller amount of reduced or encoded data can then be written to the memory module(s) 104. In some embodiments, the data reduction engine also intercepts read requests. For example, upon receipt of a read request, the data reduction engine can retrieve the smaller amount of compressed or encoded data from the memory modules 104 and convert it back into its raw form.

In some embodiments, through implementation of the data reduction engine, the system 100 can be able to store an equivalent or raw data that exceeds, and in some instances, greatly exceeds the physical size of the memory modules 104. In some embodiments, because of the data reduction engine, reliance on conventional storage devices for mass data storage can be eliminated or at least substantially reduced and mass data storage can be provided in the memory modules 104.

In some embodiments, because the mass data storage is provided in the memory modules 104, all of the data is quickly accessible over the high speed memory bus 106. This can provide a solution to the disadvantage that is common in conventional computer systems that data retrieved from mass data storage must go over a slower peripheral bus. Because, in some embodiments, the system 100 does not need to access data from a conventional storage device over the peripheral bus, the overall speed of the system can be greatly increased.

In some embodiments, the system 100 includes a single processor 102. In some embodiments, the system 100 includes more than one processor 102, for example, two, three, four, or more processors. In some embodiments, the system can include one or more sockets. In some embodiments, the one or more processors 102 comprise multiple cores. In some embodiments, the processors comprise Intel processors, such as Intel's, Skylake or Kaby Lake processors, for example. Other types of processors can also be used, e.g., AMD processors, ARM processors, or others. In general, the system 100 can be configured for use with any type of processors currently known or that will come to be known without limitation.

In some embodiments, the system comprises one or more memory modules 104. In some embodiments, the memory modules 104 can be dual in-line memory modules (DIMMs) configured to connect to DIMM slots on a motherboard or on other components of the system 100. In some embodiments, the system 100 may include the maximum amount of memory supported by the processors 102. This need not be the case in all embodiments, for example, the system 100 can include anywhere between 1 GB and the maximum amount of memory supportable by the processors 102. In some embodiments, one or more individual memory modules 104 in the system 100 can be the largest size memory modules available. As larger sized memory modules are developed, the system 100 can use the larger sized modules. In some embodiments, the system 100 can use smaller sized individual memory modules, e.g., 1 GB, 2 GB, 4 GB, 8 GB, 16 GB, 32 GB, or 64 GB memory modules. In some embodiments, the system includes between 1 GB and 3 TB or 6 TB of memory. In some embodiments, the more memory (e.g. RAM) the system includes, the greater the possibility of greater data reduction, more processing power, and overall computer value.

In some embodiments, the memory modules comprise DRAM, although other types of memory or RAM modules can also be used. In some embodiments, the system uses NV-DRAM. In some embodiments in which NV-DRAM is used, the persistent storage system 108 and the dual energy system 112 can be omitted as the NV-DRAM is already non-volatile. In some embodiments, the memory modules may comprise 3D X-Point memory technology, including, for example, Intel Optane DIMMs.

In some embodiments, the computing system is configured to operate with only a processor and NVDIMMs (or 3D X-Point DIMMs, NVRAMs or RERAMs) without the need for use of a conventional storage device. In some embodiments, the NVDIMMs utilizes cross-point memory (a faster version of flash memory based storage but still only accessible in block format, vs RAM which is random access down to bytes; further there are other versions of this faster flash being developed as well as others, but none are as fast, dense, or capable of small byte access such as RAM which is required by all applications and CPUs). In some embodiments, the NVDIMMMs are block addressable and/or can be configured to be inserted into a DIMM socket. In general, DIMMs can refer to the form factor of the memory in how such memory plugs into a motherboard or other interface. In some embodiments, the NVDIMMs comprise RAM (volatile memory) and flash memory (non-volatile memory) wherein the NVDIMMs use volatile memory during normal operation for speed and dump the data contents into non-volatile memory if the power fails, and does so by using an on-board backup power source to be described in more detail below. In some embodiments, the foregoing system operates at a slower processing speed than a computing system configured to operate with only a processor and RAM. In some embodiments, the computing system operating a processor with NVDIMMs can be more expensive to manufacturer due in part to the expense of NVDIMMs. In some embodiments, NVDIMMs require super caps and/or modification to the mother board to provide energy to the NVDIMMs such that when the power goes down or while it was alive, it would basically then be able to retire the RAM to the flash without losing data. In some embodiments, NVDIMMs, using bit marker technology, can only store much less than, e.g., about 1/10^{th} to ¼^{th}, the amount of data that RAM (and at slower speeds than DRAM) is capable of storing by using bit marker technology. In some embodiments, NVDIMMs do not have very high storage density as compared to RAM or DRAM.

In some embodiments, utilizing only a processor and memory, the system can comprise memory that is configured to be plugged into an interface mechanism that can be coupled to a DIMM slot, wherein the interface mechanism comprises a power source. In some embodiments, the interface mechanism having a power source enables the data that is stored in the memory to be persistently stored in the memory in the event that there is a disruption in the supply of power to the memory. In some embodiments, the back-up power source is not integrated into the interface mechanism, in which there would be some cases where there would be no need for an interface mechanism, but rather there is a power source(s) integrated into and/or coupled to the motherboard (or main CPU/RAM board) to supply back-up power to the entire motherboard which in turn would supply power to the memory in the event there is a disruption in the supply of power to the computer system. Supplying power to the motherboard and/or memory, in some embodiments, can ensure that the data stored in memory persists in the event there is a disruption to the power supply.

In particular, referring back to FIG. 1, in some embodiments, the system 100 can be considered a merger of a server and an array controller with regard to data protection, high availability, and fault tolerance. In some embodiments, the system 100 fuses or combines two generally separated computer system functions: compute and storage. In some embodiments, the system 100 makes the memory modules 100 the only storage media for applications to run against and thus all I/O requests remain on the very fast memory bus. Further, in some embodiments, the persistent storage system 108 and the dual energy system 112 provide that the data is nonvolatile.

### Persistent Storage System

As noted above, in some embodiments, the system 100 can include a persistent storage system 108. In some embodiments, the persistent storage system 108 is configured to provide nonvolatile storage of data in the even to of a loss of power to the system 100. In some embodiments, as shown in FIG. 1, the persistent storage system 108 can include two storage devices: storage device 1 and storage device 2. In some embodiments, the persistent storage system 108 include at least two storage devices. Each of the storage devices can be a persistent storage device (i.e., a nonvolatile storage device that retains data even when unpowered). For example, each storage device can be an SSD, HDD, or the like.

In some embodiments, the multiple storage devices of the persistent storage system 108 can be configured in a mirrored or RAID configuration. For example, in some embodiments, the system includes two NVMe SSDs in a dual-write RAID-1 configuration. In this configuration, data can be written identically to two drives, thereby producing a “mirrored set” of drives. In some embodiments, a RAID configuration of the persistent storage system 108 can provide improved fault tolerance for the system 100. For example, if either storage device fails, the data is preserved in the other storage device. In some embodiments, other RAID levels can be used (e.g., RAID 2, RAID 3, RAID 4, RAID 5, RAID 6, etc.).

Although FIG. 1 illustrates the persistent storage system 108 with only two storage devices, in some embodiments more than two can be included, for example, two, three, four, five, six or more. In some embodiments, up to 16 storage devices are included. In some embodiments, up to 32 storage devices are included.

In some embodiments, as noted previously, the persistent storage system 108 can be used to provide an asynchronous backup of the data stored in the memory modules 104. Thus, in some embodiments, in the event of a power failure, data related to transactions not yet completed can be lost. In general, this amount of data can be minimal. Accordingly, in some embodiments, the persistent storage system 108 provides a nonvolatile method for backing up the data in the memory modules 104.

In some embodiments, data is continually backed up to the persistent storage device 108. For example, in some embodiments, the initial state of the data in the memory modules 104 is copied to the persistent storage device 108, and then the system 100 continues to copy any changes in the data (i.e., the deltas) to the persistent storage device 108. In some embodiments, the system may not continuously copy data to the persistent storage device 108. For example, not continuously copying the data can allow the system to run at an even higher performance. In these systems, data may only be copied to the persistent storage device 108 when a power event is detected.

In some embodiments, the system persistent storage system 108 includes sufficient capacity to back up all of the memory modules 104. Thus, in some embodiments, the size of the persistent storage system 108 is at least as large as the total size of the memory modules 104. For example, if the system includes 3 TB of memory, the persistent storage system 108 may include at least 3 TB of space. In RAID configurations, for example, the mirrored RAID 1 configuration described above, if the system includes 3 TB of memory, each storage device of the persistent storage system 108 may include at least 3 TB of space.

In some embodiments, the persistent storage system 108 is not used for user data in the conventional sense. For example, in some embodiments, a user could not decide to save data to the persistent storage system 108. Rather, in some embodiments, user data is saved and accessed from the memory modules 104. In some embodiments, a back-up copy of the customer data may be provided in the persistent storage system 108 but may generally not be visible to the user.

Although this disclosure makes reference to the persistent storage system 108 include two storages devices, it will be appreciated that, in some embodiments, a system can include only a storage. For example, a system could include an SSD backup. In such a system, in the event of a failure of the single drive, data may be lost.

### Example Architecture Embodiments of a Dual Node System

In some embodiments, the system comprises a multiple node system. In some embodiments, a dual node system may comprise one or more features described above in connection with a single node system architecture. In some embodiments, a dual node system can comprise a non-stop, fault tolerant, in-memory computer architecture.

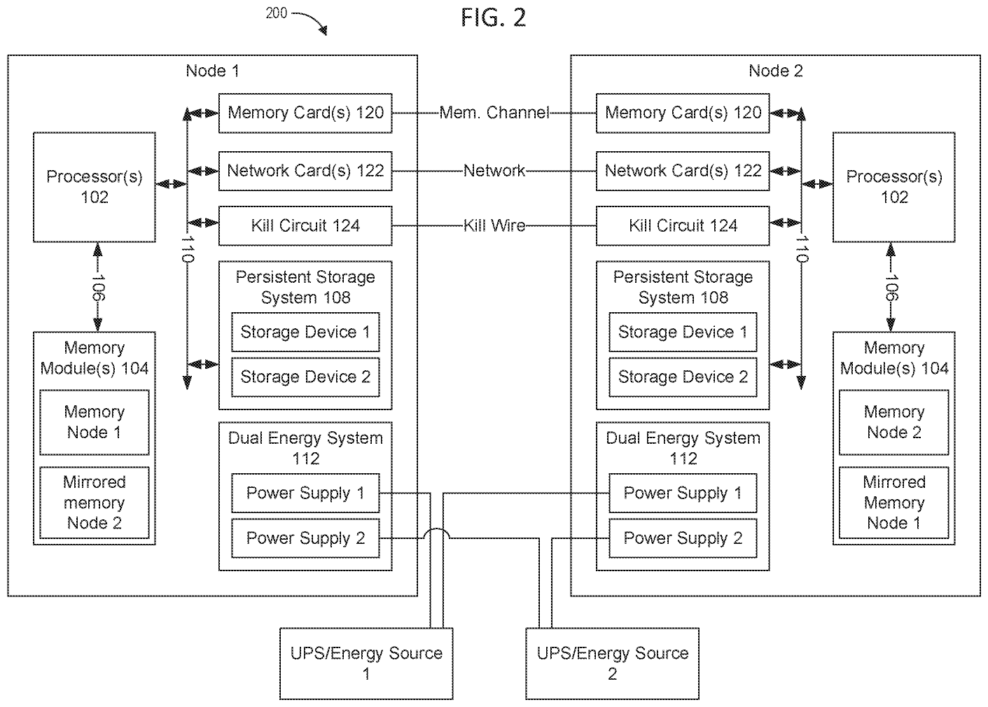

FIG. 2 is a block diagram of an example dual node in-memory computer system 200. In some embodiments, the system 200 includes two nodes (node 1 and node 2) that are interconnected to provide a non-stop, fault tolerant in-memory computer system 200. In some embodiments, the computer system 200 is designed for very high availability, data protection, and fault tolerance and can be used, for example, in environments where both up time and data protection are critical.

In some embodiments, each node (node 1 and node 2) can be similar to the in-memory computer system 100 described above in connection with FIG. 1. For example, in some embodiments, each node includes one or more processors 102 and one or more memory modules 104 connected by a high-speed memory bus 106. In some embodiments, each node can also include a persistent storage system 108 and a power supply 112 as described above. For sake of brevity, description of these features will not be repeated with the understanding that the description above of the in-memory computer system 100 of FIG. 1 is applicable here to each node.

In addition to the features previously described, in some embodiments, each node also includes one or more memory cards 120 (configured to allow communication over a memory channel, tunnel, fabric, or switch), one or more network cards 122, and a one-way kill circuit 124. In some embodiments, these features work together to provide transparent mirroring of memory between the two nodes of the system 200. In some embodiments, for example, as shown in FIG. 2, the memory modules 104 of the first node include a first portion of memory dedicated to the memory of node 1 and a second portion dedicated to the mirrored memory of node 2. Similarly, in some embodiments, the memory modules 104 of the second node include a first portion of memory dedicated to the memory of node 2 and a second portion dedicated to the mirrored memory of node 1. In some embodiments, as will be described in greater detail below, because each node includes a mirrored copy of the other node, in the event of a failure of either node, the surviving node can take over the work of both nodes. While the capacity of each node may be reduced (as half of each node must be dedicated to backing up the opposite node) in some embodiments, this arrangement provides a high degree of fault tolerance and availability.

FIG. 2 illustrates an example system in an active-active system configuration. That is, both node 1 and node 2 may actively run virtual machines (VMs) and/or applications, and each node may contain a mirrored copy of the other node's running memory. As such, in some embodiments, if either node fails, the surviving node can begin running the VMs or applications that were previously running on the failed node using the mirrored copy of the failed node's memory.

In some embodiments, the system may be operated in an active-passive configuration. That is, only one node, e.g., node 1, is actively running VMs or applications. In this case, node 2 is running in a passive state. It does not run any VMs or applications and only contains a mirrored copy of node 1's memory. As such, in some embodiments, if node 1 fails, node 2 can become active, taking over node 1's running applications and VMs using the mirrored copy of node 1's memory.

In some embodiments, the memory of each node is mirrored to the opposite node over a memory channel (also referred to as a memory tunnel, fabric, or switch). In some embodiments, the memory channel comprises 32 lanes of PCIe, which in some embodiments is capable of transferring 32 gigabytes of data per second. In some embodiments, the memory channel is capable of transferring 32 gigabytes of data per second per lane. This can provide a connection between the nodes that is much faster than traditional network connections. As compared to traditional networks of today, one can employ 100 gigabit networks switches that can only provide 12 gigabytes per second.

In some embodiments, to access the memory channel, each node includes one or more memory cards 120. In some embodiments, each memory card 120 provides for 16 lines of PCIe (32 gigabytes of data per second). In some embodiments, each node comprises two memory cards 120 allowing for a total of 32 PCIe lanes. In some embodiments, the memory cards 120 are connected to the processors 102 through the peripheral bus 110, which may be a PCIe bus. In the case of intel processors in some embodiments, the memory cards 120 and the memory channel can access the processors 102 via the Non-Transparent Bridge (NTB) of 32 lanes of PCIe on all Intel processors. In some embodiments, the memory cards 120 are configured to allow the computer systems in a multi-computer system to communicate at or substantially at memory BUS speeds thereby introducing only a small amount or no amount of latency between the two computing systems during data mirroring and/or other data transfer between the systems.

In some embodiments, the system 200 comprises one or more specialized communication links between the nodes to transmit heartbeat data between the two nodes. In some embodiments, the heartbeat data provides information to the nodes that each of the computing systems is still functioning properly. In some embodiments, a first heart beat is sent over the memory channel and a second heart beat is sent over the network, for example, by means of network cards 122.

In the event that the system 200 loses both heartbeats, in some embodiments, the system 200 can interpret the loss as meaning that one of the nodes. In which case, in some embodiments, the system 200 can be configured to send a one way kill signal through the kill circuit 124. In some embodiments, kill circuit 124 is configured to guarantee that only one of the nodes is terminated such that both computing systems do not terminate, thereby ensuring that the system is fault tolerant and that no data is lost. In some embodiments, the system is configured to delay sending the one way kill signal to account for the situation wherein the non-responding computing system is in the process of rebooting. In some embodiments, to restart the terminated computing system, the system requires human intervention, for example, the non-responding computing system requires a hardware repair.

In some embodiments, the surviving node is configured to perform a fail over procedure to take over the work of the non-functioning node. In some embodiments, the functioning node can take over the work of the non-functioning node because the functioning node includes a mirrored copy of the memory from the non-functioning node. In some embodiments, the functioning computing system is configured to instantly take over the work of the non-functioning computing system. In some embodiments, the functioning computing system is configured to fail over or take over after a period of time the work of the non-functioning computing system.

In some embodiments, the functioning computing system is configured to perform a fail back procedure, or in other words transfer the work of the non-functioning computing system back after the non-functioning computing has rebooted. In some embodiments, the functioning computing system is configured to copy or mirror the data related to the work of the non-functioning computing system that is stored in the capacity efficient shared storage in the functioning computing system to the non-functioning computing system. In some embodiments, the functioning computing system is configured to keep track of the changes or the delta or the new data related to the work of the non-functioning computing system that is stored in the capacity efficient shared storage of the functioning computing system since the system taking over the work from the non-functioning computing system. In some embodiments, the functioning computing system is configured to copy or mirror the changes or the delta or the new data to the non-functioning computing system after the non-functioning computing system has rebooted, assuming that the memory in the non-functioning computing system was not replaced or reformatted or the data in the memory was not otherwise erased. In some embodiments, the fail back procedure involves copying or mirroring all or some of the data associated with the work of the non-functioning computing system that is stored in the capacity efficient shared storage to the previously non-functioning computing system through the memory tunnel.

Example Systems with More than Two Nodes

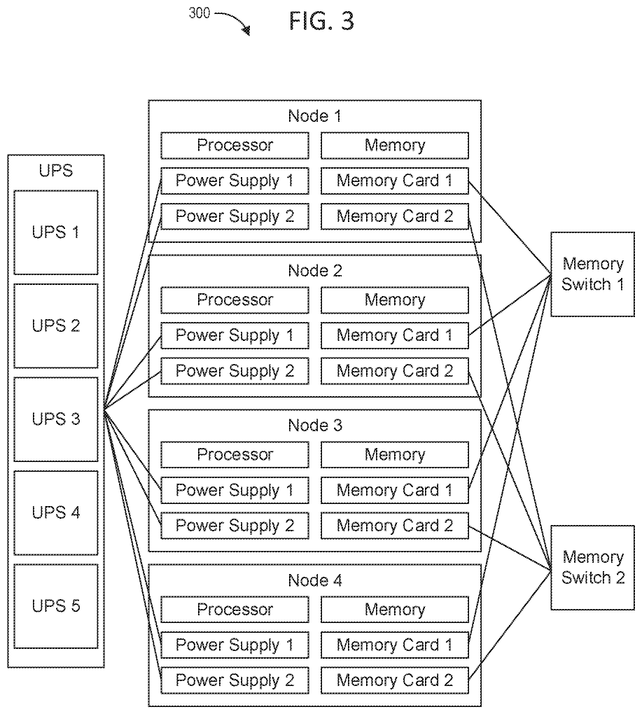

In some embodiments, the system can comprise more than two nodes. In particular, FIG. 3 is a block diagram of a in-memory computer system 300. In the embodiment illustrated in FIG. 3, the computer system 300 includes four nodes. Each node may be similar to the in-memory computer system 100 described above. Each node may include two memory cards and each memory card can be connected to one of two memory switches. The nodes can communicate with each other through the memory cards and switches in a manner that is much faster than traditional networking (e.g., gigabit ethernet connections).

As shown in FIG. 3, in some embodiments, the system 430 may represent a multi-computing system cluster, wherein paired computing systems within the cluster can electronically communicate with other paired computing systems. In the illustrated example, the system 300 includes four nodes. In some embodiments, the first and second nodes can be paired in an arrangement. Further, the third and fourth nodes can also be provided in a paired arrangement. In this example, the paired nodes can be configured to mirror data between themselves in a manner similar to that described above with reference to FIG. 3. Additionally, in some embodiments, the four nodes are also in electronic communication with each other through the memory switches.

In some embodiments, the system is configured to copy or mirror data between paired computing systems. In some embodiments, such systems configured to copy or mirror data between paired computing systems are ideal for mission critical situations requiring no loss of data and no loss of availability; however, such systems can have system performance decreases due to increased processing power and/or network traffic (for example, increased overhead with the network) required to perform data copying or mirroring. Accordingly, in some embodiments, each computing system can only use a portion, for example, a quarter, a half, three-quarters, of the memory storage because the non-used portion must be used for data copying or mirroring with the other paired computing system.

In some embodiments, the systems disclosed herein are configured to operate a plurality of VMs. In some embodiments, the systems disclosed herein can be configured to operate natively or raw without operating any virtual machines on the system because the entire system is being used to operate a single OS in order to provide maximum performance to the single OS and/or the software applications running over the OS and the system.

Further, FIG. 3 illustrates that, in some embodiments, a UPS system may be provided to supply backup power to the dual energy source systems (e.g., the two power supplies) of each node. In this example, the UPS is illustrated as module and comprises five individual modules. In some embodiments, it may be preferred to have at least one more UPS module than the number of system nodes to provide redundancy in the system. For example, in the illustrated example of four nodes, the UPS comprises five modules.

### Real-Time Data Reduction and Real-Time Memory

In some embodiments, the systems, methods, and devices described herein can comprise and/or be configured to utilize real-time data reduction, encoding, and/or decoding processes. In some embodiments, a system comprising an architecture as described herein can comprise a real-time data reduction engine module for performing one or more data reduction, encoding, and/or decoding processes as described herein. In some embodiments, even a system having conventional computer system architecture can be configured to utilize one or more data reduction, encoding, and/or decoding processes described herein by utilizing one or more computer-implemented methods via computer software. As such, in some embodiments, a conventional computer system can be reconfigured through software to implement one or more features of a real-time data reduction engine module as discussed herein.

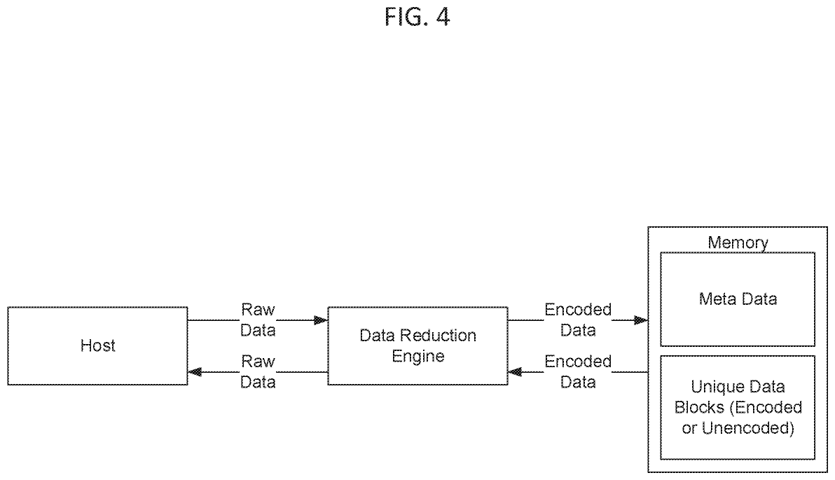

FIG. 4 is a schematic representation of a data reduction engine processing raw data received from a host for storage in memory. As shown, in some embodiments, the data reduction engine can receive raw data from a host and encode that data for storage in memory. Similarly, the data reduction engine can retrieve encoded data from memory, decode that data, and provide raw data back to the host. In some embodiments, the data reduction engine encodes the data such that the amount of encoded data stored in the memory is many times smaller than the amount of raw data that the encoded data represents. As discussed above, the data reduction engine can allow an in-memory computer to operate substantially or entirely using only a processor and memory, without the need for a conventional storage device because the storage size of the memory is virtually amplified many times because of the data reduction engine.

In some embodiments, the data reduction engine, module, or software uses bit marker technology as described herein. Bit marker and data reduction technology are also described in U.S. application Ser. No. 13/756,921, filed Feb. 1, 2013; U.S. application Ser. No. 13/797,093, filed Mar. 12, 2013; U.S. application Ser. No. 14/804,175, filed Jul. 20, 2015, now U.S. Pat. No. 9,304,703; U.S. application Ser. No. 15/089,658, filed Apr. 4, 2016, now U.S. Pat. No. 9,628,108; U.S. application Ser. No. 15/089,837, filed Apr. 4, 2016, now U.S. Pat. No. 9,817,728, International Patent Application No. PCT/US2016/025988, filed Apr. 5, 2016; and International Patent Application No. PCT/US2017/024692, filed Mar. 29, 2017, each of which is incorporated herein by reference in its entirety.

In some embodiments, the data reduction engine, module, or software operates as a low-level system component, e.g., lower than the applications, OSs, and virtual machines running on the system. Accordingly, in some embodiments, the data reduction engine, module, or software can process data on the system in a manner that is not apparent to the applications, OSs, and virtual machines running on the system.

In some embodiments, the data reduction engine, module, or software acts a shim between the host and data storage. In some embodiments, the host can send read and write requests as if it were using a conventional storage device. In some embodiments, the data reduction engine, module, or software can intercept these read and write requests and process the data. In some embodiments, the data reduction engine, module, or software can then read or write the data to the memory. In some embodiments, the host may believe that it has read or written data to a conventional storage device, when in reality the data reduction engine has read or written the data to memory.

In other embodiments, the data reduction system, module, or software may operate as a higher level component of the system, e.g., as a component of an application, OS, or virtual machine running on the system. In these embodiments, the application, OS, or virtual machine running on the system can process the data itself using the data reduction engine, module, or software.

In some embodiments, the data reduction engine, module, or software processes all data received by the system. That is, the data reduction engine, module, or software processes all data received from all applications, OSs, virtual machines, etc., running on the computer system. In some embodiments, the more data that is processed by the data reduction system, the greater the virtual amplification and improved performance of the computer system.

As shown in FIG. 4, in some embodiments, read/write requests for raw data can be provided by a host and/or intercepted by the data reduction engine, module, or software. The host can represent, for example, an application, an OS, a VM running on the system, etc.

In some embodiments, a write request may contain a stream of raw data to be stored. In some embodiments, the data reduction engine, module, or software can break the stream of raw data into one or more blocks. The blocks may be analyzed to determine whether they are unique. In some embodiments, only the unique data blocks are stored in the memory. In some embodiments, the data reduction or virtual amplification can be achieved by only storing one instance of each unique data block. The pool of stored unique data blocks can be referred to as Capacity Efficient Shared Storage Pool (CESSP). The CESSP can include each unique data block stored by the system. In some embodiments, from the CESSP, all the raw data can be reconstructed by combining the various unique data blocks in the proper order.

In some embodiments, the data reduction engine, module, or software also stores meta data. The meta data can contain information that allows the raw data streams to be reconstructed from the stored unique data blocks. In some embodiments, the meta data can include the logical extended memories (LEMs) discussed below. In some embodiments, the meta data can include information about how many times each unique data block has been seen by the system. In some embodiments, the meta data can include pointers to the unique data blocks. In some embodiments, the data in the memory can be encoded using bit markers.

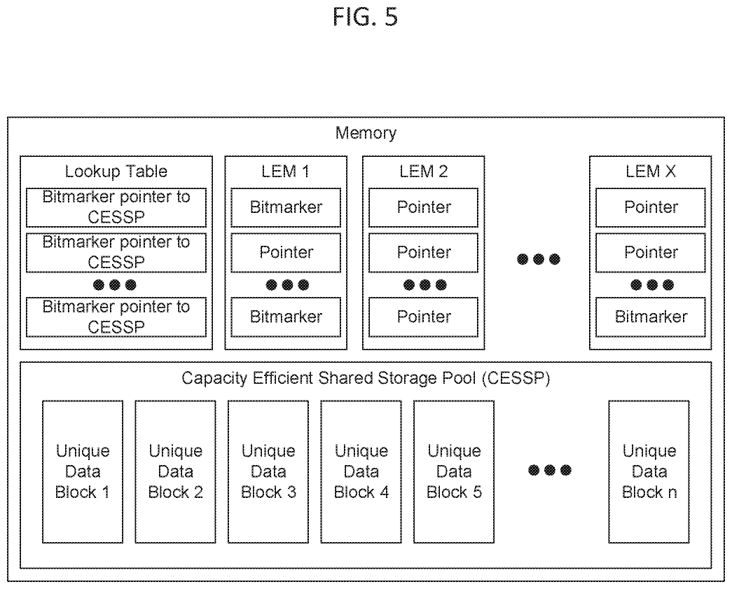

FIG. 5 is a block diagram illustrating a schematic representation of data stored within memory according to some embodiments. As illustrated, in some embodiments, the memory includes a Capacity Efficient Shared Storage Pool (CESSP), which can include one instance of each unique raw data block seen by the system. In some embodiments, the raw data blocks can be encoded using bit markers. In some embodiments, the memory also include a bit marker table as described in the above-noted application that have been incorporated herein by reference. The R memory may also include one or more logical extended memories (LEMs). LEMs are described in greater detail in the following sections.

### Logical Extended Memory (LEM)

In some embodiments, systems, devices, and methods described herein comprise and/or utilize a LEM (logical extended memory), which in general is a virtual disk. In some embodiments, a LEM represents an abstract virtual block, virtual disk, or an encoded memory disk. In some embodiments, a LEM is a form of meta-data. In some embodiments, a LEM comprises a list of pointers. In some embodiments, the list of pointers in a LEM are pointing to data elements in the overall pool of raw data vectors, which in some cases is called a gene pool or CESSP. In some embodiments, the gene pool comprises data vectors, bit markers, raw data, and/or the like. In some embodiments, the genome, also referred to as all the data element stored in the memory storage, is stored in RTM.

In some embodiment, systems, devices, and methods described herein, utilizing only a processor and memory, comprises memory data storage which is configured to store a genome, also referred to as a gene pool, CESSP, or the entire data set, where all the data is stored and is represented, and such representation reflects all the files and blocks that have ever been read into the system. In other words, in some embodiments, the genome represents all the data that the computer system has processed. In some embodiments, the genome comprises raw data. In some embodiments, the genome comprises bit markers. In some embodiments, the genome comprises pointers. In some embodiments, the genome comprises unique data vectors. In some embodiments, the system comprises memory storage configured to store meta-data. In some embodiments, the meta-data comprises data for deconstructing and reconstructing raw data from bit markers. In some embodiments, the genome comprises a combination of all of the foregoing data types. In some embodiments, the genome refers to the entirety of the memory storage that is used for storing data versus tables and other pointers that point to other data elements and/or blocks of data within the genome.

In some embodiments, the system comprises memory storage that is configured to store tables, wherein the tables allow for bit marker data to be stored and accessed for future deconstruction and reconstruction of raw data to and from bit markers. In some embodiments, the system comprises memory storage that is configured to store LEM data, which can comprise a listing of pointers to data elements stored in the genome. In some embodiments, the LEM data, represents a virtual disk. In some embodiments, the system comprises memory storage configured to store one or more LEMs, which in some cases can represent one or more virtual disks operating in the computer system.

In some embodiments, systems, devices, and methods described herein, comprising and/or utilizing only a processor and memory, use statistical modeling and/or statistical predictions to determine what actual storage space in the memory is necessary to effectuate a virtual disk of a particular storage size to be represented by the LEM. In some embodiments, the system utilizes statistical modeling and/or statistical predictions to determine the maximum virtual storage size that a LEM can represent to a virtual machine.

In some embodiments, systems, devices, and methods described herein, comprising and/or utilizing only a processor and memory, can utilize LEMs in order to act as virtual disks. In some embodiments, the LEMs can point to data elements in the genome. In some embodiments, the LEMs can point to bit markers stored in a bit marker table, which in turn can point to data elements in the genome.

In some embodiments, systems, devices, and methods described herein, comprising and/or utilizing only a processor and memory, can be configured so utilize bit marker technology and/or a LEM, wherein both utilize pointers to point to data elements stored in the genome in order to obfuscate and/or encode the raw data. In some embodiments, the data that is stored in the memory storage of the system is obfuscated to such an extent that without the bit marker technology and/or the LEM, it would be difficult for a third-party to re-create or reconstruct the raw data that is stored in a deconstructed form in the RAM storage. In some embodiments, the system, utilizing only a processor and memory, can make data stored in the memory storage secure by obfuscating and/or encoding the raw data through the use of pointers to point to unique data elements stored in the genome.

In some embodiments, the systems disclosed herein comprise a base OS that is configured to generate a LEM for presenting to a virtual disk to a virtual machine that is running a secondary OS. In some embodiments, the base OS comprises an application or interface that is integrated into the secondary OS or operates on top of the secondary OS, wherein such application or interface is configured to generate a LEM for presenting a virtual disk to a virtual machine that is running a secondary OS. In some embodiments, the system comprises a base OS that is configured to generate a LEM when a virtual disk is requested from a secondary OS that is operating on the system. In some embodiments, the system comprises a base OS that is configured to generate a LEM when a user instructs the OS to create a virtual disk for a secondary OS that is operating on the system.

In some embodiments, the creation of a LEM by the base OS represents a virtual disk of a certain size, for example 10 GB, 20 GB, 30 GB, and the like. As discussed herein, in some embodiments, the LEM comprises a listing of pointers, wherein such pointers are pointing to data elements in the genome. Accordingly, in generating a LEM to represent a virtual disk of a certain storage size, in some embodiments, the system is not generating a virtual disk that actually has the particular storage size that is being presented to the virtual machine. Rather, in some embodiments, the system is using statistical modeling and/or statistical predictions to generate the virtual disk that represents a particular storage size. In other words, in some embodiments, the system is creating a LEM to represent a virtual disk by using a listing of pointers to data elements stored within the genome, wherein such data elements are used over and over again by other pointers in the system, thereby avoiding the need to have such data elements be repeatedly stored into RAM. In some embodiments, by avoiding the need to repeatedly store into RAM data elements that are identical, the system need not create a virtual disk of a particular size storage size by allocating actual storage space in the RAM that is equivalent to the particular storage size that is represented by the LEM. Rather, in some embodiments, the system can allocate actual storage space in the RAM that is far less than the particular storage size that is represented by the LEM.

Virtualization of a Virtual or Physical in-Memory Disk(s) in an Operating System (OS)

As illustrated above, in some embodiments, the hierarchy of a system that allows server virtualization can comprise a lower level system, called a hypervisor that runs on an OS (e.g., Linux or Windows, but could be purpose-written). In some embodiments, this lower level system allows virtual machines (VMs or guests, e.g. OS instances running one or more applications) to run along with other guests at the same time). In some embodiments, for each OS instance running under the hypervisor, each OS creates system and data disks for OS and application use. Traditionally, these disks are physical disks that are made up of pieces of HDDs or SSDs, but could be virtual (e.g. RAID storage of which a portion of the RAID storage, which is a group of disks set up by the OS guest system setup software, something within external storage to the box the OS guest is running in (e.g. array controller) organized to provide data protection and/or performance). However, within OS's today, a ‘physical disk’ may be made up of RAM or other block based memory (flash, cross-point RAM, re-RAM, or any other solid state block based memory). This lower level system can be in hardware or run on hardware.

As described herein in some embodiments, with RAM or block-based memory, virtual peripheral storage volumes/partitions can be created, and these can translate to virtual RAM/block based memory, which can then translate to virtual encoded RAM/block based memory. All of this can allow for non-contiguous memory to be used to allow for fault tolerance while still being so much faster than peripheral storage such that peripheral storage is no longer required for random, small block IO, as is typically done with HDDs and SSDs. In some embodiments, this virtualization technique allows for RAM/block based memory based ‘disks’ to relegate peripheral storage to what it was before DRAM was invented, i.e., sequential large block IO for ingress of input raw data and output/storage of derived information from the application that operated upon the input raw data.

As illustrated above, in some embodiments, the system, at a hardware level and/or at a lower system software level that supports virtual machines (which in some cases can be a hypervisor, or the OS, or a program running in the system), can be configured to utilize LEMs and/or bit markers to virtualize and/or virtually represent virtual or physical memory outside of a virtual machine OS that is running on the system. In particular, LEMs can comprise a bucket of pointers that point to physical addresses in the memory. As such, in some embodiments, when an OS in a virtual machine reads or writes seemingly continuous data, the virtual machine's OS interacts with the system, wherein the system can be configured to utilize LEMs to retrieve one or more pointers to fetch raw data from memory, which in fact is not contiguous, to present to the virtual machine's OS.

In some embodiments, a higher level OS, for example, an OS for a virtual machine, can be configured to virtualize a memory disk by one or more processes at an OS level as opposed to at a hardware level and/or at a lower system software level that supports virtual machines. In other words, in some embodiments, a high-level OS can be configured to process the virtualization as described below. In particular, in some embodiments, an OS can be configured to access and utilize a translation table between a virtual address and a physical address of a memory. The translation table can be located inside the OS or outside, for example in a hypervisor. In some embodiments, when an OS requests one or more bytes of data that are contiguous or at least seemingly contiguous, the OS can be configured to access a translation table, which translates such seemingly contiguous data blocks into physical locations or addresses in the memory. As such, in some embodiments, the OS can fetch the raw data from the memory for use by use of such translation table.

In some embodiments, virtualization and/or virtual representation of a virtual or physical memory disk(s) can encode raw data, for example by use of a translation table. Further, in certain embodiments, virtualization and/or virtual representation of a virtual or physical memory disk(s) can also provide increased capacity or virtually increased capacity, for example by use of bit markers, and/or increased performance, for example by decreasing the number of read and/or write processes required by a computer system. In some embodiments, virtualization and/or virtual representation of a virtual or physical memory disk(s) can also be used to duplicate data on bad memory, thereby resolving any related issues.

Virtualization of memory disks can also be advantageous to allow mixing and matching of different media types, including those that are fast and slow. For example, in certain embodiments, a LEM outside of an OS or translation table can determine whether one memory media should be used over another memory media depending on its characteristic, such as fast or slow.

Generally speaking, certain OSs are configured to utilize block media, such as for example hard drives or FSBs. At the same time, certain OSs can be able to tell the difference between a memory disk, such as volatile RAM, compared to a block disk. Certain OSs can also allow a user to set up cache, virtual memory, and/or a virtual disk, which can be physical in the sense that it can be based on memory or another physical disk. In some embodiments, the ability to set up a virtual disk can be thought of as an added feature on top of the base OS. For example, in some embodiments, an OS can comprise a volume manager that is configured to set up one or more volumes for physical disks and/or virtual disks, such as RAID volumes.

In other words, generally speaking, certain OSs, such as Microsoft Windows Linux or any other OS, can allow ‘disks’ to be made up of memory, which can be ‘contiguous’ segments of memory made for typically small usages, for example possibly to hold an image of an executable program or store something fast for an application without the normal use of peripheral storage. In certain cases, if anything happens with respect to hardware errors in writing or reading of the memory, the data can be corrupt, as it can be seen as a ‘physical’ ‘disk’ to the OS. Generally speaking, in certain computer systems and/or servers, when such errors occur, the system and/or server can be configured to assume that the data has been stored already persistently within a peripheral storage device or that the data is lost and either has been made to be a ‘don't care’ as the data was a ‘scratchpad’ for intermediate results or used as some sort of cache to sit in front of peripheral storage, all of which can be assumed to be a ‘normal’ case.

However, in some embodiments described herein, the system can be configured to use memory disks as mainline disks (system or application disks). In some embodiments in which the system does not periodically use peripheral storage to cover power failures or cell failures, data within the memory disk can be lost upon error, power failure, cell failure, or the like. In some embodiments, if a UPS is enabled, the memory disk can still be open to data loss for any double bit ECC error or otherwise uncorrectable error in a byte, word, or block of memory.

Accordingly, in some embodiments described herein, the system can be configured to allow virtualization and/or virtual representation of a virtual or physical in-memory disk(s) including volatile RAM, non-volatile RAM, ReRAM, XPoint memory, Spin-RAM, dynamic memory, memristor memory, or any other type of memory. As such, in some embodiments, the type of RAM disk can be that which is exactly RAM, meaning random access down to the byte or new, block based ‘memory’ that can be placed on the CPU RAM bus and treated in a virtual manner as described herein. In particular, in some embodiments, the system can be configured to allow virtualization and/or virtual representation of a virtual or physical in-memory disk(s) within an OS and/or outside of an OS. In some embodiments, a virtual RAM disk can be a RAM disk that is potentially created by an OS or other entity underneath an OS (such as hypervisor, Formulus Black forCE OS, etc) that basically abstracts the access to RAM so that the memory involved within the virtual RAM disk. The OS can be any OS, including but not limited to Microsoft Windows, Mac OS, Unix, Ubuntu, BeOS, IRIX, NeXTSTEP, MS-DOS, Linux, or the like. Further, in some embodiments, the system can allow virtualization and/or virtual representation of a virtual or physical RAM disk(s). In some embodiments, virtualization and/or virtual representation of a virtual or physical RAM disk(s) can utilize one or more processes described herein relating to bit markers, LEMs, or the like.

More specifically, in some embodiments, virtualization and/or virtual representation of a virtual or physical RAM disk(s) can comprise translating a physical address on a RAM disk to a virtual address or vice versa. In other words, virtualization and/or virtual representation of a virtual or physical RAM disk(s) can comprise virtualizing what the physical or virtual nature of a particular RAM disk that can involve rerouting. As a non-limiting example, in some embodiments, virtualization of a physical or virtual RAM disk can be thought of as an organizational feature.

In some embodiments, the system can comprise a feature within an OS, such as a volume manager for example, that allows a user to virtualize RAM disk. In some embodiments, in order to virtualize virtual or physical RAM within an OS, the system can be configured to utilize one or more different mapping techniques or processes. For example, an OS can be configured to process in terms of physical addresses, such as outputting a physical address in the kernel of the OS or the like. In some embodiments, the mapping can comprise a translation table between a virtual address and a physical address or vice versa. In some embodiments, by providing such mapping to virtualize RAM disk, data can be encoded and/or the capacity and/or performance of RAM can be increased. In some embodiments, one or more drivers can be configured to re-route the physical address based on which the OS is processing to a virtual address or vice versa. In some embodiments, the system can be configured to use LEMs as described herein to conduct a more direct mapping instead of re-routing by use of drivers, for example outside of the OS.

In some embodiments, the mapping technique or process does not need to be to contiguous memory. While an OS may view the virtualized RAM disk as a contiguous disk, as is the case with a conventional hard drive, the system, through virtualization and/or mapping, can in fact convert the physical address to a virtual address on the RAM, in which data can be accessed individually in any order or point. In other words, in some embodiments, the system can be configured to present one or more virtual block addresses or virtual byte to the OS such that the OS thinks that it is accessing physical block addresses. However, such virtual block addresses or virtual byte addresses may in fact have no linear normal physical relationship to the underlying memory. As such, in some embodiments, while an OS may know that it is talking to RAM and access bytes by some contiguous state, a translation table and/or virtualization process between the OS and the RAM can be configured to translate such contiguous bytes into physical addresses in the RAM where the data is stored. Thus, in some embodiments, the system can be configured to represent seemingly contiguous bytes of data that the OS needs to read, even though the data may not in fact be in linear order but rather stored in random locations on RAM.

In some embodiments, the mapping or rerouting does not need to be contiguous. As such, in some embodiments, a level of indirection is provided to allow for fault tolerance of the RAM disk in order to get around the problem with conventional RAM disks that require contiguous, working RAM. In some embodiments, indirection can allow for bad location re-mapping or re-vectoring. Also, in some embodiments, the access, although with more instructions, may still be on the order of memory access as the additional instructions to get to the actual data for read or write can be small in the number of CPU cycles as compared to any disk made up from peripheral storage.

In some embodiments, the system can be configured to generate and/or utilize an Encoded Virtual RAM Disk(s). In some embodiments, an Encoded Virtual RAM Disk(s) can be a virtual RAM disk(s) that allows encoding and/or decoding of data within the virtual RAM disk(s), for example relying on any one or more features of a base virtual RAM disk as described herein.

In some embodiments, encoding for data reduction, which can also provide security for the data, can allow the overall computer system to operate or run faster without the need for peripheral storage at all, for example in a computer system with dual external power in which power never becomes an issue for volatile RAM. In particular, in some embodiments, data reduction with a virtual RAM disk(s) can allow less writes to occur to the memory as the encoding engine can take substantially less time to encode than to write to external storage and therefore take up less bandwidth of the CPU memory as well as overall space within the fixed RAM size of a given computer system. In some embodiments, encoding can be for use in security, such as encryption, data-reduction, or both in reads and writes to/from the RAM. Furthermore, in some embodiments, an Encoded Virtual RAM Disk(s) can comprise one or more memory types for such uses as ‘tiered’ performance, in-line upgrade or replacement, and/or for different encoding or security types within the virtual RAM disk, for use by multiple applications at the same time, but at different sections of the virtual RAM disk.

### Clustering

The in-memory computer systems, devices, and methods described throughout this application can be used for a wide variety of purposes. In some embodiments, the in-memory computer systems can include one or more of the additional features described below, including but not limited to clustering, virtual machine mobility, data security, and/or data backup functionality.

In some embodiments, in-memory computer systems can be clustered together in various ways to provide additional functionality, high availability, fault tolerance, and/or data protection.

In a first example, two or more in-memory computer systems can be arranged into a cluster by connecting them communicatively over a network (e.g., Ethernet, fiber, etc.) or over a memory channel as described above. In this arrangement, it is possible to move virtual machines between the clustered in-memory computers. Moving virtual machines can be achieved using, for example, a software platform. Virtual machine mobility is described in greater detail below.

In another example, two or more in-memory computers can be clustered together by replicating memory of a first in-memory computer to half of another independent in-memory computer. This may be considered an active-active cluster configuration and is mentioned above. In this case, the first in-memory computer dedicates a portion of its memory to running its own virtual machines and applications and another portion of its memory to backing up another clustered in-memory computer. If either in-memory computer goes down, the surviving computer can take over. In another example, the in-memory computers can be active-passive clustered, with one in-memory computers actively running guests while another in-memory computers is used merely to back up the memory of the first and to take over only in the event that the first fails.

In another example, guests (e.g., virtual machines) on two or more in-memory computers that can be clustered using their own OS/guest clustering, while, at the same time, lower level software or hardware running on the in-memory computers replicates virtual disks of the virtual machines between the in-memory computers. This can allow for high availability for the OS/guest for its active-passive or active-active application between the in-memory computers.

In another example, guests (e.g., virtual machines) on two or more in-memory computers, each having their own set of virtual machines in each half of their memory while replicating their half to their partner (e.g., active-active), can failover to the other in-memory computers because the ‘state’ of each guest's memory is also replicated either in software or hardware to the other in-memory computers. In some embodiments, this can be accomplished with hardware that automatically replicates any RAM write to another region of memory upon setup.

### Virtual Machine Mobility

In some embodiments, the in-memory computer systems, devices, and methods described herein can allow improved and highly efficient cloning and transfer of virtual machines (VMs).

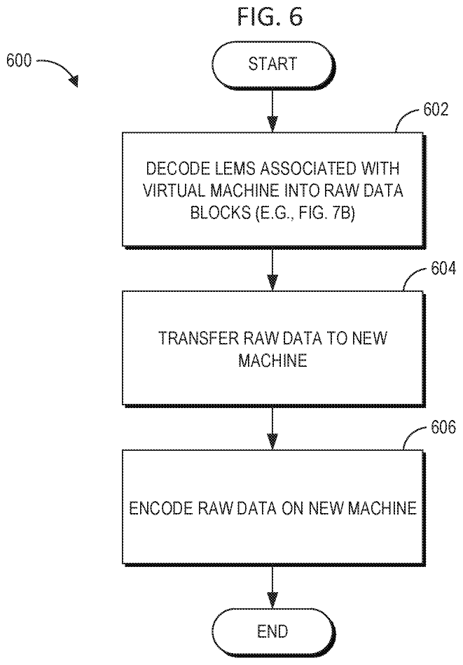

FIG. 6 is a flowchart illustrating an example method 600 for transferring virtual machines between in-memory computer systems according to some embodiments. In the illustrated example, the method begins at block 602 at which LEMs associated with the VM to be transferred are decoded on the source machine. In some embodiments, this converts the encoded, compressed data associated with the VM into raw data.

In some embodiments, at block 604, the raw data is transferred to the target machine. Transfer can occur, for example, over a memory channel (see, e.g., FIG. 2), if available. This can greatly increase the speed of the transfer. In some testing, it has been determined that the in-memory computer system efficiently performed virtual machine state and storage movement between in an in-memory computer system over a memory fabric at 3-10 times the throughput as today's fastest Ethernet networks (40 Gb-100 Gb), in addition to much less latency. In some embodiments, the transfer can also occur over a network connection, such as an ethernet connection or a fiber channel.

In some embodiments, the method continues at block 606 on the target machine. In some embodiments, if the target machine is an in-memory computer system the received raw data can be encoded on the target machine. In some embodiments, this can involve setting up new LEMs on the target machine.

Notably, in some embodiments, the encoding of the VM data on the target machine may not (and likely will not) match the encoding of the VM data on the source machine. This can be because each machine has its own CESSP and has developed its own bit markers and encoding methods based on the data it is has previously ingested.

In some embodiments, cloning a VM on an in-memory computer can also be accomplished simply. For example, it may only be necessary to create a copy of the LEMs associated with the VM.

### Fractal Algorithm

In some embodiments, the system can be configured to utilize a fractal algorithm to implement bit markers in a computer system. In some embodiments, a fractal algorithm requires more overhead processing (which can be overcome by using a slightly faster CPU, but the ROI of cost/performance by using this algorithm method is about 10-1, which makes it not only viable, but obvious to move towards), but a fractal algorithm can provide more storage capacity on a RAM device than other bit marker implementations. In some embodiments, the system is configured to comprise a processor with an integrated FPGA, ASIC, or integrated into a CPU chip that can be configured to process the fractal algorithm, which in some embodiments, can reduce the overhead processing times and/or processing work that a fractal algorithm can require. In some embodiments, an FPGA chip, or additional hardware integrated into the CPU of the system can improve processing speeds to account for increase computational processing thereby yielding high performance with increased storage capacity made possible using a fractal algorithm.

In some embodiments, the system implements bit marker technology by utilizing fractal algorithms to compute pointers and/or where the data is located in memory. In some embodiments, the computing of pointers and/or where the data is located in memory allows the system to re-create the raw data that has been deconstructed and stored in memory as various data vectors based on bit marker technology. In some embodiments, the use of fractal algorithms to implement bit marker technology can result in a 30×, 40×, 50×, 60×, 70×, 80×, 90×, or 100× improvement in the storage capacity of memory. In some of the embodiments, the use of fractal algorithms to implement bit marker technology can require additional overhead processing which can be accounted for using hardware accelerator technology, such as FPGA chips with in a processor. In some embodiments, the system uses hardware acceleration to account for increased overhead processing due to the use of fractal algorithm(s). In some embodiments, the system is configured speed up processing to account for using fractal algorithm(s) by using an optimized memory block size, also referred to as grain size, that does not have as much overhead to make use the fractal algorithms more efficient.

### Disk Array Controller

In some embodiments, the system, device, or method, utilizing only a processor and memory, is configured to become a disk array controller. In some embodiments, the system acting as a disk array controller comprises a server front end portion and a disk controller backend portion, wherein the front-end server portion interfaces and communicates with other systems to present the storage devices as one or more logical units.

In some embodiments, the system, using only a processor and memory in combination with a backup energy source, is a merge of a server and a redundant storage array controller and comprises data protection, high availability, error recovery, data recovery, and/or fault tolerance. In some embodiments, the system disclosed herein are a new computer design that fuses computing and storage. In some embodiments, the systems disclosed herein act as a server and a front end of an array controller. In some embodiments, the systems disclosed herein reduce the need for external storage performance to only be that of sequential IO or transfers with high bandwidth. In some embodiments, the system, utilizing only a processor and memory, is configured to make memory the only storage media for data storage and applications and other systems. In other words, in some embodiments, the data remains in a memory BUS in the systems disclosed herein.

In some embodiments, the system is a RAID controller and/or an array controller. In some embodiments, the system cannot lose data because if any data is lost the system may not have the necessary pointers and/or data vectors and/or bit markers and/or raw data and/or the like to reconstruct the raw data that has been deconstructed and stored in memory. Accordingly, in some embodiments, the system is configured to remove from usage any data lines and/or integrated circuits of the memory that return a single bit error out because the system does not want to lose data stored in the memory. In some embodiments, the system is configured to track and monitor any data lines and/or integrated circuits of the memory that return a single bit error out because such data lines and/or integrated circuits of the memory are deemed suspect because the system does not want to lose data stored in the memory. In some embodiments, the system can be configured to remove from usage any data line and/or integrated circuit that returns a number of bit error out that exceeds a threshold level based on the tracking and monitoring. In some embodiments, they system is configured to replace data lines and/or integrated circuits of the memory that have been removed from usage with spare data lines and/or integrated circuits of the memory that have been set aside to replace bad memory elements. In certain embodiments, the system is configured to set a pre-determined percentage of spare memory space for re-vectoring of bad locations in memory and because accessing memory is based on random access, there is no processing penalty for re-vectoring bad locations in memory. In contrast, the re-vectoring of hard disk drives incurs a large penalty because extra cylinder seat time is required to perform the re-vectoring.

### Read/Write

In some embodiments, the system, device, or method is configured to read and/write between the processor and the memory in 4k memory blocks. In some embodiments, the system is configured to read and/write between the processor and the memory in 1k memory blocks. In some embodiments, the system is configured to read and/write between the processor and the memory in 64 byte memory blocks. In some embodiments, the system is configured to read and/write between the processor and the memory using adjustable or variable memory block sizes. In some embodiments, the system is configured to dynamically adjust or vary the memory block size being used based on the system environment and/or the processing environment, for example, at the moment of processing.

In some embodiments, the system, device, or method, utilizing only a processor and memory, is configured to interface between various virtual machines and/or other systems operating on the computing system in order to allow such virtual machines and/or other systems to read and write data to the memory storage by utilizing the meta-data, pointers, LEM, and/or other data structures disclosed herein. In some embodiments, the process described above can occur at the kernel level of the system.

In some embodiments, the system, device, or method, utilizing only a processor and RAM, comprises an OS and/or an application or other interface, where in such OS, application, or other interface is configured to read in raw data and determine whether the raw data element is unique or whether the raw data element has been identified previously from reading other raw data. In the event that the raw data element is unique, the system can be configured to convert such raw data into a new bit marker and/or store such raw data in the genome and make such unique raw data element a part of the dictionary of data elements that can be recycled or reused or pointed to in the future by other applications, systems or the like. In some embodiments, the process described above can occur at the kernel level of the system.

In some embodiments, the system, utilizing only a processor and memory, is configured to read in raw data and have such raw data be analyzed by the OS, and some environments, at the kernel level, where in the OS is configured to determine whether the right data is unique or non-unique. In the event that the data is unique, the system in some embodiments is configured to convert or encode the unique data as a bit marker and/or store the unique data in the genome and/or encode the data in some other fashion for storage in the memory storage. In the event that the raw data is non-unique, the system in some embodiments is configured to determine the location of where the non-unique data is stored in the memory storage and generate a pointer to the location of the non-unique data. In some embodiments, the pointer is configured to point to a bit marker, a raw data element, a data vector, a data element, a pointer, encoded data, a virtual disk, a LEM, or some other data, all of which can in some embodiments be stored in the memory storage.

For example, the system can be configured to receive three blocks of raw data elements. In analyzing the first block, the system can be configured to identify the first block as a unique data element that the system has never received before, in which case, the system can be configured to store the first block into memory storage. In analyzing the second block, the system can be configured to identify the second block is the same as the first block, and other words the second block is non-unique data, in which case the system can be configured to generate a second pointer to the location in which the first block is stored in memory storage. In some embodiments, the system can be configured to identify the third block is the same as some other previously read block of data, in which case the system can be configured to generate a third pointer to the location in which the previously read block is stored in memory storage. In some embodiments, the system can generate a first pointer to the location in which the first block of data is stored in the memory storage.

In some embodiments, the system can be configured to store in a LEM the first pointer, the second pointer, and the third pointer in order to create a representation of and/or an encoding of the three data blocks. In some embodiments, the system is configured to receive a request, for example, from an application and/or a virtual system and/or other entity operating on the system, to read the three data blocks. In some embodiments, the system is configured to intercept such requests, for example, at the kernel level, and identify the pointers, which can for example be stored in the LEM, that are associated with the three data blocks. In some embodiments, the system is configured to utilize the three pointers in order to identify the location of the raw data elements stored within the genome. In some embodiments, the system is configured to retrieve the raw data elements stored in the genome and return the raw data elements to the entity that requested to read the three data blocks. In some embodiments, the pointers can be configured to point to raw data elements, other pointers, bit markers, data vectors, encoded data, and the like. In the event that the pointer is pointing a bit marker, then in some embodiments, the pointer is pointing to another pointer and/or an element in a bit marker table (as known as a bit marker translation table), which in turn is pointing to a raw data element.

In some embodiments, when the system writes the first data block to the memory storage, the system need not write that first data block to the memory storage again because any time a new data block is read and matches the first data block, the system can simply refer, through generating and storing a pointer, to the location where the first data block is stored in memory storage. By generating and/or storing and/or reading a pointer as opposed to raw data that is stored in memory whether or not such data is unique or non-unique, the system, device, or method, utilizing only a processor and memory, can minimize access to the memory storage, resulting in maximizing processing performance of the system because the system is analyzing raw data for real differences across the entirety of the data. By generating and storing a pointer, the system can make more efficient use of the memory storage because the byte size of a pointer is far less than the byte size of the first data block. For example, a pointer can comprise 4 bytes in a 32 bit machine or 8 bytes in a 64 bit machine, whereas a data block can comprise 64 bytes, 1k bytes, or 4k bytes or more. Further, by not needing to write certain data blocks to the memory storage, the processing speeds of the system can be improved because the system need not waste processing time in writing relatively large blocks of data.

In some embodiments, the genome or the entire data set stored in the memory storage is referred to as a capacity efficient shared storage pool (CESSP) because by only storing unique raw data elements in the memory, the system has made the storage capacity of the memory efficient because storage space in the memory is not wasted by storing a non-unique data element. Further, in some embodiments, the system requires that all the applications, OSs, virtual machines, user data, and any other entity operating within the system to use the entire data set as a dictionary for accessing and storing raw data elements, thereby resulting in the system creating a shared storage pool of data that any applications, OSs, virtual machines, user data, and any other entity operating within the system can access. In some embodiments, all of the data, in every file, disk, partition or the like, which is stored in the system lives in the capacity efficient shared storage pool. In some embodiments, the capacity efficient shared storage pool is the sum of all data stored in the system. In some embodiments, every unique block that the system has read is stored in the capacity efficient shared storage pool. In some embodiments, it can be said that every unique block that the system has read is merged into the capacity efficient shared storage pool. In some embodiments, any entity operating on the system must utilize a set of pointers in conjunction with the capacity efficient shared storage pool to determine and reconstruct the raw data being requested to read. In some embodiments, the system requires to the use of hash tables, assumptions and predictions for determining and/or reconstructing the raw data from a set of pointers pointing to various data elements in the capacity efficient shared storage pool.

In some embodiments, the system is configured to receive a request to generate a disk partition of a certain size with a certain file system type. In some embodiments, the system is configured to generate a LEM, when a ‘disk’ is created by the user on the system with computer/ram/storage, which in some embodiments is a list of pointers, that is configured to return data in response to the request, wherein the data indicates to the requesting entity, for example a virtual machine, that there exists a disk partition of the requested size with the requested file system type. In some embodiments, the data returned is the data that was read into to the machine from external sources either by file transfer from another computer/server or from an external storage device to fill the memory with raw data and thereby the virtual disk, and thereby the LEM. In some embodiments, the generated LEM is configured to be transparent to the requesting entity, in other words, the requesting entity only sees a disk partition of the requested size with the requested file system type, and does not see a LEM and/or a listing of pointers.

### Memory Tunnel

In some embodiments, the system, device, or method, using only a processor and memory to primarily process data, can be configured to connect to other similar systems, which are also only using a processor and memory to primarily process data, through a memory channel/interface, which can also be referred to as a memory switch or memory tunnel. In some embodiments, a memory channel comprises 32 lanes of PCIE, which in some embodiments is capable of transferring 32 gigabytes of data per second. Many more options may exists with more lanes, faster lanes, or other types of memory sharing interfaces.

As compared to traditional networks of today, one can employ 100 gigabit networks switches that can only provide 12 gigabytes per second. Accordingly, by the system using a memory tunnel, the system can move data at a much more rapid pace and, in some embodiments, there is some additional latency in using a memory tunnel; however, in some embodiments, the system is able to become more fault tolerant and/or can ensure greater data protection for the system by allowing the system to move at great speeds virtual machines and/or mirroring data of the memory storage. In some embodiments, the systems disclosed herein that utilize a memory tunnel can move virtual machines and/or memory mirroring data in real time, batch mode, near real-time, and/or on a delayed basis.

In some embodiments, the system comprises two memory tunnel cards, which provides for 32 lanes of communication allowing the system to communicate at 64 gigabytes per second. In some embodiments, each memory tunnel card is operating at full duplex. In some embodiment, system comprises a first memory tunnel card operating at full duplex and a second memory card that is transferring data at 32 gigabytes per second in one direction. In some embodiments, the multi-computing system comprises a bit PCI switch to allow each of the computing systems within the multi-computing system to communicate with each other. For example, in a six node multi-computing system, each of the six nodes (specifically, each computing system) can be connected to a six node PCI switch to allow each node to communicate with every other node. In this example, the multi-computing system can be configured to perform pair-wise mirroring of the data stored in the capacity efficient shared storage of the memory in each of the paired computing systems. This can be advantageous for data protection and high availability of a multi-computing system.

### Multi-Computing System

In some embodiments, the system comprises two or more computing systems, wherein the computing systems primarily uses a processor and memory to process data, and communicate via a memory tunnel connection. In some embodiments, the foregoing multi-computing system can run into situations where one or more of the computing systems in the multi-computing cluster fails. In some embodiments, the system is configured to be able to send a kill message to one or more of the computing system in the multi computing cluster when there is a detection of a failure.

In some embodiments, the multi computing cluster is subject to a common mode failure (CMF), where in one issue can kill all of the computing systems in the multi computing cluster. In some embodiments, the multi computing cluster is subject to a no single point of failure (NSPF), wherein only one or some of the computing systems in the multi-computing cluster fails. In some embodiments, the multi-computing cluster is subject to a no common mode failure (NCMF), wherein multiple issues cause all the computing systems in the multi-computing system to fail.

Whenever a failure in a multi-computing system is detected, it can be advantageous to be able to send a kill signal to the failing computing system(s) in the multi computing system in order to maintain data integrity and/or data protection at all times even when faults are occurring in the system.

In some embodiments, a multi-computing system is configured such that the computing systems are paired with one other computing system. In some embodiments, the pairing of two computing systems in a multi computing system allows for data protection, high availability, and fault tolerance. In some computing environments, such as, on a ship or a trading floor, the computing systems must be available at all times and no data can be lost. In order to achieve the highest availability and fault tolerance in a multi computing system, it can be advantageous to have the data in the paired computing systems mirrored between the two computers. It can be more advantageous to mirror such data over the memory tunnel in order to have rapid mirroring of data between the two computing systems, which could occur much faster over a memory tunnel than over a standard network connection.

In some embodiments, the computing systems can comprise memory tunnel adapter or interface that can be configured to transmit data across a memory tunnel at 64 gigabytes per second, or 128 gigabytes per second, or higher. In some embodiments, the memory tunnel adapter or interface is configured to communicate at half duplex or full duplex. In some embodiments, the memory tunnel adapter or interface is configured to allow the computer systems in a multi-computer system to communicate at or substantially at memory BUS speeds thereby introducing only a small amount or no amount of latency between the two computing systems during data mirroring and/or other data transfer between the systems.

In some embodiments, the computing systems paired in a multi-computing system are configured to copy or mirror the capacity efficient shared storage pool (CESSP) data in each of the computing systems into the other computing systems. In other words, in some embodiments, the data stored in CESSP of a first computing system is copied or mirrored to the paired second computing system, and the data stored in CESSP of the second computing system is copied or mirrored to the paired first computing system. By copying or mirroring the data stored in the CESSP between computing systems, the combined system can be fault tolerant because if one of the two computing systems malfunctions or fails, then the failing computing system can rapid transfer all its virtual machines and/or data to the other functioning machine without significant or any downtime. In some embodiments, the moving of virtual machines and/or data only requires the moving of LEMs and/or bit markers and/or other pointers because all of the necessary data in the CESSP has been mirrored or copied to the functioning machine. In other words, all of the raw data is already stored in the other functioning machine because the data in the CESSP had been previously mirrored or copied from the failing computer system to the functioning computer system and only LEMs, bit markers, and/other pointers, which are significantly smaller in byte size than the raw data.

Accordingly, moving and restarting virtual machines and other data between paired machines can occur rapidly to achieve a fault tolerant system without data loss. In some embodiments, the mirroring or copying of data between the paired computing systems is performed in real-time, substantially real-time, periodically, batch mode, or other timed basis. In some embodiments, each paired computing system is configured only to make half of the memory available to the virtual machines, applications, and the like operating on the first computing system because the other half the memory of the first computing system is allocated to store the mirrored data from the second computing system as well as any other data from the second computing system that is needed to operate the virtual machines, applications, and the like. In some embodiments, when one of the paired computing systems fails, and the other computing system takes over the work of the failing computing system, the process can be known as fail over. In some embodiments, when the failing computing system recovers from a previous failure and is takes back the work previously transferred to the non-failing computing system, the process is called fail back.

For example, in some embodiments, a system can comprise two computing systems, both primarily using a processor and memory to process data without the need of a convention storage device, wherein the two computing systems are electronically coupled to each other through a memory tunnel to allow for communication speeds that are equivalent or are substantially near the data transfer speeds of a BUS channel. In this example, the system can be configured to operate 400 virtual machines, wherein virtual machines 1-199 operate on the first computer system and virtual machines 200-399 operate on the second computer system. The first computing system can be configured to store unique raw data elements and other data in a first CESSP stored in the memory of the first computing system. The second computing system can be configured to store unique raw data elements and other data in a second CESSP stored in the RAM of the second computing system. The first and second computing systems can be configured to generate LEMs for the virtual machines.

In the event that the second computing system malfunctions, for example, due to a hardware and/or software failure, the system can be configured to move virtual machines 200-399 that are operating on the second computing system to the first computing system by copying the LEMs associated with the virtual machines to the first computing system such that the LEMs, which in some embodiments are a listing of pointers, are pointing to the data in the second CESSP that is stored in the first computing system, wherein such data was mirrored from the second computing system. The process of the first computing system taking over all the work of the second computing system is in some embodiments known as fail over. While the first computing system is operating virtual machines 200-399, the first computing system, in some embodiments, is also running virtual machines 1-199, wherein the LEMs associated with virtual machine 1-199 are pointing to the data in the first CESSP that is stored in the first computing system. In some embodiments, when the second computing system has recovered from the previous failure, then the LEMs that are stored in the first computing system and that are associated with virtual machines 200-399 are moved, copied, or migrated to the second computing system, and the second CESSP that is stored in the first computing system are copied or mirrored to the second computing system in order for the second computing system to resume the work of operating virtual machines 200-399. In some embodiments, the process is called fail back.

In some embodiments, the two computer systems are running their guest OS's and applications in simple clustered methods where there is only one set of virtual machines (or guest OS's running applications), and in this case, the second system is there mainly for high availability, not to add additional virtual machines or applications. This can be based on the fact that many applications are not ‘highly available’ aware to be failed over. In some cases, depending on applications and environment, the system can include a clustered set of guests and data will be mirrored, but only one side will run the VMs and applications. When the side running the applications or VMs fails, the other side can take over. Thus, in some embodiments, the system may have an active-passive operation mode. Or, in some embodiments, the system may have an active-active mode for different VMs on both computers simultaneously that can failover as noted above (e.g., FIG. 2).

In some embodiments, a paired computing system comprises a specialized communication link between the paired computing systems in order to transmit heartbeat data between the two computing systems. In some embodiments, the heartbeat data provides information to the two computing systems that each of the computing systems is still functioning properly. In some embodiments, the specialized communications link between the two computing systems is separate from the memory tunnel communications channel between the two computing systems. In some embodiments, the specialized communications channel for transmitting heartbeat data is different from the memory tunnel channel in order to ensure that the heartbeat data is transmitted in the case of a failure in the memory tunnel channel communications link. In some embodiments, the first computing system is configured to generate a first heartbeat data, which is transmitted over the specialized communication channel, and the second computing system is configured to generate a second heartbeat data, which is also transmitted over the specialized communications channel. In some embodiments, the generating and transmission of the first and second heartbeat data helps to ensure that the two computing systems are aware that each computing system is communicating with another computing system that is alive and functioning in order to ensure that the data being transmitted by a first computing system is being processed by a second computing system.

In some embodiments, the system is configured to transmit a first heartbeat data over a specialized communications channel between the first and second computing systems, and the system is configured to transmit a second heartbeat data between the first and second computing systems over the memory tunnel communications channel. In the event that the system loses both heartbeats, in some embodiments, then the system can interpret the loss as being both communication channels have failed, which is a low probability event in view of the fact that the two heartbeats are communicating over two different interfaces and channels. Alternatively, in some embodiments, the system can be configured to interpret the loss of both heartbeats as meaning that one of the two computing systems has malfunctioned and/or is no longer responding and/or is no longer processing data. In which case, the system can be configured to send a one way kill signal. In some embodiments, the system is configured with a mechanism to generate a one way kill signal that guarantees to only terminate one of the two computing systems such that both computing systems do not terminate thereby ensuring that the system is fault tolerant and that no data is lost. In some embodiments, the system is configured to delay sending the one way kill signal to account for the situation wherein the non-responding computing system is in the process of rebooting. In some embodiments, to restart the terminated computing system, the system requires human intervention, for example, the non-responding computing system requires a hardware repair.

In some embodiments, where the non-responding computing system did not require a new memory storage, then the functioning computing system need only synchronize the new data from the CESSP stored in the functioning computing system with the old data in the CESSP stored in the previously non-responding computing system. In some embodiments, where the non-responding computing system did require a new memory storage or the entire computing system needed to be replaced, then the functioning computing system must copy or mirror the entire CESSP stored in the functioning computing system into the CESSP stored in the previously non-responding computing system. In some embodiments, the foregoing process is known as fail back.

In some embodiments, the system is not configured to automatically invoke a fail back process but rather requires a user to invoke the fail back procedure. In some embodiments, the system is configured to automatically invoke a fail back process when the system detects that the previous unresponsive paired computing system has become functional, for example, by detecting heartbeat signals from the previously non-responsive paired computing system.

In some embodiments, the system comprises a mother board having a one way kill circuit or other mechanism for generating a signal to terminate and/or reboot and/or shutdown the system. In some embodiments, the one way kill circuit can be invoked when paired computing systems cannot communicate between each other, which in some circumstances can create a split-brain situation wherein the paired computing systems that supposed to be working together are now working independently, and/or wherein the data mirroring is no longer occurring between the paired computing systems, which can lead to data corruption between the paired computing systems. In some embodiments, the system can be configured to use the one way kill circuit to stop a split-brain situation (a situation where two systems are up and running but cannot communicate as they must to maintain coherent data, which can and does lead in many cases to customer data corruption).

In some embodiments, the one way kill circuit is configured to only terminate one of the paired computing systems when both of the paired computing systems invokes the one way kill circuit available in each of the computing systems. In some embodiments, the one way kill circuits in the paired computing systems are configured to communicate with each other in determining which of the paired computing systems should be terminated. In some embodiments, the one way kill circuits are configured to determine which of the paired computing systems has more stored data in the memory, and is configured to terminate, shutdown, and/or reboot the computing system that has less stored data in the memory. In some embodiments, the one way kill circuits in each of the computing systems is configured to determine whether the computing system in which the one way kill circuit is embedded in has malfunctioned and/or is non-responsive. In the event that the one way kill circuit has determined that its host computing system has malfunctioned and/or is non-responsive, then in some embodiments the one way kill circuit is configured to communicate data to the one way kill circuit in the other paired computing system, wherein such data comprises information that one way kill circuit's host computing system has malfunctioned and/or is non-responsive, and/or data that indicates that one way kill circuit's host computing system should be terminated.

In response to receiving such data, the one way kill circuit in the other paired computing system can be configured to generate a one way kill signal to the other computing system thereby causing the other computing system to terminate, shutdown and/or reboot. In some embodiments, the one way kill circuit determines which of the paired computing systems is terminated based on whichever computing system can initiate and send the one way kill signal to the other computing system. In this scenario, both of the paired computing systems are operating but they are not communicating properly and accordingly it is only necessary to shut down one of the systems and it may not matter which one is shutdown.

In some embodiments, if only one of the computing systems is functioning, then the other computer system may not able to send off a one way kill signal, therefore resulting in the functioning computing system automatically sending a one way kill signal to the non-functioning system, which forcibly powers down or shuts down the non-functioning system. In some embodiments, the functioning computing system is configured to wait for a period of time, also referred to as a timeout, before automatically sending a one way kill signal to the other computing system in order for the non-functioning computing system to reboot in the event that the non-functioning system is in the process of rebooting.

In some embodiments, the functioning computing system is configured to perform a fail over procedure, or in other words take over the work of the non-functioning computing system which received a one way kill signal from the functioning computing system. In some embodiments, the functioning computing system can take over the work of the non-functioning computing system because the data stored in each of the RAMs in each of the paired computing systems is synchronized, in some embodiments, constantly, intermittently, periodically, in batch mode or by some other means, thereby each computing system has a coherent cache of the other computing system's data. In some embodiments, the functioning computing system is configured to instantly take over the work of the non-functioning computing system. In some embodiments, the functioning computing system is configured to fail over or take over after a period of time the work of the non-functioning computing system.

In some embodiments, the functioning computing system is configured to perform a fail back procedure, or in other words transfer the work of the non-functioning computing system back after the non-functioning computing has rebooted. In some embodiments, the functioning computing system is configured to copy or mirror the data related to the work of the non-functioning computing system that is stored in the capacity efficient shared storage in the functioning computing system to the non-functioning computing system. In some embodiments, the functioning computing system is configured to keep track of the changes or the delta or the new data related to the work of the non-functioning computing system that is stored in the capacity efficient shared storage of the functioning computing system since the system taking over the work from the non-functioning computing system. In some embodiments, the functioning computing system is configured to copy or mirror the changes or the delta or the new data to the non-functioning computing system after the non-functioning computing system has rebooted, assuming that the RAM in the non-functioning computing system was not replaced or reformatted or the data in the RAM was not otherwise erased. In some embodiments, the fail back procedure involves copying or mirroring all or some of the data associated with the work of the non-functioning computing system that is stored in the capacity efficient shared storage to the previously non-functioning computing system through the memory tunnel.

In some embodiments, paired computing systems comprise three channels of communication between each other. In some embodiments, paired computing systems comprise a memory tunnel channel for communicating data between each other. In some embodiments, paired computing systems comprise an ethernet network channel for communicating data between each other. In some embodiments, paired computing systems comprise a one way kill channel for communicating data between each other.

In some embodiments, the system is configured to perform load balancing by moving one or more virtual machines from a first computing system by copying or mirroring LEMs and in some embodiments the data referenced by the LEMs to a second computing system, which may be existing in the cluster of computing systems or may be new to the cluster of computing systems, through a memory tunnel, wherein the data referenced by the LEMs is stored in the capacity efficient shared storage of the first computing system. In some embodiments, the system in moving one or more virtual machines from a first computing system to a second system is configured to copy or mirror the all or a part of the capacity efficient shared storage of the first computing system to the second computing system. In copying or mirroring a part of the capacity efficient shared storage of the first computing system to the second computing system only the data referenced by the LEMs associated with the virtual machines being moved are copied from the capacity efficient shared storage of the first computing system to the capacity efficient shared storage of the second computing system. This can be advantageous because less data is being copied from the first to the second computing systems, and therefore less time and/or less computer processing is required. By requiring less time and/or less computer processing, the migration of virtual machines can occur rapidly, thereby reducing the amount of down time in restarting the virtual machine on the second computing system and increasing the availability of the virtual machine to users.

In some embodiments, where the first and second computing systems are paired such that the capacity efficient shared storages in the first and second computing systems are mirrored, the system is configured to perform load balancing through the migration of one or more virtual machines from the first to the second computing system by only copying the LEMs associated with the one or more virtual machines from the first to the second computing systems without copying the data referenced by the LEMs because such data already exists in the capacity efficient shared storage of the second computing system due to the mirroring configuration. The foregoing can be especially advantageous because only a relatively small amount of data is being copied from the first to the second computing systems (because in some embodiments, only copying pointers, which are small in size), and therefore less time and/or less computer processing is required. By requiring less time and/or less computer processing, the migration of virtual machines can occur rapidly thereby reducing the amount of down time in restarting the virtual machine on the second computing system and increasing the availability of the virtual machine to users.

In some embodiments, the system comprises a multi-computing system cluster, wherein paired computing systems within the cluster can electronically communicate with other paired computing systems within the cluster to transfer data and/or signals and/or migrate virtual machines to perform load balancing of tasks operating on the multi-computing system cluster. For example, the system can comprise four computing systems, wherein the first and second computing systems are paired and the third and fourth computing systems are paired. In this example, the paired computing systems are configured to mirror data between the two computing systems, specifically the first and second computing systems are configured to mirror data between each other, and the third and fourth computing systems are configured to mirror data between each other. The four computing systems can also be in electronic communication with each other. In some embodiments, the first pair of computing systems, specifically the first and second, can move virtual machines to the second pair of computing systems, specifically the third and fourth, in order to achieve load balancing within the cluster, which in such migration of virtual machines is performed using the methods disclosed herein, for example, utilizing a memory tunnel.

In some embodiments, the system is configured to copy or mirror data between paired computing systems. In some embodiments, such systems configured to copy or mirror data between paired computing systems are ideal for mission critical situations requiring no loss of data and no loss of availability; however, such systems can have system performance decreases due to increased processing power and/or network traffic (for example, increased overhead with the network) required to perform data copying or mirroring. Additionally, in some embodiments, each computing system can only use a portion, for example, a quarter, a half, three-quarters, of the memory storage because the non-used portion must be used for data copying or mirroring with the other paired computing system.

In some embodiments, the system is configured to be able to dynamically change from a copying or mirroring data configuration to a non-mirroring configuration where all the data in the memory is copied to a conventional storage device in real-time, substantially real-time, periodic basis or in batch mode, or the like.

In some embodiments, the systems, devices, and methods disclosed herein are configured to operate a plurality of virtual machines. In some embodiments, the systems disclosed herein can be configured to operate natively or raw without operating any virtual machines on the system because the entire system is being used to operate a single OS in order to provide maximum performance to the single OS and/or the software applications running over the OS and the system.

In some embodiments, the systems disclosed herein have one, two, three, four, or more network communications channels. For example, in a paired confirmation, where the system comprises two computing systems that are paired together, the system comprises first network communications channel in the form of a memory tunnel connection, which in some embodiments is a 32 bit PCI connection implemented in one or two or three or more network cards embedded or coupled to the motherboard of the computing systems. The system can also comprise a second network communications channel in the form of a standard ethernet communications channel to communication over a traditional network with other computing systems, including the paired computing system, and in some embodiments, heartbeat data is transmitted between the two paired computing systems over the ethernet connection (which in some cases is secondary heartbeat data), and in some embodiments communications to and from the backup energy sources and the system are transmitted over the ethernet connection. The system can also comprise a third network communications channel in the form of a serial connection between the paired computing systems, wherein the serial connection is coupled to the one way kill circuit or card or interface that is coupled to the motherboard of each of the paired computing systems. In some embodiments, the serial connection between the two computing systems is configured to transmit one way kill signals between the paired computing systems, and in some embodiments, heartbeat data is transmitted over the serial connection between the two computing systems.

### Computer-Implemented Methods

As discussed herein, in some embodiments, in-memory computer systems, devices, and methods comprise a computer-implemented method or software that operates or causes to operate one or more processes described herein. For example, in some embodiments, a computer-implemented method or software can operate on a specialized architecture computer system comprising or utilizing only a processor and memory, without conventional storage or without using conventional storage to regularly read/write data for processing, to facilitate reading and/or writing of data between the processor and memory.

Additionally, in some embodiments, a computer-implemented method or software can operate on a conventional or unspecialized architecture computer system, comprising a processor, memory, and conventional storage. However, in some embodiments, a computer-implemented method or software operating on such conventional or unspecialized architecture computer system can manipulate or change usage of memory and/or conventional storage, such that only or substantially only memory is used for regular reading and writing of data by the processor without using the conventional storage for such purposes. Rather, in some embodiments, a computer-implemented method or software operating on such conventional or unspecialized architecture computer system can be configured to utilize conventional storage only as back-up or for other secondary uses as described herein.

In some embodiments, a computer-implemented method or software, operating either on a specialized or unspecialized architecture computer system, can be part of the computer system's regular OS. In such instances, a computer-implemented method or software that is part of the OS can be configured to manage, translate, encode, and/or decode data and read/write requests of data by the processor as described herein. For example, the computer-implemented method or software can receive a read/write request from the OS and retrieve, encode, decode, and/or manage such requests by accessing and/or processing the data, bit markers, pointers, and/or the like stored in memory.

In some embodiments, a computer-implemented method or software, operating either on a specialized or unspecialized architecture computer system, operates on a level lower than the OS. In such instances, the OS can simply request a read and/or write process as it would normally do. However, in some embodiments, the computer-implemented method or software can intercept such read/write request from the OS and facilitate translation, retrieval, encoding, decoding, and/or management of data by accessing and/or processing the data, bit markers, pointers, and/or the like stored in memory. In some embodiments, as all read/write requests by the OS is intercepted and/or facilitated by the computer-implemented method or software operating at a level below the OS, the OS may have no knowledge of the data reduction, encoding, decoding, and/or management processes. Rather, in some embodiments, the OS may believe that it is simply reading and/or writing data in a conventional sense, for example to contiguous blocks of data either in memory or conventional storage, while actually the data may be read and/or written onto non-contiguous blocks of memory.

In some embodiments, a computer-implemented method or software for implementing one or more in-memory processes and data reduction, encoding, decoding, and/or management processes described herein may be installed on a computer system before or after installation of the OS.

In some embodiments, a computer-implemented method or software, operating either on a specialized or unspecialized architecture computer system, operates as an add-on or application at a higher level than the OS. In such instances, the OS can simply request a read and/or write process, which can trigger translation of the same by the computer-implemented method or software. The computer-implemented method or software can then facilitate translation, retrieval, encoding, decoding, and/or management of data by accessing and/or processing the data, bit markers, pointers, and/or the like stored in memory.

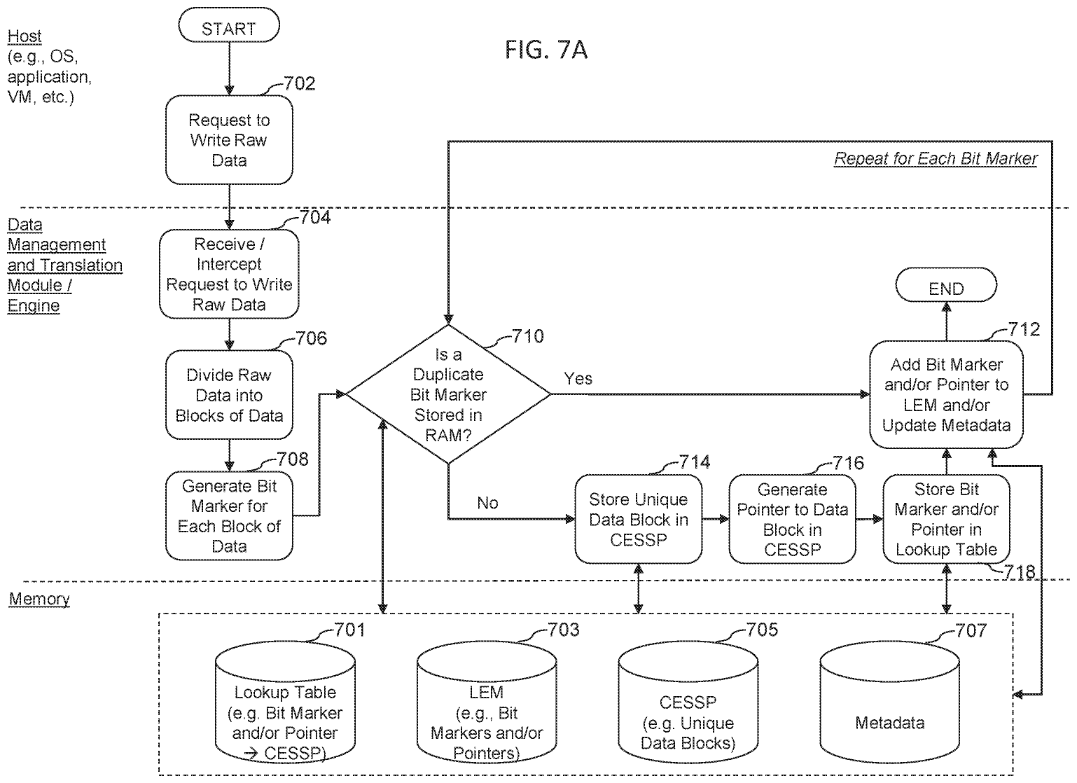

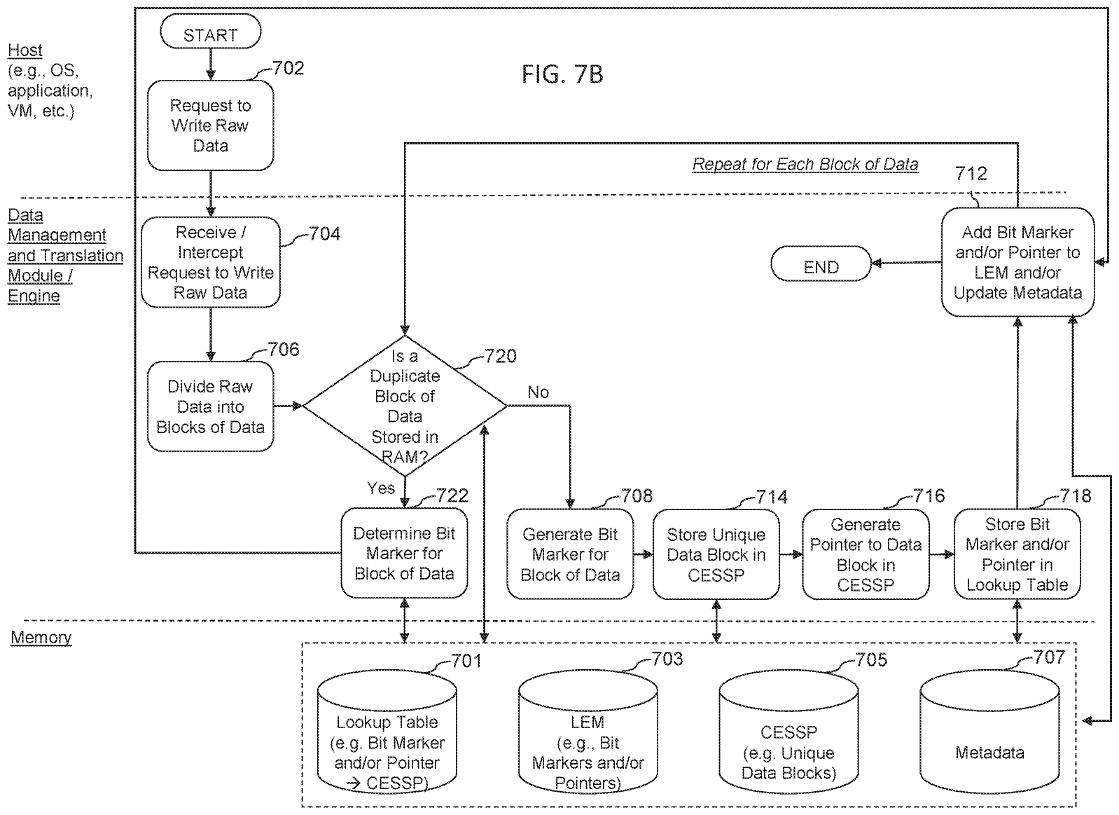

FIG. 7 is a flowchart illustrating an example method(s) for writing data utilizing in-memory computer systems, devices, and methods. As illustrated in FIG. 7A, in some embodiments, the host can request to write raw data at block 702. The host can be an OS, application, virtual machine, and/or the like.

In some embodiments, a data management and translation module or engine can receive and/or intercept the request to write raw data at block 704. As described above, in some embodiments, the data management and translation module or engine can, in some embodiments, be part of the host or be a separate OS or program running below or on top of the main OS. In some embodiments, the data management and translation module or engine can comprise the data reduction module as discussed herein and/or be configured to conduct one or more processes described herein as being performed by the data reduction module. In some embodiments, the data management and translation module can be computer software program configured to perform one or more in-memory computer system processes as described herein. In some embodiments, the data management and translation module can be implemented and/or installed on a specialized computer architecture system. In some embodiments, the data management and translation module can be implemented and/or installed on a conventional, unspecialized computer architecture system previously configured to utilize memory and conventional storage in a conventional way, thereby effective transforming the conventional computer architecture system into a in-memory computer system that utilizes only a processor and memory for regular data read/write processes without using conventional storage.

In some embodiments, the data management and translation module or engine is configured to divide the raw data into one or more blocks of data at block 706. For example, the data management and translation module or engine can be configured to divide the raw data into blocks of equal or varying lengths. In some embodiments, the data management and translation module or engine can be configured to divide the raw data in multiple ways, for example by dividing up the raw data at different points, thereby obtaining different blocks of data from the same initial raw data.

In some embodiments, the data management and translation module or engine is configured to generate a bit marker for each divided block of data at block 708. For example, in some embodiments, the data management and translation module or engine is configured to input each block of raw data into a hash function or other transformation that translates the same into a bit marker. In some embodiments, the transformation or hash function is configured such that the same block of raw data inputted into the transformation will result in the same bit marker.

In some embodiments, for each bit marker that is generated, the data management and translation module or engine is configured to determine at block 710 whether the generated bit marker is already stored in memory. In order to do so, in some embodiments, the data management and translation module or engine is configured to communicate with one or more databases (or other data structures) stored within memory.

For example, in some embodiments, the memory can comprise one or more look-up tables 701, one or more LEMs 703, a CESSP or gene pool 705, and/or one or more metadata databases 707. In some embodiments, one or more of the foregoing databases or data structures can be combined. In some embodiments, a look-up table 701 can comprise data that matches one or more bit markers and/or pointers to a unique block of data stored in the CESSP. In some embodiments, a LEM 703 can comprise one or more bit markers and/or pointers. In some embodiments, the CESSP 705 can comprise a collection of all unique blocks of data stored in memory. The CESSP 705 can also include bit markers and/or pointers in some embodiments. In some embodiments, a metadata database 707 can comprise metadata relating to the one or more bit markers and/or pointers, such as number of uses, order, and/or the like.

Referring back to block 710, in some embodiments, the data management and translation module or engine can be configured to determine whether each bit marker generated from the raw data to be written is already stored in memory by comparing each generated bit marker to one or more bit markers stored in one or more look-up tables 701, LEMs 703, CESSP 705, and/or metadata databases 707.

In some embodiments, if the data management and translation module or engine determines that a bit marker generated from the raw data to be written is already stored in memory, then the data management and translation module or engine can be configured to simply add the bit marker to the LEM at block 712. In addition, in some embodiments, the data management and translation module or engine can also be configured to retrieve from the memory a pointer to the corresponding block of data and add the pointer in the LEM at block 712. Further, in some embodiments, the data management and translation module or engine can be configured to update the metadata accordingly at block 712 to account for the additional instance of this bit marker and/or unique block of data.

In some embodiments, if the data management and translation module or engine determines that a bit marker generated from the raw data to be written was not previously stored in memory, then the data management and translation module or engine can be configured to store this new unique data block in the CESSP at block 714. Further, in some embodiments, the data management and translation module or engine can be configured to generate a pointer to the new unique data block in the CESSP at block 716. In addition, in some embodiments, the data management and translation module or engine can be configured to store the newly generated bit marker and/or pointer in a look-up table in the memory at block 718. In some embodiments, the newly generated bit marker and/or pointer can be added to the LEM at block 712. In some embodiments, the data management and translation module or engine can be further configured to update the metadata accordingly at block 712 to account for the new bit marker and/or unique block of data.

In some embodiments, the data management and translation module or engine can be configured to repeat one or more processes described herein in connection with FIG. 7A for each bit marker that was generated in block 708. In particular, in some embodiments, the data management and translation module or engine can be configured to repeat one or more processes described in blocks 710, 712, 714, 716, and/or 718 for each bit marker generated for each block of data in block 708. In some embodiments, once one or more such processes have been completed for each bit marker that was generated from the raw data, the write process can be completed.

FIG. 7B is a flowchart illustrating another example method(s) for writing data utilizing in-memory computer systems, devices, and methods. One or more processes illustrated in FIG. 7B comprise similar or the same processes as those described above in connection with FIG. 7A. In particular, those processes with the same reference numbers can include the same or similar features and/or processes.

As with certain processes described above in connection with FIG. 7A, in the embodiment(s) illustrated in FIG. 7B, in some embodiments, the host requests raw data to be written at block 702. In some embodiments, the data management and translation module or engine receives and/or intercepts such write request at block 704. In some embodiments, the data management and translation module or engine further divides the raw data into one or more blocks of data in block 706.

Unlike in those embodiments illustrated in FIG. 7A, in some embodiments such as those illustrated in FIG. 7B, the data management and translation module or engine can be configured to compare the one or more blocks of data directly with one or more unique blocks of data stored in the memory at block 720. That is, in some embodiments, rather than first generating bit markers from the divided blocks of raw data for comparison with bit markers already stored in memory, the data management and translation module or engine can be configured to compare the divided blocks of raw data directly with unique blocks of data stored in the memory at block 720. To do so, in some embodiments, the data management and translation module or engine can be configured to compare each divided block of raw data with those unique data blocks stored in a look-up table 701, LEM 703, CESSP 705, or anywhere else in R memory.

In some embodiments, if the data management and translation module or engine determines in block 720 that a duplicate block of data is already stored in memory, then the data management and translation module or engine then determines or identifies a bit marker corresponding to this block of data at block 722. In particular, in some embodiments, if a block of data is already stored in memory, then a corresponding bit marker can be already stored in memory as well. As such, in some embodiments, the data management and translation module or engine identifies and/or retrieves the corresponding bit marker from memory, for example from a look-up table 701, in block 722.

In some embodiments, then the data management and translation module or engine can be configured to simply add the bit marker to the LEM at block 712. In addition, in some embodiments, the data management and translation module or engine can also be configured to retrieve from the memory a pointer to the block of data and add the pointer in the LEM at block 712. Further, in some embodiments, the data management and translation module or engine can be configured to update the metadata accordingly at block 712 to account for the additional instance of this bit marker and/or unique block of data.

In some embodiments, if the data management and translation module or engine determines that a block of data derived from the raw data to be written was not previously stored in memory, then the data management and translation module or engine can be configured to generate a new bit marker for this block of data at block 708. In some embodiments, this new unique data block can be stored in the CESSP at block 714. Further, in some embodiments, the data management and translation module or engine can be configured to generate a pointer to the new unique data block in the CESSP at block 716. In addition, in some embodiments, the data management and translation module or engine can be configured to store the newly generated bit marker and/or pointer in a look-up table in the memory at block 718. In some embodiments, the newly generated bit marker and/or pointer can be added to the LEM at block 712. In some embodiments, the data management and translation module or engine can be further configured to update the metadata accordingly at block 712 to account for the new bit marker and/or unique block of data.

In some embodiments, the data management and translation module or engine can be configured to repeat one or more processes described herein in connection with FIG. 7B for each block of data that was derived from the raw data at block 706. In particular, in some embodiments, the data management and translation module or engine can be configured to repeat one or more processes described in blocks 720, 722, 708, 714, 716, 718, and/or 712 for each bit marker generated for each block of data in block 708. In some embodiments, once one or more such processes have been completed for each bit marker that was generated from the raw data, the write process can be completed.

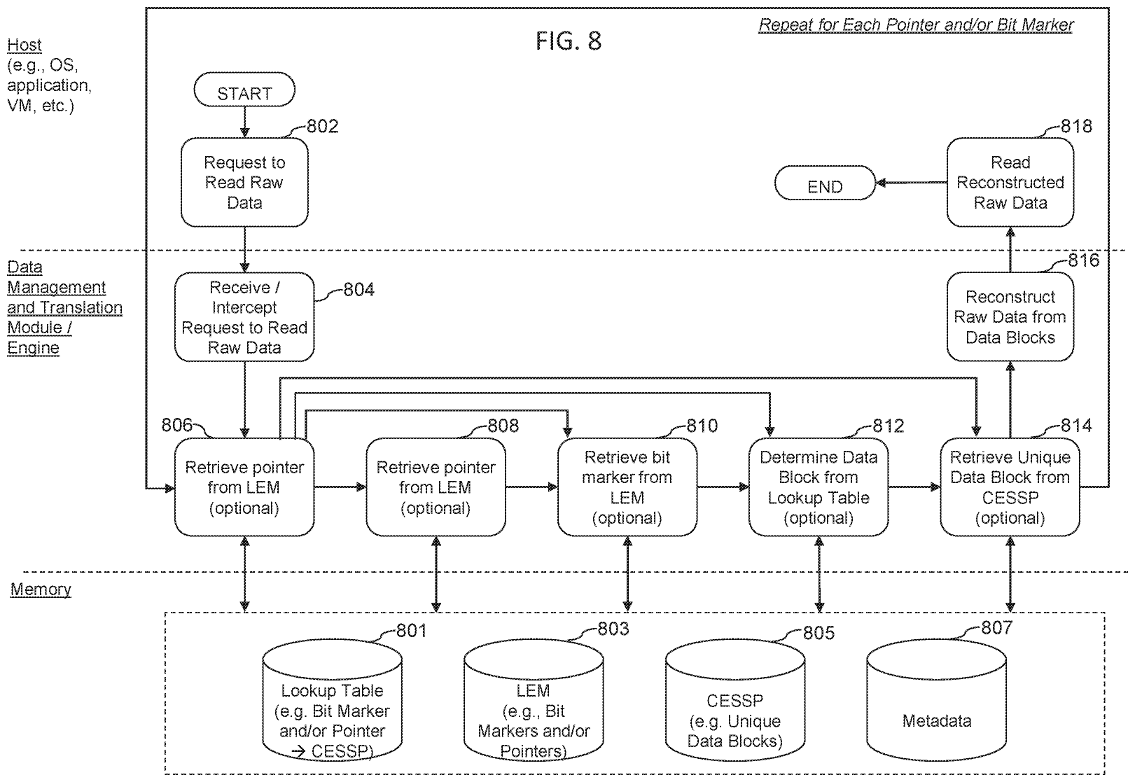

FIG. 8 is a flowchart illustrating an example method(s) for reading data utilizing in-memory computer systems, devices, and methods. As illustrated in FIG. 8, in some embodiments, the host can request to read raw data at block 802. The host can be an OS, application, virtual machine, and/or the like.

In some embodiments, the data management and translation module or engine can be configured to receive and/or intercept the request to read raw data at block 804. In some embodiments, the data management and translation module or engine can be configured to fulfill the read request from the host by communicating with the memory and/or one or more databases or data stored in the memory.

In particular, in some embodiments, the data management and translation module or engine can be configured to retrieve one or more pointers from the LEM 803 at block 806, wherein the one or more pointers can correspond to the location of stored unique data blocks that form the raw data that was requested to be read by the host. As discussed above, in some embodiments, a pointer can point to another pointer. As such, in some embodiments, the data management and translation module or engine can be configured to retrieve a second pointer from the LEM 803 at block 808.

Also, as discussed above, in some embodiments, a pointer can point to a bit marker. As such, in some embodiments, the data management and translation module or engine can be configured to retrieve a bit marker from the LEM 803 that the pointer pointed to at block 810. In some embodiments, a pointer itself can be stored within a look-up table 801. As such, in some embodiments, the data management and translation module or engine can be configured to access a look-up table 801 to determine the corresponding block of data at block 812. Further, in some embodiments, the data management and translation module or engine can be configured retrieve a corresponding unique data block from the CESSP 805 at block 814.

In some embodiments, one or more processes illustrated in blocks 806, 808, 810, 812, and 814 can be optional. For example, in some embodiments, once the data management and translation module or engine retrieves a first pointer from the LEM 803 at block 806, the data management and translation module or engine can then directly go to the CESSP 805 to retrieve the corresponding unique block of data at block 814. In some embodiments, once the data management and translation module or engine retrieves the first pointer from the LEM 803 at block 806, the data management and translation module or engine can use the first pointer to determine a data block corresponding to that pointer from a look-up table 801 at block 812.

In some embodiments, once the data management and translation module or engine retrieves the first pointer from the LEM 803 at block 806, the data management and translation module or engine can retrieve a corresponding bit marker at block 810, which can then be used to further retrieve the corresponding block of data. Also, in some embodiments, once the data management and translation module or engine retrieves the first pointer from the LEM 803 at block 806, the data management and translation module or engine can retrieve another pointer at block 808 that can be used to subsequently retrieve the corresponding block of raw data. In some embodiments, the data management and translation module or engine can be configured to directly use a bit marker to retrieve a corresponding raw data block, for example from look-up table as in block 812 or from the CESSP at block 814, without using or retrieving any pointers at all.

In some embodiments, one or more processes illustrated in and described in connection with blocks 806, 808, 810, 812, and 814 can be repeated for each bit marker and/or pointer for the raw data that was requested. In some embodiments, at block 816, the data management and translation module or engine reconstructs the requested raw data by combining the raw data blocks that were retrieved from the memory, for example by utilizing one or more processes illustrated in and described in connection with blocks 806, 808, 810, 812, and 814. In some embodiments, the reconstructed raw data is then read by the host at block 818.

### Non-Uniform Real-Time Memory Access (NURA)

In some embodiments, the systems disclosed herein are configured to allow the processor to access and/or be exposed to memory in a similar way to a media device, such as an SSD or HDD. In order to provide the processor with access to the memory as a media or storage device, in some embodiments, the system is configured to reserve a portion of the memory as a real time memory (RTM) media. In some embodiments, the memory storage elements are stitched or combined together into a media that is referred to herein as the RTM. In some embodiments, the process of reserving a portion of the memory as a RTM media starts during the boot up of the computer.

In a typical boot up process, the OS reserves some or all of the memory for the OS to utilize as fast access temporary storage for performing OS functions and for processing data. In some embodiments, the systems disclosed herein are instead configured to reserve all or substantially all of the available memory and only allocate a small portion of the memory for the OS during the boot up process. In some embodiments, the systems disclosed herein are configured to allocate the reserved portion of the memory, namely, the portion of the memory not allocated for the OS, for serving as the RTM media. For example, in some embodiments, the system boots up via a BIOS and a base OS, which loads drivers for networking cards, sound cards, display cards, a keyboard, a mouse and the like, and loads the kernel and a core algorithm engine of the system as disclosed herein. In some embodiments, the core algorithm engine may reconfigure the kernel in order to re-allocate the memory such that a small portion of the memory is allocated to the base OS and the remaining portion of the memory is allocated to the RTM media, which in some embodiments is controlled by the core algorithm engine.

The process of allocating memory as the RTM media enables the processor to access the RTM as standard media. In some embodiments, the base OS may inquire as to what type of media comprises the RTM. In some embodiments, implementations of the system may be configured to respond to the OS inquiry by stating that the RTM is a memory backed storage, and in response the OS treats the RTM as a similar category media as an SSD or HDD. In some embodiments, the core algorithm engine comprises a driver that can reside in the base OS for allowing communication with the RTM media. In some embodiments, the core algorithm engine is an encrypted system in order to prevent third-parties from determining how the core algorithm engine works or from accessing the data that is being processed by the core algorithm, all of which can help prevent reverse engineering of the core algorithm engine. In some embodiments, the calls made to and/or by the implementations of the system are also encrypted in order to prevent reverse engineering of the system. In some embodiments, the system is configured to compensate for a reduction in processing speed due to the encrypted calls and the encryption of the core algorithm engine because the system is processing all data in memory (for example, the RAM), without any use of a peripheral drive to process data.

In some embodiments, it can be advantageous to utilize the above described implementations of the systems in a multiprocessor platform and/or a clustering platform. For example, in the multiprocessor platform context, the system can be configured to allow for the addition of processors to the system without turning off or rebooting the system. The system may also enable the addition of one or more new processors to the system in real time, such that the new one or more processors can access the RTM media as soon as the one or more new processors have been added to the system. In another example, the system can be configured to allow for the addition of one or more new computer systems to an existing cluster of computers without shutting down or rebooting the existing cluster system, thereby allowing access to the additional of the one or more computer systems to the existing cluster system in real time, such that the new one or more computer systems can access the RTM media as soon as the new one or more computer systems have been added to the system. In some embodiments, the systems disclosed herein are configured to allow access, in real time without shutting down the system to the RTM media as a single memory pool, to the additional processors being added to a multiprocessor platform, or to the additional computing systems being added to an existing cluster system.

In some embodiments, the systems disclosed herein can be configured to add processors and/or computing systems that can access the RTM without having to reboot or shutdown the system by relying on a base OS, such as Unix, Linux, BSD, or the like to handle the physical hardware addition of new CPUs and memory via hot plugging technologies. In some embodiments, the system is configured to use hot plug technologies for managing the changing of hardware details, which has been abstracted by the OS.

In some embodiments, the systems disclosed herein comprise a core algorithm engine running on the base OS, and the core algorithm engine can be configured to probe the lower level hardware changes with no power cycle or reboot/shutdown involved. Based on the hardware changes, the core algorithm engine of the system can, in some embodiments, be configured to make corresponding modification, automatically in real-time or on demand, in the architecture policies of the system to enable the newly added processors and/or computer systems to access the RTM without shutting down or rebooting the system.

In some embodiments, the system is configured to identify the number of permitted processors/sockets that will be utilized for processing data in the system. In some embodiments, the number of permitted sockets/processors that are utilized by the system depends upon the number of licenses purchased or acquired by the user of the system. For example, in some embodiments, a system having a one processor license will only allow for one processor to be utilized by the system for processing data even though the computing system may have two or more processors in the platform.

Typically, when a computer system receives instructions or a sequence of instructions, the system sequences and schedules the instructions, or transmits the instructions to all the available CPUs of the system in a systematic fashion for processing. In some cases, the system uses a round-robin technique for processing such instructions. Further, the instructions typically must be in uniform format because CPUs expect instructions to be uniform in nature. Otherwise, the CPUs may not be able to process the instructions and/or the instructions may cause the CPU to lock-up and/or become more inefficient. In a multiprocessor system, there is also a sequencing of instructions processing, and this is referred to as a symmetric multiprocessor system. Symmetric multiprocessing (SMP) involves a multiprocessor computer hardware and software architecture where two or more identical processors are connected to a single, shared main memory, have full access to all input and output devices, and are controlled by a single operating system instance that treats all processors equally, reserving none for special purposes. Most multiprocessor systems today use an SMP architecture. In the case of multi-core processors, the SMP architecture applies to the cores, treating them as separate processors. In scaling from one processor to multiple processors, systems typically employ aligned architectures because instructions need to be scheduled in sequence to ensure that each CPU can process the instructions in an orderly process and at the correct timing. Otherwise, the CPU can become locked-up and/or inefficient by using more electricity and by overheating or the like. Accordingly, CPUs generally expect instructions to be uniform and aligned. In some embodiments, the systems disclosed herein can be configured to provide processors instructions in a uniform and aligned manner. Contrastingly, in some embodiments, the systems disclosed herein can be configured to provide processors instructions in a non-uniform, non-aligned real-time manner.

Typically, a non-uniform memory access (NUMA) architecture generally refers to a shared memory architecture used in multiprocessing systems, wherein each processor is assigned its own local memory and can access memory from other processors in the system. In some embodiments, a processor that is locally accessing memory assigned to the processor provides a low latency and a high bandwidth performance whereas a processor accessing memory owned by another processor can have higher latency and lower bandwidth performance.

In some embodiments, a multi-processor system configured with uniform and aligned instructions can be enabled to access memory to find processors that are underutilized or “starved for data” due to the unified memory accessing instruction stream. However, in such a configuration there can be performance issues when multiple processors attempt to access the same memory. In contrast, a multi-processor system configured with a NUMA architecture attempts to address the shared memory issue by providing separate local memory for each processor, thereby avoiding the performance hit when several processors attempt to address the same memory. For problems involving spread data, which can be common for high performance servers and similar applications, a NUMA architecture can improve the performance of a system as compared to a single shared memory by a factor of roughly the number of processors (or separate memory banks).

In some embodiments, it may be advantageous for a system to provide scalable memory bandwidth. In some embodiments, to provide scalable memory bandwidth, the kernel, for example, a Linux kernel, may introduce a non-uniform memory access (NUMA) system.

To further improve the scalability of the systems disclosed herein, the systems can be configured in some embodiments to provide a non-uniform non-aligned RTM access (NURA) architecture to support platforms with N-way (N>=1) processors. In some embodiments, the non-uniform RTM access architecture improves the scalability of the core algorithm engine within a SMP environment.

In general, SMP embodiments can involve the use of a multiprocessor computer hardware along with a software architecture where two or more processors are connected to a single, shared main memory. In some embodiments, such SMP embodiments are configured to enable the two more processors to have full access to all input and output devices, including but not limited to the memory. In some embodiments, such symmetric multiprocessing embodiments are configured to enable the two or more processors to be controlled by a single OS instance that, and in some embodiments, the single OS instance can be configured to treat all processors equally, reserving none for special purposes. In some embodiments, the systems disclosed herein can be configured such that one or processors have restricted or priority access to all input and output devices, including but not limited to the memory, and in some embodiments, the systems disclosed herein can be configured to comprise a single OS instance that is configured to treat one or more processors with higher priority over other one or more processors. In some embodiments, the systems disclosed herein can comprise multi-core processors, in which case the SMP architecture can apply to the cores, treating each of them as separate processors.

In some embodiments, the purpose of NUMA systems disclosed herein is to enable a suitable model for various coding software modules. With a suitable framework model, it can be possible detect contradictions prior to coding of various software modules and/or can be used as a reference for how such software modules interact at a high level.

In some of the embodiments, the systems may utilize some or all of the basic procedures and structures, such as the system initialization, physical memory layout and management, core engine modules control flow and data path, and user application practice, as illustrated herein.

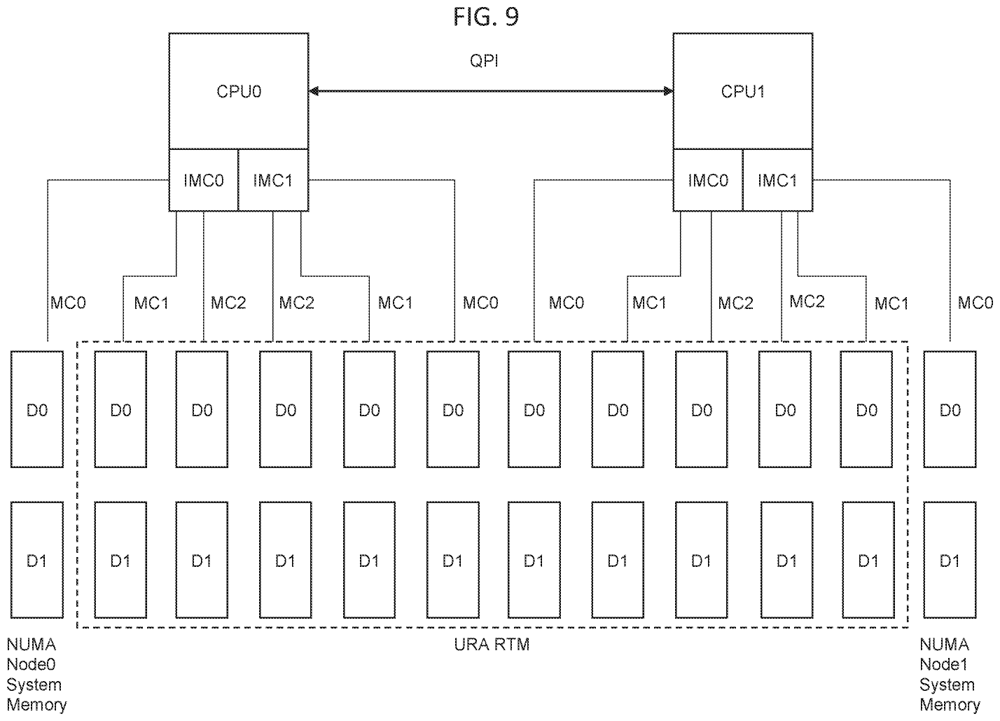

In some embodiments, the systems disclosed herein comprise a dual CPU platform wherein in some cases the physical memory address space (for example, the RAM) is formatted as a single dimension linear address space, across multiple memory channels as well as two or more non-uniform memory access (NUMA) nodes as illustrated in FIG. 9. In some embodiments, the system comprises a physical memory address space (for example, the RAM) formatted as a single dimension linear address space, across multiple memory channels as a uniform RTM access (URA) architecture.

In FIG. 9, there is illustrated as an example a system comprising a duel socket server with dual in-line memory modules (DIMMs) on all memory channels. In some embodiments, the system can be configured to reserve two DIMMs from MC0 of IMC0 (integrated memory controller) within CPU0, and two DIMMs from the MC0 of IMC1 within CPU1 as system memory, which can be configured to be managed by an OS kernel memory management after the system has been booted up. In some embodiments, the system can be configured to utilize or reserve the rest of the physically contiguous RAM, for example the twenty DIMMs illustrated in FIG. 9, to form a both physically and virtually contiguous memory address space, which can be maintained and managed by a core algorithm engine. In some embodiments, the core algorithm engine can be configured to be a proprietary kernel module, a supplemental OS or other software module that is configured to construct the RTM storage space based on utilizing or reserving any remaining RAM storage not used by the kernel, which is illustrated as the twenty DIMMs in FIG. 9.

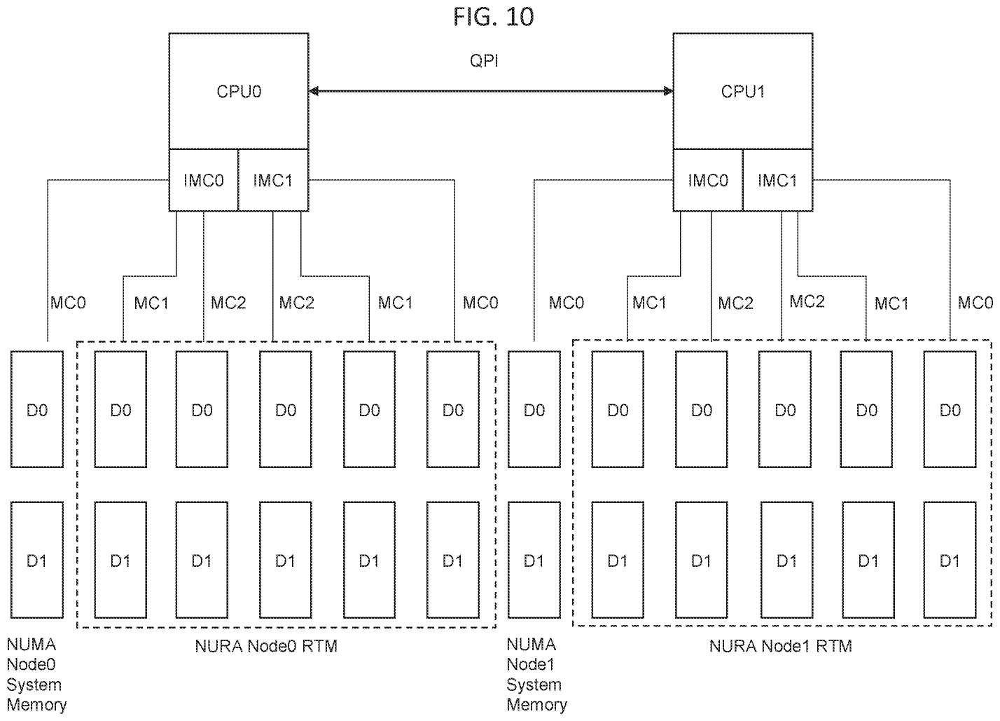

In some embodiments, the system is configured to perform the memory reservation or memory utilization by using kernel command line parameter “memmap=”. In other embodiments, the system is configured to perform the memory reservation or memory utilization by using other methodologies and/or technologies. In some embodiments, the systems disclosed herein can be configured to scale the system based on determining the number of CPU packages within a single host server. In some embodiments, the system can be configured to utilize the processor scale out process to also facilitate the host level scale out. In some embodiments, the system is configured to generate a conception of “RTM node” for each of CPU package (as illustrated in FIG. 10), instead of having one large chunk of physical contiguous memory.

As illustrated in FIGS. 9 and 10, the systems illustrated in these figures differ based on the reservation of system memory and RTM storage space. In some embodiments, the system is configured to symmetrically reserve system memory and RTM space on each CPU package according to the physical memory configuration, as illustrated in FIG. 10. In some embodiments, the system may comprise a dual socket server, wherein the system can be configured to reserve the DIMMs placed on channel 0, IMC 0 for each of the CPU's for system RAM, while DIMMs placed on all other channels will be reserved for the core algorithm engine. In some embodiments, the configuration illustrated in FIG. 10 can be easily ported to a server which has either a higher or lower number of CPU packages.

In some embodiments for the system configuration illustrated in FIG. 10, the system can be configured to perform memory reservation by applying multiple “memmap=” parameters according to the physical address layout. In other embodiments of the system configuration illustrated in FIG. 10, the system is configured to perform the memory reservation or memory utilization by using other methodologies and/or technologies.

In some embodiments, a URA system can comprise a RTM storage space that can be both physical contiguous and virtual contiguous simultaneously. In some embodiments, the core algorithm engine is configured to probe the specific type of memory region and/or map the region into its own virtual address space. In some embodiments, the RTM can have a single super block, data segment, meta segment, and/or the like.

In some embodiments, a URA system, such as that illustrated in FIG. 9 can be useful as a development platform because all CPUs can have only one unified view of RTM space, and all SMP cores can share the data structure of the unified RTM space. However, in some embodiments, a URA system cannot work as efficiently with a large quantity of SMP cores. For example, in some embodiments, the shared meta segment in RTM may comprise logical block addressing (LBA) pointers. As the number of CPU packages and SMP cores increases, the cache coherence policy, in some embodiments, can eventually impact the cache and memory accessing performance when the shared data structures are updated concurrently.

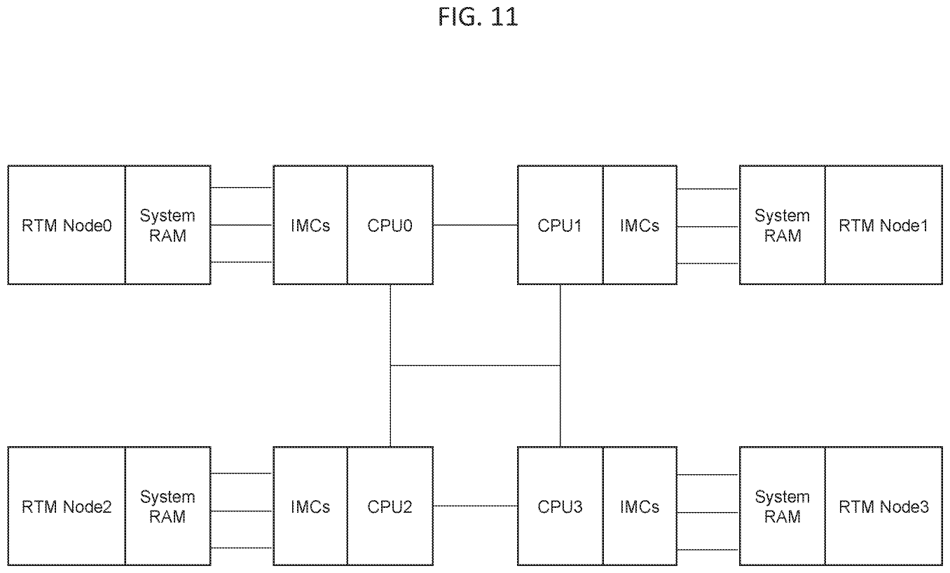

In some embodiments, as illustrated in FIG. 11, the systems disclosed herein can comprise a symmetric architecture. In some embodiments, a system with a symmetric architecture can become difficult to maintain especially when additional processors are involved and/or are added to the system because the complexity of the inter-connection and cache coherent for the NUMA policy can grow as a function of:

$$( \begin{matrix}n \\ 2\end{matrix} ) = \frac{n \times ( n - 1 )}{2} = θ ( {n}^{2} )$$

In some embodiments, the systems disclosed herein can be configured to overcome the foregoing drawback relating to the complexity and/or scalability and/or performance degradation in NUMA systems operating using a symmetric architecture by configuring the systems to split the shared address space and data structure onto each CPU. As illustrated in FIG. 11, in some embodiments, the system is configured such that each CPU is associated with its own RTM node and system RAM. In some embodiments, all of RTM nodes can have the same layout and/or data structure view, such as super block, data segment, or meta segment.

In some embodiments, though all CPUs can work within separated storage spaces parallelly, the system can still be configured to share information through QuickPath Interconnect (QPI), or other high-speed connection or network link or memory channel, and ccNUMA (cache coherent NUMA) policy. In some embodiments, the term “cache coherent” refers to the fact that for all CPUs, any variable that is to be used must have a consistent value. Therefore, it must be assured that the caches that provide these variables are also consistent in this respect.

In some embodiments, a NUMA architecture can still face issues when accessing shared memory, especially as the number of processors increases, and therefore the use of a ccNUMA architecture in a NUMA system can be advantageous because ccNUMA can be configured to guarantee data consistency when accessing the shared memory.

In some embodiments, the advantage of using a NURA architecture is to improve the utilization of SMP and/or improve memory bandwidth by increasing the memory locality (isolation), while satisfying the need to guarantee memory and/or cache data consistency with reasonable performance costs when accessing shared memory when necessary.

In some embodiments, a system configured as illustrated in FIG. 11 can be scaled over different number of CPUs; however, in some cases, the programming model can become more complicated since the low-level memory management component should abstract the separation of RTM nodes, provisioning all RTM nodes as a unified storage space to the storage layer.

In some embodiments, the system can comprise a NURA architecture running a core algorithm engine that is configured to be able to support platforms requiring a number of CPU packages. In some embodiments, the change of the number of CPU packages and/or the number of processors, should be made within GPool data structure (e.g., rtmio, lookup table, recycle bin, etc.), such that all details are hidden from the upper storage services layer.

In some embodiments, the system is configured to allow users to create logical extended memory (LEM) devices, which can be attached to a specific NUMA node, and in some embodiments, the storage space of the LEM device that is attached to a specific NUMA node can be configured such that the storage space can be able to cover all the RTM nodes.

In some embodiments, the system can be configured to comprise a new number of sockets-based licensing feature that can be built based on the NURA system. In some embodiments, the system can be configured such that the maximum number of NURA nodes is equal to the number of NUMA nodes in the system. In some embodiments, the system can be configured such that CPU hotplug is not supported by the core algorithm engine. Accordingly, in some embodiments, the system requires a reboot when a user updates the license or number of CPU packages, makes modification on kernel command line. In some embodiments, the system can be configured such that CPU hotplug is supported by the core algorithm engine.

In some embodiments, the system can be configured to start with defining the max number of nodes at six (MAX NR NODE SHIFT=6); however, in some embodiments, the system can be configured to support 2\hat{ }6=64 RTM nodes or more. In some embodiments, the systems disclosed herein can be configured to support more than 64 RTM nodes. In some embodiments, the system is configured to comprise a core algorithm engine that is built within the Linux kernel as a proprietary kernel module.

In some embodiments, the system is configured with main design features comprising a bootup procedure and/or memory reservation process. In some embodiments, the system is configured such the core algorithm engine uses a first process that utilizes the following command to reserve physical memory:

“memmap=0x28000000000!\\0x4000000000\i2cma=0@64G:0x0000000100000000,1@64G\\0x000002c000000000”

In some embodiments, the system is configured to reserve physical memory from Linux kernel differently than the process above in order to a implement NURA architecture in the system.

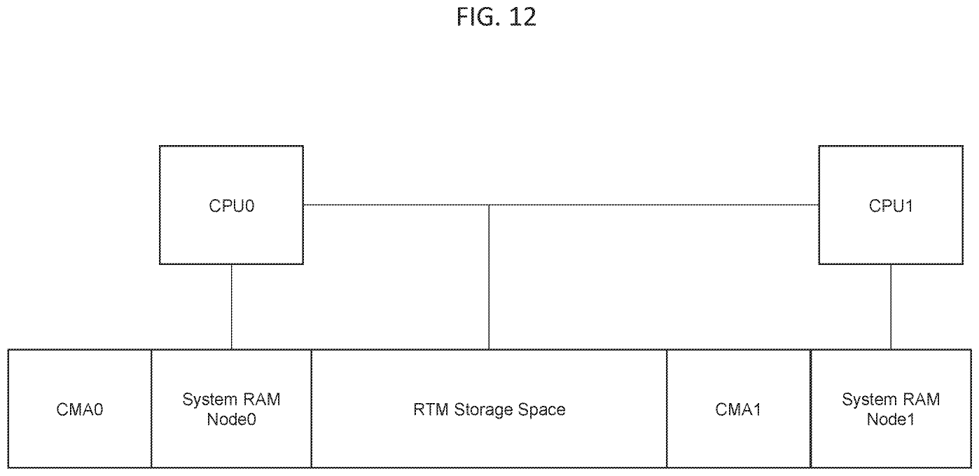

In the first process above, the system can be configured to use one “memmap=” parameter to reserve one physical contiguous memory region, which may start from physical address 0x4000000000 with length 2560 GB (in hex number 0x28000000000), and have a special memory type identifier 12 (persistent memory). In this embodiment, the system is configured to allow a Linux kernel memory management component to use the rest of the physical memory as system RAM, wherein each node associates with 256 GB memory space according to the example above. In some embodiments, the system is also configured to reserve two contiguous memory allocation regions: the CMA region on the first node may begin at physical address 0x100000000, which is immediately following the Linux kernel virtual address start point and has length of 64 GB; the CMA region on the second node may begin at physical address 0x2c000000000 (256 GB+2560 GB), which is the exact the start point for the second node System RAM physical address, and has length of 64 GB. In some embodiments, the first process above results in a physical memory layout as illustrated in FIG. 12.

As an alternative to the first process above, in some embodiments, the system can be configured to use a second process that utilizes the following example kernel bootup command line:

“memmap=0x14000000000!\\0x4000000000memmap=0x14000000000!\\0x1C000000000.”

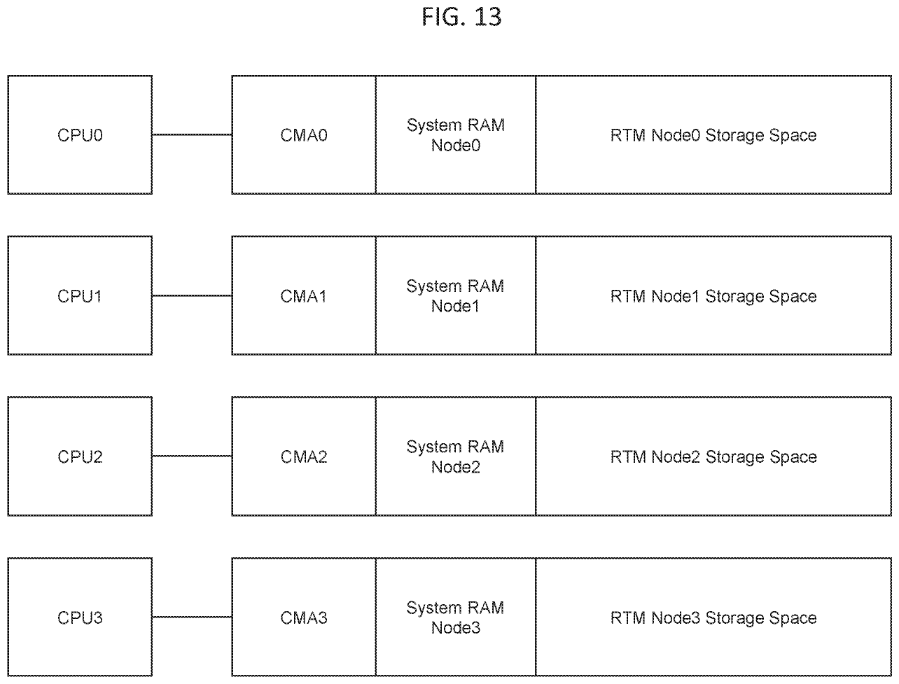

Similar to the first process, the second process follows the same methodology in using the “memmap=” parameter and proper physical calculation to reserve system RAM and RTM storage space. In contrast, the second process is configured to generate a NURA architecture within the system by placing multiple “memmap=” parameters to reserve physical memory for each CPU package as illustrated in FIG. 13.

In some embodiments, the system can configured to verify that a user defined contiguous memory allocator (CMA) region reservation is within an operating threshold as determined by the system. In some embodiments that utilize the first process above, the CMA reservation is based on a typical dual processor platform. In some embodiments that utilize the second process above, the CMA reservation is based on an iteration to reserve a symmetrical physical memory region for each node during bootup time.

In some embodiments, the systems disclosed herein can comprise a high-level feature configured for a NURA architecture, wherein the high-level feature is the gene pool component fallback list. In some embodiments, the fallback list is generated for RTM nodes, a recycle bin, and a lookup table. In some embodiments, the fallback list is generated on each processor, according to NUMA distance.

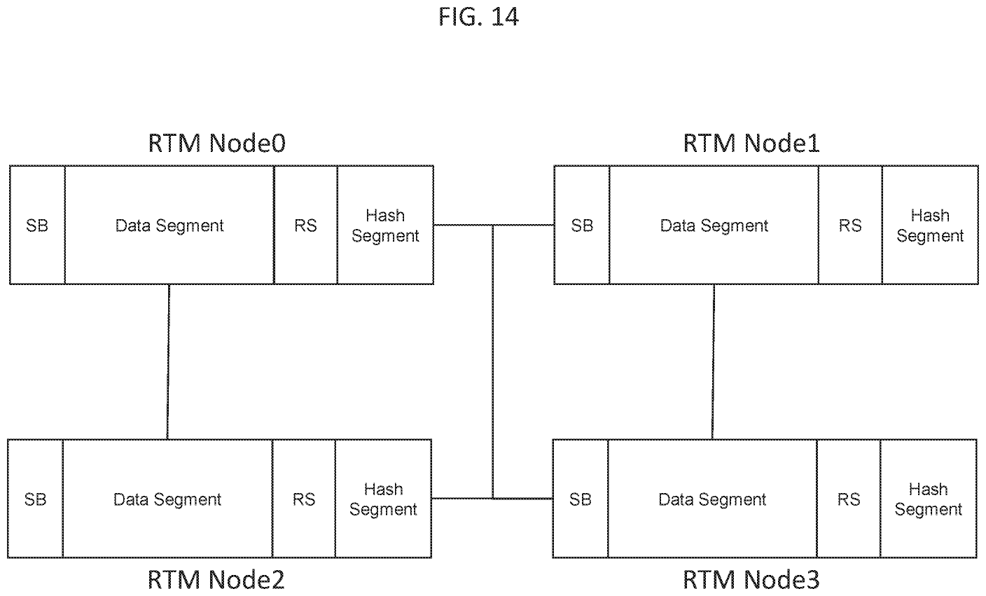

As illustrated in FIG. 14, in some embodiments, the system is configured to use a RTM node. In this example, the generated RTM node fallback list can be reviewed as the following:

On CPU0: rtm_node[0]->rtm_node[1]->rtm_node[2]->rtm_node[3];

On CPU1: rtm_node[1]->rtm_node[0]->rtm_node[3]->rtm_node[2];

On CPU2: rtm_node[2]->rtm_node[3]->rtm_node[0]->rtm_node[1];

On CPU3: rtm_node[3]->rtm_node[2]->rtm_node[1]->rtm_node[0];

In some embodiments, it can be advantageous to manage the topology of CPU and memory in NURA implementation. To assist with the foregoing, the system can be configured to comprise a topology manager as part of gene pool functionality.

In some embodiments, the systems that use the second process above comprise a memory storage physical layout that is unique with a NURA architecture, which in some embodiments requires a corresponding change to how data is stored to persistent memory, for example, an SSD or HDD, for backup purposes.

In some embodiments that utilize the first process above, the system can comprise a middleware process that is configured to map the whole or substantially all the physical memory storage as one large chunk of virtually contiguous memory into its own virtual address space. In some embodiments where the system utilizes the second process above, the system can be configured to take care of the storage memory topology issue. In some embodiments, the system can be configured to map different storage spaces as separated virtual memory chunks into the system's virtual address space and optimize the SMP I/O thread in order to accelerate the memory backup performance.

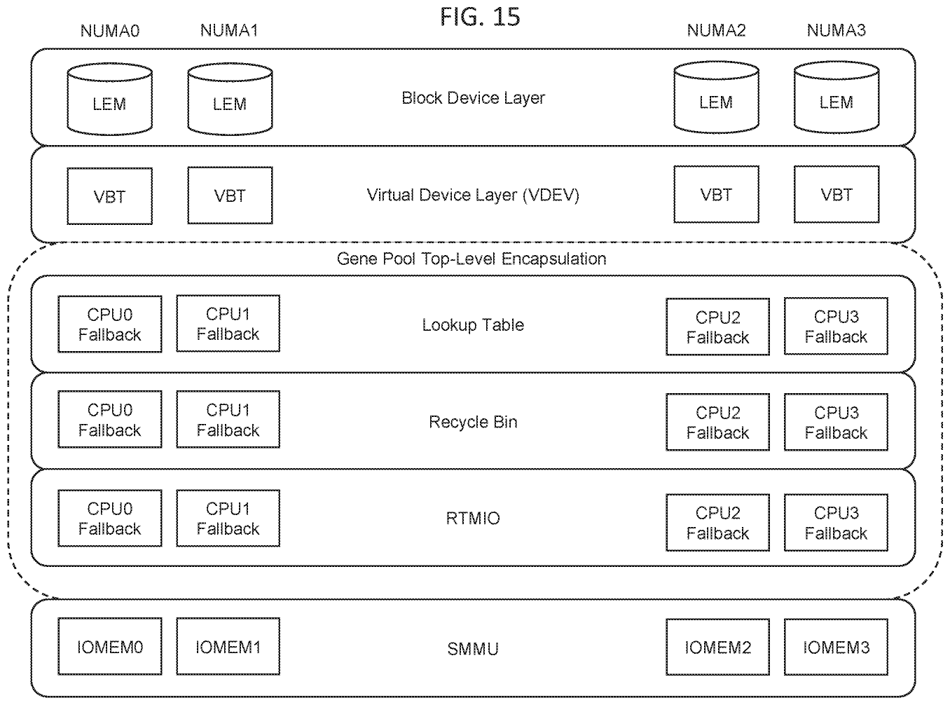

In some embodiments, the core algorithm engine comprises a storage memory management unit (SMMU), a gene pool structure, a gene pool virtual device layer, and a block device layer. In some embodiments, the gene pool structure comprising an RTMIO structure, recycle bin structure and lookup table structure as illustrated in FIG. 15.

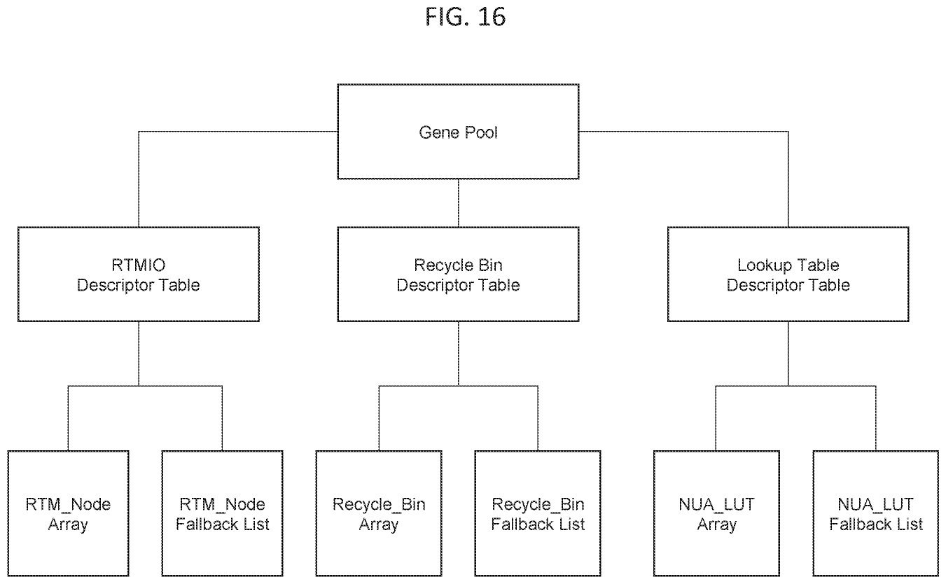

In some embodiments, the system comprises a core structure RTMIO, a recycle bin and a lookup table that are not monolithic data structures, which is shared by all SMP cores. In some embodiments, the three data structures, RTMIO, recycle bin, and the lookup table will be stored as a descriptor table with a gene pool structure. In some embodiments, each descriptor table can be configured to contain: an array of functionality data structures (e.g. RTM, recycle bin, nua_lut); and a fallback list built on NUMA distances as illustrated in FIG. 16.

In some embodiments, the system comprises a high-level gene pool description, virtual device layer and block device layer that can be shared by all the CPUs in the system, and in some embodiments, the system can be configured to simultaneously comprise instances, such as VBT and LEM, that use a NUMA architecture. In some embodiments, the modification is completed below the virtual device layer and the gene pool description abstract some or all architecture and implementation details, thereby providing unified services and interfaces to higher levels.

In some embodiments, the core algorithm engine is configured to support a NURA architecture. In some embodiments, the systems disclosed herein with a NURA architecture comprise an array of data structure “struct memres” which contain (1<<MAX NR NODE SHIFT) elements. In some embodiments, an element indicates one physically contiguous region in memory that can be used as one RTM node.

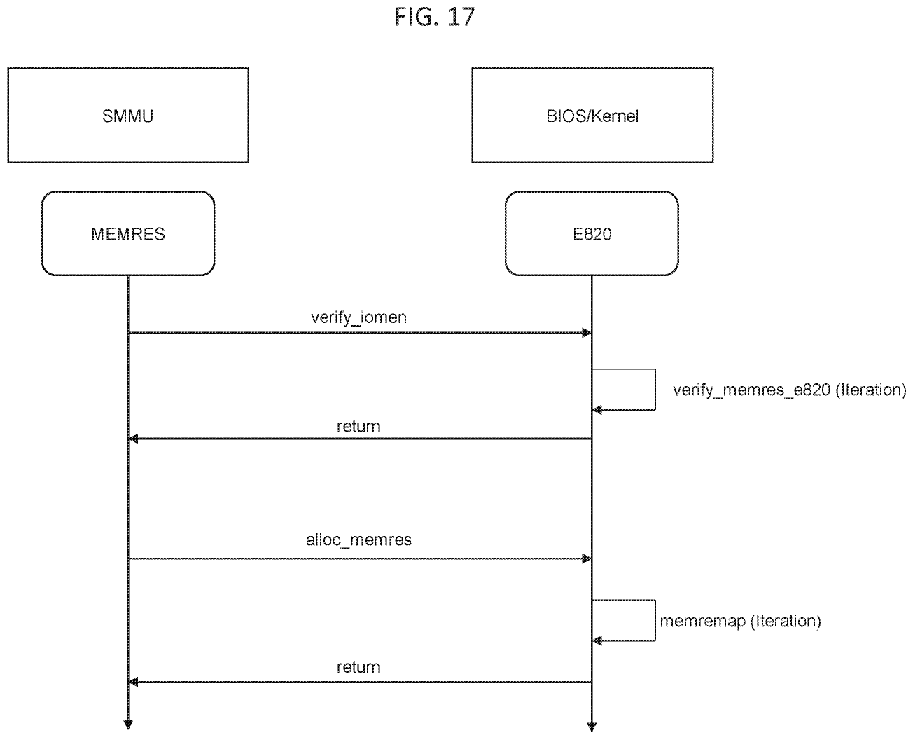

In some embodiments, the systems disclosed herein comprise a storage memory management unit (SSMU) that can be configured to invoke, for example, E820 APIs to travel through the E820 table, which in some instances can be constructed by the Linux kernel during bootup time. In some embodiments, once a specific entry is identified as a NURA reservation, the SMMU will call memremap( ) function to map the corresponding physical address space into a kernel virtual address. In some embodiments, the control flow can be illustrated as shown in FIG. 17.

In some embodiments, the systems disclosed herein can comprise a system memory management unit (SMMU) that can be configured to perform a sanity check, storage allocation and/or free for the core algorithm engine, both during in initialization stage and/or during the runtime stage.

In some embodiments, the system is configured to use as the lowest level of encapsulation and abstraction of storage memory space a real-time memory input/output (RTMIO) data structure that can be configured to maintain one storage space and provision the storage space as an RTM node. In some embodiments, the RTMIO data structure defines the virtual layout the storage space and provides semantics for load, store, control, and the like to the storage space. In some embodiments, the RTMIO data structure defines the physical and logical layout of the lowest level storage space and semantics for all essential operations over the storage space.

In some embodiment, the declaration of the data structure and semantics are within include/rtmio.h. In some embodiments, the core data structure can be configured to be kept the same, with an additional field which indicates the physical address of the storage space. In an embodiment, the RTMIO data structure can take the form of:

struct rtmio {

struct memres *memres;
union {

...

} status_word;
unsigned long phys_addr;
unsigned int meta_size;
...

};

In some embodiments, the system can be configured to comprise another layer of abstraction in RTMIO that can be advantageous in using a NURA architecture, and in some embodiments, the additional layer of abstraction can take the form of defining an RTMIO descriptor table. In some embodiments, the number of entries of the RTMIO descriptor table can be correlated with the number of NUMA nodes. In some embodiments, each entry can comprise the local RTM node reference and/or the NURA fallback relationship. As an example, some embodiments of the systems disclosed herein can use the following data structure to define the RTMIO descriptor table entry:

struct rtm_desc_entry {

struct rtmio *local_node;
unsigned int dist[(1UL << MAX_NR_NODE_SHIFT)];

};

In some embodiments, the integer array above stores all NUMA IDs within the current system, which can be sorted in ascending order based on NUMA distance. In some embodiments, the first element within the array indicates the local RTM node NUMA ID, which can be used as a NURA ID. In some embodiments, the system can be configured to find the RTMIO reference of the second nearest RTM node from local node by using, for example, “rtm_desc_entry[rtm_desc_entry[LOCAL_NURA_ID]->dist[2]]->local node”.

In some embodiments, the system can enable the data structure of the descriptor table and/or the entry of the table to be changed to better suit or accommodate or make more efficient the system for specific circumstances during implementation.

In some embodiments, the system can be configured to generate a free_list data structure as a per-CPU variable for each of SMP core. In some embodiments, the free_list data structures are globally visible. In some embodiments, during recycle phase, the I/O thread can evenly distribute orphan blocks onto all the free_list structures, while during the reuse phase, the I/O thread can try to reuse the free block from the local free_list structure first, and if the local list is empty, the system can randomly pick up one free list among all SMP cores as a start point, then travel through all free_list structures until finding a usable free block.

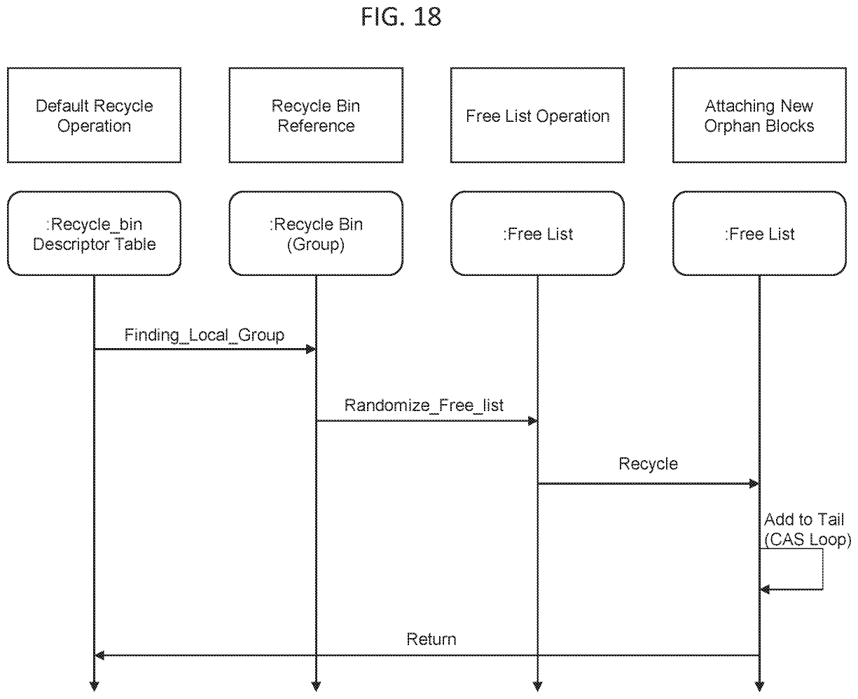

In some embodiments, the system can be configured to group free_list structures based on different NURA nodes and create fallback list among those groups instead of constructing the globally visible free_list structures. In some embodiments, the system can be configured to, during a recycle phase, evenly distributed the orphan block over different free lists within its group. In some embodiments, the group can be described by using recycle bin descriptor table, following same methodology as RTMIO design. An example recycle phase is illustrated in FIG. 18.

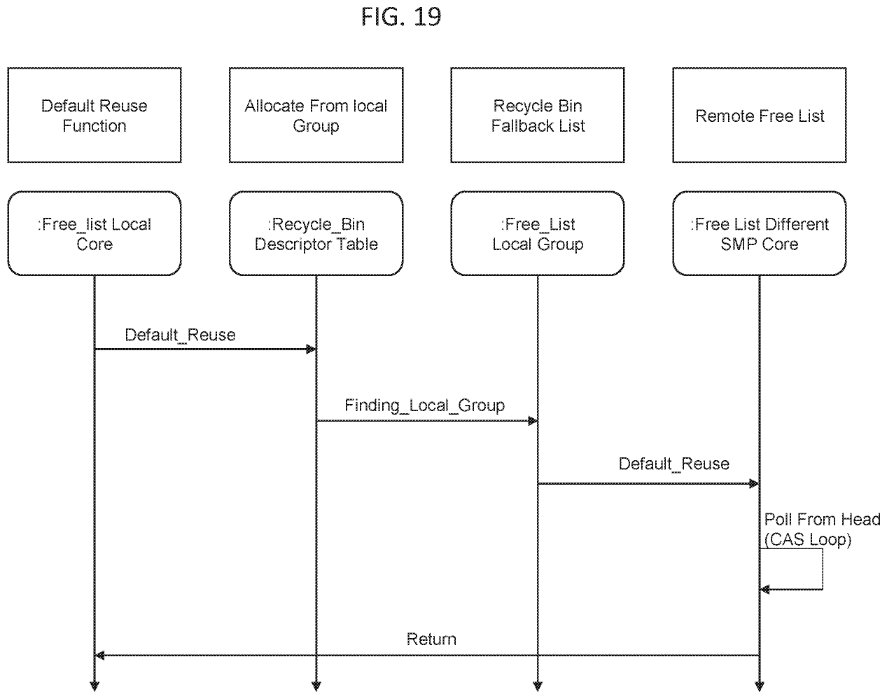

FIG. 19 illustrates an example flowchart of a reuse operation. In some embodiments, the reuse operation can be configured to follow the same methodology as the recycle process but the reuse process does the opposite of recycle. In some embodiments, the system can comprise a reuse operation be configured to only try to allocate free block from local free list group.

In some embodiments, the system can comprise a lookup table configured to have a “non-uniform access” feature. In some embodiments, the array of the lookup table is limited by two, for example, in a dual-CPU socket systems.

In some embodiments, the system is configured such that the array of the lookup table is not limited by two, allowing the lookup array to be allocated on each NURA node. In some embodiments, the modification (e.g., insert, erase, etc.) of a lookup array only occurs on local lookup array at a particular NURA node, while the lookup operation is configured to occur one level remote. In some embodiments, the system is configured to allow the lookup operation to occur on local, nearest, and/or second nearest lookup array. In some embodiments, the system can allow the user to define the proper searching policy to guarantee that the lookup operation will search the duplication hash value as well as maintaining reasonable searching latency.

In some embodiments, the system is configured to enable high-level Gene Pool integration. In some embodiments, instead of having singletons such as struct RTMIO, struct recycle_bin, the system is configured to comprise a corresponding descriptor table for all the different structures that the system requires. In some embodiments, the descriptor table for the various structures can take on the following example structure:

Struct gpool_struct {

Struct gpool_sb_info gp_superblock;
Struct rtmio_desc_entry *rtm_dtb;
Struct recycle_bin_desc_entry *recycle_bin_dtb;
...

}

In some embodiments, the system is configured to enable initialization and resource management to be handled by the sub-module. In some embodiments, the Gene pool superblock is altered to adapt the fallback logic. In some embodiments, the system statistic module is altered to adapt to the NURA architecture.

In some embodiments, the system is configured to enable free block allocation within a write path. In some embodiments, the system comprises a modification to gpool_io_put( ) function. In some embodiments, the system is configured to comprise the pseudo function for allocating a free block for the write operation:

allocate_free_block( ):

for NURA_node from [local] to [most distant]

free_block = find free block by increase next_lba;
if (!free_block)

free_block = reuse free block from local recycle bin;

if (free_block)

break;

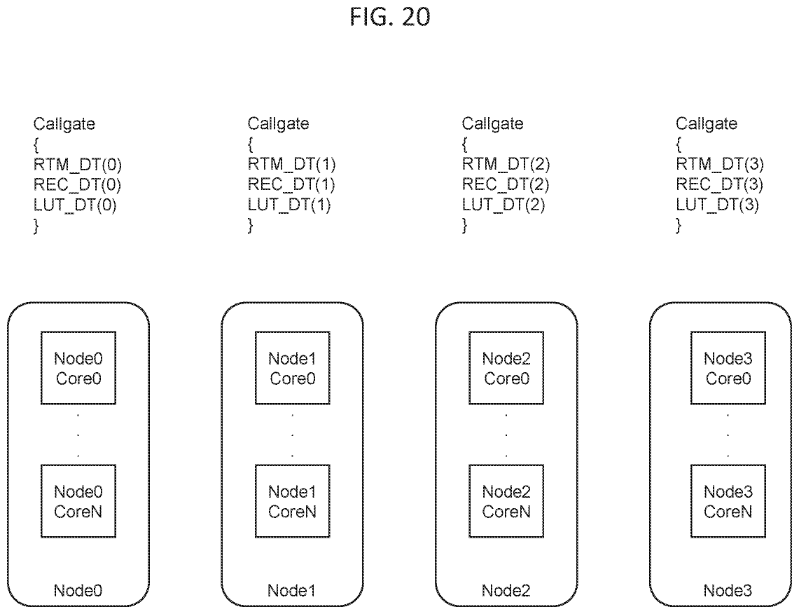

In some embodiments, the above pseudo function follows the fallback logic. In some embodiments, the system can be configured such that each CPU core has a percpu variable “Call gate” which points to appropriate local node entry to access RTM, recycle_bin and nua_lut structures which are local to the processor as illustrated in FIG. 20. In the example of FIG. 20, by accessing each CPU core's “call gate” variable, the system can be configured to refer to the data structures corresponding to the local node.

### Hybrid I/O

As noted above, it is generally because of the limited capacity, volatility, and high cost associated with RAM that conventional computer systems have also included a peripheral bus for accessing peripheral devices such as peripheral or mass storage devices. These conventional storage devices are generally available with capacities that are much larger than RAM modules. For example, HDDs are commonly available with capacities of 6 TB or even larger. Further, these conventional storage devices are generally persistent, meaning that data is retained even when the devices are not supplied with power. Additionally, these conventional storage devices are generally much cheaper than memory. However, there are also disadvantages associated with the use of these conventional storage devices in conventional computer systems. For example, I/O transfer speeds over the peripheral bus (e.g., to and from conventional storage devices) are generally much slower than the I/O speeds to and from main memory (e.g., RAM). This is because, for example, conventional storage devices are connected to the processor over the slower peripheral bus. In many computers, the peripheral bus is a PCI bus. Then there is typically an adapter to the actual bus to which the peripheral storage device is attached. For storage devices, such as HDDs and SSDs, the connector is often SAS, SATA, Fiber Channel, and most recently Ethernet. There are also some storage devices that can attach to PCI directly such as NVMe Drives. However, in all cases speeds for accessing devices over the peripheral bus are about 1000 times slower than speeds for accessing RAM (e.g. DRAM).

Thus, in conventional computer systems, devices, and methods a limited amount of memory has generally been provided that can be accessed at high transfer speeds, and a larger amount of peripherally attached conventional storage is provided for long term and mass data storage. However, in these conventional systems, the difference in the I/O transfer speeds associated with the memory and the conventional storage devices creates a bottleneck that can affect the overall performance of the systems. Under heavy computing loads, for example, this bottleneck will eventually slow the entire computing system to the speed of the conventional storage device.

This section further describes systems, methods, and devices for hybrid I/O processing to provide general and flexible I/O processing functionalities, for example, on a hyper-converged system or in-memory computer system. In particular, in some embodiments, the systems, methods, and devices described herein can provide capabilities of handling both high performance synchronous I/O and asynchronous I/O simultaneously for a storage subsystem on hyper-converged infrastructure.

In some embodiments, the in-memory computer systems, devices, and methods described herein can function without reliance on conventional storage devices (and thus are not subject to the bottleneck described above) and/or provide solutions to one or more of the conventionally-viewed drawbacks associated with memory (e.g., volatility and limited capacity). Stated another away, in some embodiments, the in-memory computer systems, devices, and methods described herein include and/or utilize a processor and memory with or without amplification, wherein the memory is used for mass data storage, without reliance or substantial reliance on a conventional hard drive, solid state drive, or any other peripheral storage device in a traditional manner.

In some embodiments, the in-memory computer systems, devices, and methods can be configured to provide and/or utilize storage capacities in memory generally only associated with conventional storage devices (e.g., HDDs and SSDs), and/or that can be accessed at the high I/O transfer speeds associated with RAM. Further, certain systems, devices, and methods can be configured such that the data is generally non-volatile, such that data will not be lost if the systems lose power. In some embodiments, the in-memory computer systems, devices, and methods utilize specialized computer architectures. In some embodiments, the in-memory computer systems, devices, and methods utilize specialized software operating on a system with traditional computer architecture.

In some embodiments, the systems, methods, and devices described herein are configured to create an RTM as detailed herein. Memory can refer to media, which can be designed to be synchronized and/or parallel. In other words, in some embodiments, memory or memory cells can be designed to have sequenced instructions sent to them. However, in some embodiments, the systems, devices, and methods described herein can be configured to apply one or more asynchronous I/O features or processes into a memory-based system with one or more synchronous I/O features or processes, thereby creating a hybrid I/O processing scheme.

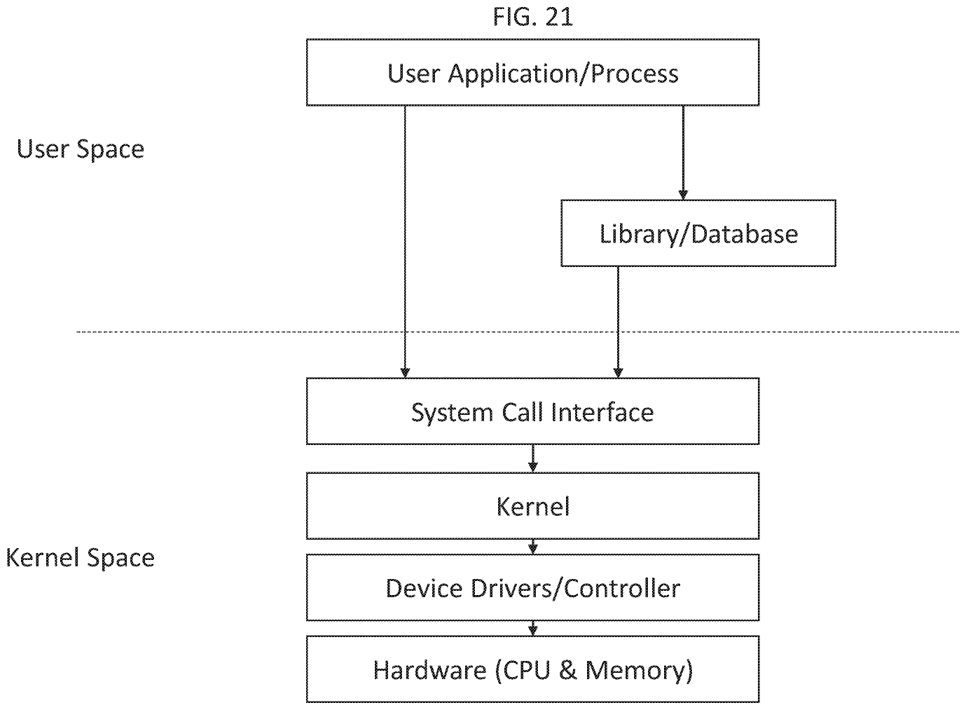

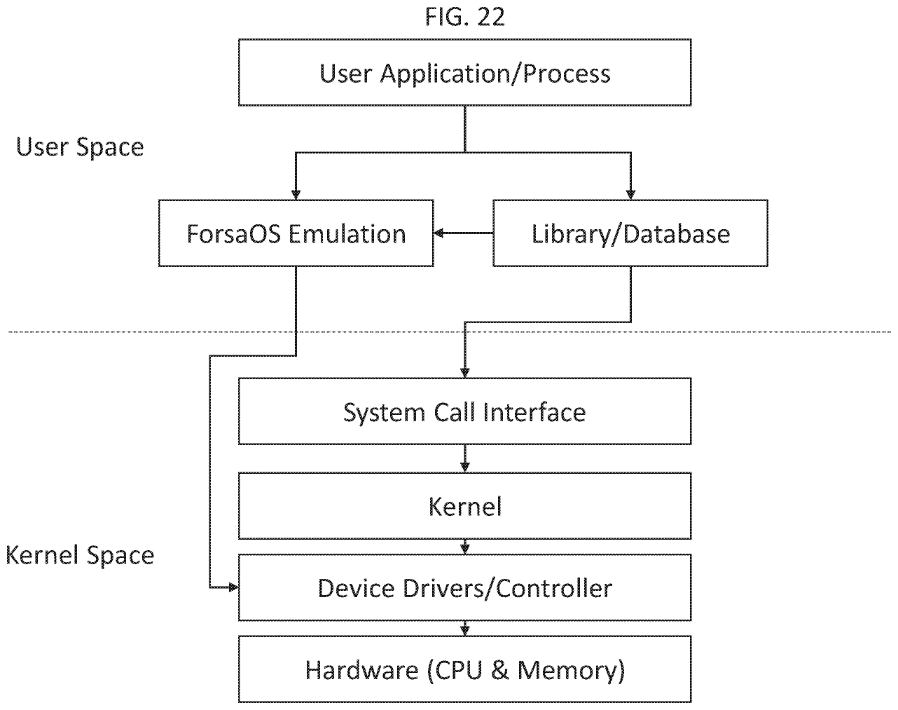

FIGS. 21-22 are flowcharts illustrating features of an embodiment(s) of systems, methods, and devices for hybrid I/O processing, including synchronous I/O processing, and/or asynchronous I/O processing. In synchronous I/O, a user process/thread starts an I/O operation and immediately enters a wait state until the I/O request has completed. On the other hand, a process/thread performing asynchronous file I/O sends an I/O request to the kernel by calling an appropriate function. If the request is accepted by the kernel, the calling thread continues processing another job until the kernel signals to the thread that the I/O operation is complete. It then interrupts its current job and processes the data from the I/O operation as necessary.

In situations where an I/O request is expected to take a large amount of time, such as a refresh or backup of a large database or a slow communications link, asynchronous I/O may optimize processing efficiency. However, for relatively fast I/O operations, the overhead of processing kernel I/O requests and kernel signals may make asynchronous I/O less beneficial, particularly if many fast I/O operations need to be made. Thus, an in-memory computer system may be configured to perform both synchronous and asynchronous I/O

More specifically, as illustrated in FIG. 21, in some embodiments, memory is divided into two distinct regions: the user space and the kernel space. In some embodiments, the user space comprises a set of locations, generally virtual memory, where normal user processes and applications run. Generally, these processes cannot access the kernel space directly. In some embodiments, some part of kernel space can be accessed by user processes via system calls. In some embodiments, these system calls act as software interrupts in the kernel space. In some embodiments, the kernel space comprises a dedicated portion of memory in which the OS kernel runs. In some embodiments, the role of the kernel space is to manage applications/processes running in user space. In some embodiments, the kernel can access the entirety of the memory. If a user process performs a system call, a software interrupt may be sent to the kernel, which then dispatches an appropriate interrupt handler and interfaces with the CPU and/or memory.

In some embodiments, for synchronous I/O, every time an instruction is passed from an application to a library/database, the database can be configured to provide the instruction to the OS kernel. In some embodiments, applications may send the request directly to a system call interface. In some embodiments, the OS kernel can be configured to schedule the instruction or call, which in some cases may involve performing one I/O transaction while preventing another I/O transaction from occurring. In other words, in some embodiments, the system can schedule a call while waiting to see if another transaction was successfully performed. In some embodiments, a transaction can be relayed to the hardware, which may comprise a CPU and memory. As such, when an instruction goes in, the system can be configured to block the CPU and hold it until it completes a task or transaction. As such, in some embodiments, the system can be configured to utilize one or more synchronous processes, which can be processed in kernel space.

However, utilizing synchronous processes in the user space can be costly and/or slow due to the synchronous nature. In synchronous I/O, each request must be completed sequentially before the next request can be processed. Thus, it can be advantageous for the system to be configured to utilize one or more asynchronous processes. In some embodiments, the in-memory computer system can comprise and/or be configured to utilize user space, as opposed to kernel space, for asynchronous I/O processing.

In some embodiments, the system can be comprise and/or be configured to utilize one or more Storage Performance Development Kits (SDPK) and/or one or more processes that mimic SDPK without actually using SDPK. More specifically, in some embodiments, the system can be configured to bypass the kernel and/or any kernel synchronization mechanisms and communicate directly with the CPU. By utilizing one or more asynchronous I/O processing, in some embodiments, the system can be configured to perform at an increased speed of at least 68 percent on the same hardware. In some embodiments, the system utilizing one or more asynchronous I/O processing, with or without one or more synchronous I/O processing, can be configured to perform, on the same hardware, at a speed that is faster than a system utilizing only synchronous I/O processing by about 1.1 times, about 1.2 times, about 1.3 times, about 1.4 times, about 1.5 times, about 1.6 times, about 1.7 times, about 1.8 times, about 1.9 times, about 2.0 times, about 2.5 times, about 3.0 times, about 3.5 times, about 4.0 times, about 4.5 times, about 5.0 times, about 6.0 times, about 7.0 times, about 8.0 times, about 9.0 times, about 10 times, about 15 times, about 20 times, about 25 times, about 30 times, about 35 times, about 40 times, about 45 times, about 50 times, and/or within a range defined by two of the aforementioned values, which can depend on the size of the instruction. In some embodiments, the system can be configured to utilize a combination of both synchronous I/O processing and/or asynchronous I/O processes. Stated differently, in some embodiments, the system can be configured to combine synchronous I/O processing and asynchronous I/O processing to obtain a hybrid I/O processing scheme.

In some embodiments, due to the inherent design of kernels and/or the base OS, the system can be configured to utilize synchronous I/O processing; however, by utilizing one or more SDPK or SDPK-like processes that mimic SDPK, the system can be configured to utilize asynchronous I/O processing at the same time. Generally speaking, SDPK can be designed to access SSDs and/or HDDs. As such, in some embodiments, the system can be configured to simulate one or more processes that are similar to SDPK. In other words, in some embodiments, the system not only moves processing to the user space but also communicates directly to memory, thereby effectively simulating SDPK but in a memory environment as SDPK does not communicate with memory. In some embodiments, the system can be configured to stitch memory into RTM. Generally speaking, it can be impossible to talk to memory directly using a traditional OS. To do so, it can be necessary, in some cases, to expose the memory as a device. As such, in some embodiments, the system can be configured to take the memory and allocate some of the memory to the base OS. In some embodiments, when the base OS boots up, it can load one or more drivers in sequence, such as for example, kernel drivers, memory drivers, device drivers, speech, sound, network, keyboard, mouse, or the like, as part of its normal boot process. In some embodiments, the system can be configured to call kernel reconfig or k-config to unload more memory load. In some embodiments, an added system OS, which can be referred to herein as ForsaOS, can be loaded at the first driver. In some embodiments, when ForsaOS is loaded, it can be configured to take substantially the entire memory and give a small portion, such as for example 2 GB or any other amount, to the base OS. In other words, when the base OS, such as Linus or other OS, loads, ForsaOS can kick and perform a reconfig and reallocate the entire memory by allocating a small portion to the base OS and the rest to RTM. In some embodiments, through this process of reallocation of memory, the system can make all of the memory appear as media and/or memory-back storage. In some embodiments, by making the memory appear as media, the system can be allowed to utilize one or more SPDK-like processes and/or asynchronous I/O processing by communicating directly with memory. In some embodiments, the base OS may not be aware of what such RTM actually is, for example from looking at internal descriptive tables, and can allow the RTM to act independently. In other words, in some embodiments, the system for ForsaOS can essentially cause the base OS into thinking that RTM is unclassified. However, the base OS may still not know how to communicate with the RTM. As such, in some embodiments, the system can be comprise and/or be configured to utilize one or more drivers to facilitate communication between the base OS and the RTM. Stated differently, in some embodiments, one or more such drivers can provide a layer that sits within the base OS and communicates on its behalf to the physical media or RTM. Stated differently, in some embodiments, the system can emulate as a user-space driver. In particular, in some embodiments, the system can be configured to perform I/O processing in user space, which is asynchronous, as well as bypass otherwise synchronous I/O processing by mimicking SDPK-like features to be applied to memory. In other words, in some embodiments, the system can be configured to combine kernel-space and user-space technologies together on a single driver. As such, in some embodiments, the system can comprise and/or be configured to utilize a unique driver that emulates and/or lives in user space but lives physically in the kernel. In other words, the driver can be configured to emulate itself to be in the user space while physically in the kernel space. In some embodiments, with hybrid I/O processing, the system can be configured to divide up specific calls to be performed by either synchronous I/O processing or asynchronous I/O processing. An example configuration of a synchronous I/O processing or asynchronous I/O processing system is illustrated in FIG. 22.

### Additional Details—Hybrid I/O Processing

As described above, in some embodiments, the system can comprise and/or be configured to utilize hybrid I/O processing on a hyper-converged system, as a software solution for example, in order to provide general and/or flexible I/O processing functionalities to satisfy variety of complex application circumstances, as well as achieve high I/O performance with relatively low CPU usage on hyper-converged infrastructure. In some embodiments, the systems, methods, and devices described herein can be provided as a software solution based on the approach of Software-Defined Storage. In some embodiments, the systems, methods, and devices described herein can be applicable on major symmetrical multi-processing system over different storage media, including but not limited to DRAM, Persistent Memory, high performance NVMe SSD NVMe-oF, and/or the like.

In some embodiments, the hybrid I/O processing approach can entitle capabilities of handling both high performance synchronous I/O and asynchronous I/O simultaneously for storage subsystems on hyper-converged infrastructure. In some embodiments, hybrid I/O processing systems, devices, and methods can be able to provision low level storage devices as both POSIX standard I/O functions (Kernel mode for example) as well as specific API patterns (User mode for example) to satisfy requirements from different user applications. In some embodiments, hybrid I/O processing systems, devices, and methods can comprise one or more of the following submodules: (1) a core algorithm engine, which can comprise an independent software library implementation, providing storage management, memory management and/or data reduction algorithm(s); (2) a Linux Kernel BDEV layer comprising a POSIX standard provisioning layer to support general storage approach on Linux/Unix system; and/or (3) Storage Performance Development Kits (SDPK) or SDPK-like processes that can act as a user mode storage protocol layer. In some embodiments, hybrid I/O processing systems, devices, and methods can provide high performance synchronous I/O processing and general storage provisioning through the Linux BDEV layer, while it utilizes SPDK or SDPK-like processes to achieve the high performance asynchronous I/O processing with user mode API patterns.

Generally speaking, the traditional storage device I/O processing approach in Linux/UNIX system can be through the kernel space driver with interrupt mode. One obvious advantage of this approach can be that all of the storage details are abstracted by the kernel storage subsystem, so that user applications do not need to change to adapt different storage device. For example, all I/O requests can be handled by POSIX syscalls. However, with the most advanced storage media, such as high performance SSD and Persistent Memory, the kernel interrupt approach can show a substantial bottleneck due to the thick software layer, such that most of CPU cycles can be consumed by the storage software layer instead of the storage device itself during I/O processing.

In some embodiments, to overcome such issues of kernel interrupt approach, systems, devices, and methods described herein can provide software-defined storage solutions, such as SPDK and PMDK or those that mimic the same, which can adopt a kernel-bypass approach in order to minimize the influence of the software layer when handling I/O requests. In some embodiments, by utilizing SPDK, for example, I/O requests can be handled completely under user space with polling mode on limited CPU resources. In some embodiments, the system can achieve high asynchronous I/O performance by removing the user to kernel mode switch and device to CPU interrupts. Yet, SPDK itself is not a generic storage solution because it cannot provision storage device with POSIX standard interfaces. To use a SPDK solution, in some embodiments, the user application can be changed to use the specific API patterns to handle I/O requests.

As such, some embodiments of the hybrid I/O processing approach, instead, combines the advantages from both of the above solutions to satisfy variety of application requirements. In particular, in some embodiments, by deploying the hybrid I/O processing solution, a single hyper-converged host storage system can handle high performance synchronous I/O request under Host Mode, and at the same time can achieve high asynchronous I/O performance under Virtualization Mode.

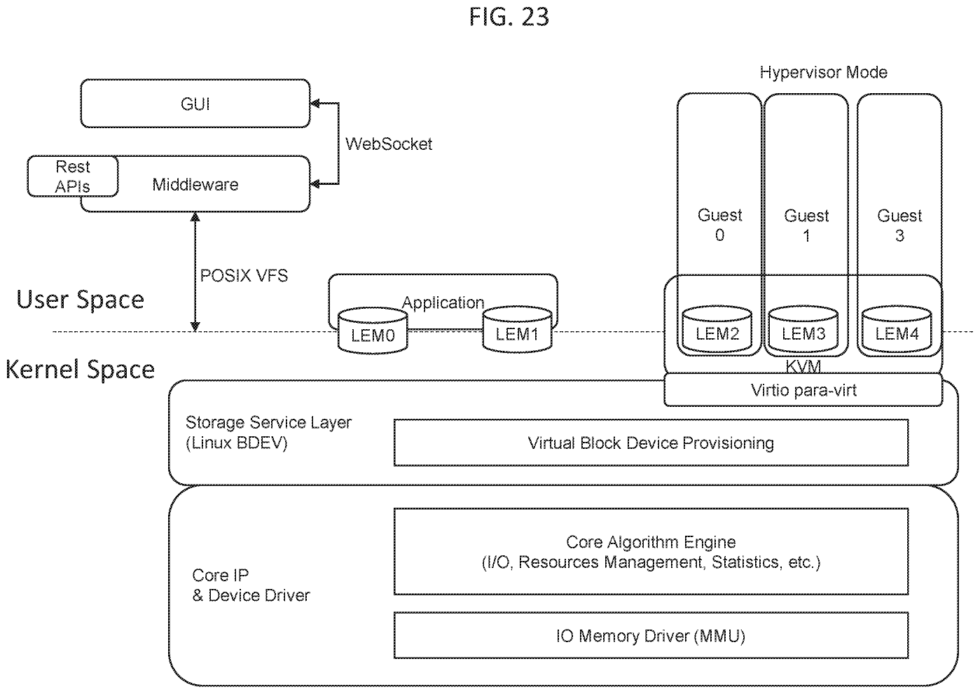

More specifically, in some embodiments, under Host Mode, the core algorithm engine can be integrated into Linux kernel as an independent IP kernel module, as shown in FIG. 23. In some embodiments, this core engine can provide storages service through the generic Linux BDEV layer by using a synchronous request-bypass method, instead of the traditional interrupt method. In some embodiments, user applications can directly use the advanced storage service that is provided by the core engine without changing their original I/O functionality.

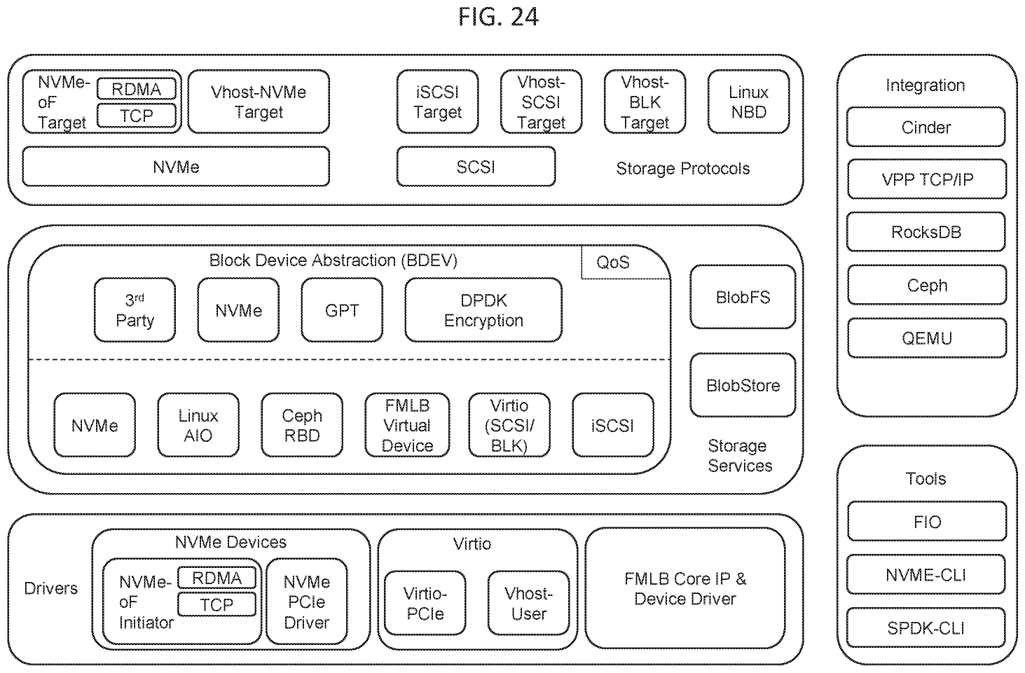

In some embodiments, under Virtualization Mode, the core algorithm engine can collaborate with the SPDK or SPDK-like framework as illustrated in FIG. 24, so that it can utilize the advantages of user polling mode to accelerate the storage performance of guest machines with relatively low CPU resources cost.

In some embodiments, besides of supporting both Host Mode and Virtualization Mode on hyper-converged systems, the hybrid I/O processing solution can also provide both high synchronous and asynchronous I/O performance on a single host system. In some embodiments, the synchronous I/O processing has advantages of low latency as well as keeping data consistence, which is suitable for OLTP environment over persistent memory storage based system, while the asynchronous I/O processing can entitle CPUs capability to handle more parallel tasks simultaneously, which can be an important point in hyper-converged system. Compared to SPDK, the system may provide both synchronous and asynchronous I/O model, require no application changes, have byte and/or block data access granularity, access memory (IO MEM) and interface with memory including DRAM. In some embodiments, with NURA architecture support, the hybrid I/O processing solution can be well scalable over SMP host as well as cluster infrastructure.

As described herein, in some embodiments, the hybrid I/O processing systems, devices, and methods can have many advantages including but not limited to providing a complete software solution, providing both Host Mode and Virtualization Mode on single host or clustering infrastructure, providing a software-defined storage solution that can handle both synchronous and asynchronous IO requests from backend based on application requirements, which can be configurable, low CPU resources cost, and/or good scalability.

### Computer Systems

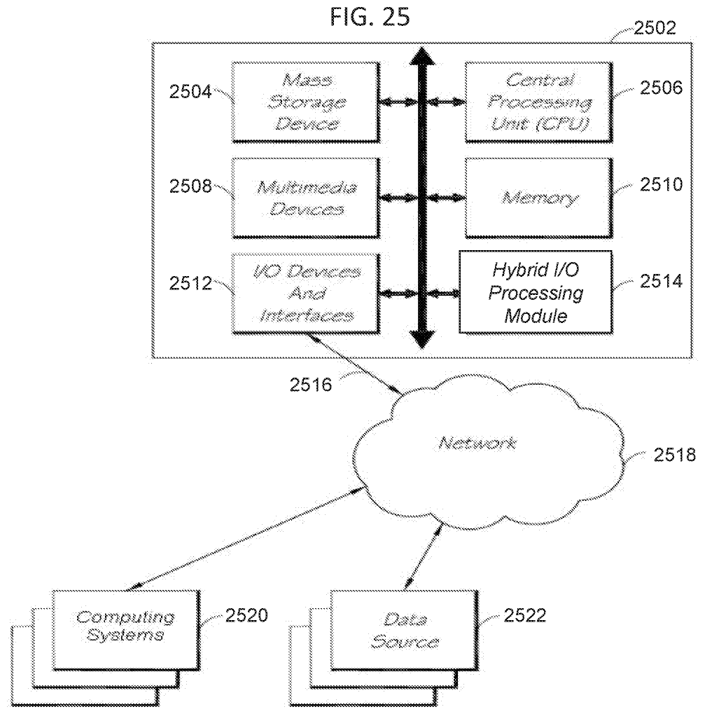

In some embodiments, the systems, processes, and methods described herein are implemented using one or more computing systems, such as the one illustrated in FIG. 25. FIG. 25 is a schematic diagram depicting an embodiment(s) of a computer hardware system configured to run software for implementing one or more embodiments of in-memory computer systems, devices, and methods. However, it is to be noted that some systems, processes, and methods described herein are implemented using one or more computing systems with a specialized computer system architecture as those described herein. In some embodiments, certain systems, processes, and methods described herein are implemented using a combination of one or more computing systems as those illustrated and described in connection with FIG. 25 and one or more computing systems with a specialized computer system architecture as those described herein. Furthermore, in some embodiments, certain systems, processes, and methods described herein are implemented using a computer system that comprises one or more features described in connection with FIG. 25 and one or more features of a specialized computing system architecture as described above.

Referring back to FIG. 25, the example computer system 2502 is in communication with one or more computing systems 2520 and/or one or more data sources 2522 via one or more networks 2518. While FIG. 25 illustrates an embodiment of a computing system 2502, it is recognized that the functionality provided for in the components and modules of computer system 2502 may be combined into fewer components and modules, or further separated into additional components and modules.

The computer system 2502 can comprise a Hybrid I/O processing module 1014 that carries out the functions, methods, acts, and/or processes described herein. The data management and translation module 2514 is executed on the computer system 2502 by a central processing unit 2506 discussed further below.

In general the word “module,” as used herein, refers to logic embodied in hardware or firmware or to a collection of software instructions, having entry and exit points. Modules are written in a program language, such as JAVA, C or C++, PYPHON or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems, and may be stored on or within any suitable computer readable medium, or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 2502 includes one or more processing units (CPU) 2506, which may comprise a microprocessor. The computer system 2502 can further include one or more of a physical memory 2525, such as RAM, a ROM for permanent storage of information, and a mass storage device 2504, such as a backing store, hard drive, rotating magnetic disks, solid state disks (SSD), flash memory, phase-change memory (PCM), 3D) (Point memory, diskette, or optical media storage device. Alternatively, the mass storage device may be implemented in an array of servers. Typically, the components of the computer system 2502 can be connected to the computer using a standards based bus system. The bus system can be implemented using various protocols, such as Peripheral Component Interconnect (PCI), Micro Channel, SCSI, Industrial Standard Architecture (ISA) and Extended ISA (EISA) architectures.

The computer system 2502 can include one or more input/output (I/O) devices and interfaces 2512, such as a keyboard, mouse, touch pad, and printer. The I/O devices and interfaces 2512 can include one or more display devices, such as a monitor, that allows the visual presentation of data to a participant. More particularly, a display device provides for the presentation of GUIs as application software data, and multi-media presentations, for example. The I/O devices and interfaces 2512 can also provide a communications interface to various external devices. The computer system 2502 may comprise one or more multi-media devices 2508, such as speakers, video cards, graphics accelerators, and microphones, for example.

The computer system 2502 may run on a variety of computing devices, such as a server, a Windows server, a Structure Query Language server, a Unix Server, a personal computer, a laptop computer, and so forth. In other embodiments, the computer system 2502 may run on a cluster computer system, a mainframe computer system and/or other computing system suitable for controlling and/or communicating with large databases, performing high volume transaction processing, and generating reports from large databases. The computing system 2502 is generally controlled and coordinated by an OS software, such as z/OS, Windows, Linux, UNIX, BSD, SunOS, Solaris, MacOS, or other compatible OSs, including proprietary OSs. Operating systems control and schedule computer processes for execution, perform memory management, provide file system, networking, and I/O services, and provide a user interface, such as a graphical user interface (GUI), among other things.

The computer system 2502 illustrated in FIG. 25 is coupled to a network 2518, such as a LAN, WAN, or the Internet via a communication link 2516 (wired, wireless, or a combination thereof). Network 2518 communicates with various computing devices and/or other electronic devices. Network 2518 is communicating with one or more computing systems 2520 and one or more data sources 2522. The Hybrid I/O processing module 2514 may access or may be accessed by computing systems 2520 and/or data sources 2522 through a web-enabled user access point. Connections may be a direct physical connection, a virtual connection, and other connection type. The web-enabled user access point may comprise a browser module that uses text, graphics, audio, video, and other media to present data and to allow interaction with data via the network 2518.

Access to the Hybrid I/O processing module 2514 of the computer system 2502 by computing systems 2520 and/or by data sources 2522 may be through a web-enabled user access point such as the computing systems' 2520 or data source's 2522 personal computer, cellular phone, smartphone, laptop, tablet computer, e-reader device, audio player, or other device capable of connecting to the network 2518. Such a device may have a browser module that is implemented as a module that uses text, graphics, audio, video, and other media to present data and to allow interaction with data via the network 2518.

The output module may be implemented as a combination of an all-points addressable display such as a cathode ray tube (CRT), a liquid crystal display (LCD), a plasma display, or other types and/or combinations of displays. The output module may be implemented to communicate with input devices 2512 and they also include software with the appropriate interfaces which allow a user to access data through the use of stylized screen elements, such as menus, windows, dialogue boxes, toolbars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 2502 may comprise a physical or logical connection established between a remote microprocessor and a mainframe host computer for the express purpose of uploading, downloading, or viewing interactive data and databases on-line in real time. The remote microprocessor may be operated by an entity operating the computer system 2502, including the client server systems or the main server system, and/or may be operated by one or more of the data sources 2522 and/or one or more of the computing systems 2520. In some embodiments, terminal emulation software may be used on the microprocessor for participating in the micro-mainframe link.

In some embodiments, computing systems 2520 who are internal to an entity operating the computer system 2502 may access the Hybrid I/O processing module 2514 internally as an application or process run by the CPU 2506.

The computing system 2502 may include one or more internal and/or external data sources (for example, data sources 2522). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 2502 may also access one or more databases 2522. The databases 2522 may be stored in a database or data repository. The computer system 2502 may access the one or more databases 2522 through a network 2518 or may directly access the database or data repository through I/O devices and interfaces 2512. The data repository storing the one or more databases 2522 may reside within the computer system 2502.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

What is claimed is:

1. A computer-implemented method of implementing hybrid input/output (I/O) functionality for an in-memory computer system, wherein the hybrid I/O comprises synchronous I/O and asynchronous I/O, the computer implemented method comprising:
allocating, by the in-memory computer system, a portion of a memory to a base operating system;
configuring, by the in-memory computer system, a remaining portion of the memory into a real-time memory (RTM), such that the memory is exposed to an operating system of the in-memory computer system as a device;
utilizing, by the in-memory computer system, one or more Storage Performance Development Kits (SDPK) and/or one or more processes that mimic SDPK to bypass the kernel and/or any kernel synchronization mechanisms and communicate directly with the memory, wherein the configuring the remaining portion of the memory into a RTM enables the utilization of the one or more Storage Performance Development Kits (SDPK) and/or one or more processes that mimic SDPK;
utilizing one or more drivers to facilitate communication between the base operating system and the RTM; and
dividing system calls to be performed by either a synchronous I/O processing or an asynchronous I/O processing,
wherein the in-memory computer system comprises the processor and the memory.

2. The computer-implemented method of claim 1, wherein the one or more processes that mimic SDPK communicate directly to memory.

3. The computer-implemented method of claim 1, wherein the allocating the portion of the memory comprises loading, by the in-memory computer system, a secondary operating system.

4. The computer-implemented method of claim 3, wherein the secondary operating system is configured to allocate the portion of the memory to the base operating system and to configure the remaining portion of the memory into a RTM.

5. The computer-implemented method of claim 3, wherein the configuring of the remaining portion of the memory comprises reconfiguring, by the secondary operating system performs a reconfiguration of the memory to appear as media and/or memory-backed storage to the base operating system.

6. The computer-implemented method of claim 1, wherein the remaining portion of the memory comprises 50% or more of the memory.

7. The computer-implemented method of claim 1, wherein the remaining portion of the memory comprises 75% or more of the memory.

8. The computer-implemented method of claim 1, wherein the remaining portion of the memory comprises 90% or more of the memory.

9. The computer-implemented method of claim 1, wherein the remaining portion of the memory comprises 99% or more of the memory.

10. The computer-implemented method of claim 1, wherein the one or more drivers comprise a layer within the base operating system that communicates with the memory or the RTM.

11. An in-memory computer system comprising:
a non-uniform non-aligned real time memory access (NURA) architecture for two or more computer processors, the NURA architecture comprising:
a plurality of first computer readable memory devices configured to store a first plurality of computer executable instructions;
a plurality of second computer readable memory devices configured to store a second plurality of computer executable instructions;
a first hardware computer processor node in communication with the plurality of first computer memory devices; and
a second hardware computer processor node in communication with the plurality of second computer memory devices,
wherein memory of a first subset of the a plurality of first computer readable memory devices is reserved or utilized as a first system memory in a non-uniform memory access node, such that the first system memory is accessible to the first hardware computer processor node and is not accessible to the second computer processor node via memory channels,
wherein memory of a first subset of the a plurality of second computer readable memory devices is reserved or utilized as a second system memory in a non-uniform memory access node, such that the second system memory is accessible to the second hardware computer processor node and is not accessible to the first computer processor node via memory channels,
wherein memory of a second subset of the plurality of first computer readable memory devices is reserved or utilized as a first real-time memory (RTM) in a non-uniform non-aligned real time memory access node,
wherein the first RTM is accessible to the first hardware computer processor node and is not accessible to the second computer processor node via memory channels,
wherein memory of a second subset of the plurality of second computer readable memory devices is reserved or utilized as a second RTM in a non-uniform non-aligned real time memory access node,
wherein the second RTM is accessible to the second hardware computer processor node and is not accessible to the first computer processor node via memory channels,
wherein the first RTM and the second RTM comprise allocated memory that appears as mass or peripheral storage media to an operating system within the first plurality of computer executable instructions and the second plurality of computer executable instructions, and
wherein the first RTM and the second RTM comprise identical pools of data elements, bit markers, and/or raw data.

12. The NURA architecture of claim 11, wherein the memory of the plurality of first computer readable memory devices and the plurality of second computer readable memory devices is reserved or utilized by using a kernel command line parameter “memmap=”.

13. The NURA architecture of claim 11, wherein the first subset of the plurality of first computer readable memory devices and the first subset of the plurality of second computer readable memory devices are placed on memory channel 0.

14. The NURA architecture of claim 11, wherein the memory of the second subset of the plurality of first computer readable memory devices and the memory of the second subset of the plurality of second computer readable memory devices is not physically contiguous.

15. The NURA architecture of claim 11, wherein the first RTM and the second RTM comprise a super block, data segment, or meta segment.

16. The NURA architecture of claim 11, wherein the first computer processor node and the second computer processor node are configured to perform processing using the first RTM and the second RTM in parallel.

17. The NURA architecture of claim 11, wherein the first computer processor node and the second computer processor node are configured share information through QuickPath Interconnect (QPI).

18. The NURA architecture of claim 11, further comprising one or more additional pluralities of readable memory devices and computer processor nodes, wherein each additional computer processor node is configured with a first subset of a plurality of computer readable memory devices reserved or utilized as an additional system memory and with a second subset of a plurality of computer readable memory devices reserved or utilized as an additional RTM.

19. The NURA architecture of claim 18, wherein each additional computer processor node is configured to perform processing in parallel to each other additional computer processor node.

20. The NURA architecture of claim 11, wherein each of the first computer processor node and the second computer processor node is configured with a logical extended memory (LEM).

21. The NURA architecture of claim 20, wherein the LEM comprises a part of the non-uniform memory access node.
